(19) United States
(12) Patent Application Publication
(10) Pub. No.: US 2026/0146144 A1
(43) Pub. Date: May 28, 2026

(54) SYNERGISTIC STABILIZER COMPOSITIONS AND METHODS FOR USING SAME FOR PROTECTING ORGANIC MATERIALS FROM UV LIGHT AND THERMAL DEGRADATION

(71) Applicant: Cytec Industries Inc., Lawrence, NJ (US)

(72) Inventors: Hargurpreet Singh, Seymour, CT (US); Ram B. Gupta, Stamford, CT (US); Jian-Yang Cho, Easton, CT (US); Xiaofeng Ren, Stamford, CT (US)

(73) Assignee: Cytec Industries Inc., Lawrence, NJ (US)

(21) Appl. No.: 19/122,685

(22) PCT Filed: Oct. 17, 2023
(86) PCT No.: PCT/EP2023/078893

§ 371 Date: Apr. 18, 2025

Related U.S. Application Data
(60) Provisional application No. 63/417,066, filed on Oct. 18, 2022.

(51) Int. Cl. C08K 5/3435; C08J 3/22; C08K 5/134; C08K 5/20; C08K 5/3492

(52) U.S. Cl. CPC C08K 5/3435; C08J 3/22; C08K 5/1345; C08K 5/20; C08K 5/3492; C08J 2323/12

(57) ABSTRACT

Synergistic stabilizer compositions having a stabilizing amount of a co-synergist; optionally a stabilizing amount of a co-active agent; a stabilizing amount of an ultraviolet light absorber selected from an ortho-hydroxyphenyl triazines, ortho-hydroxy benzophenones, oxanilides, cyanoacrylates, benzoxazinones, optionally ortho-hydroxyphenyl benzotriazoles, and combinations thereof; and a stabilizing amount of a hindered amine light stabilizer, are provided herein. The total weight of co-synergist (IV) and co-active agent (when present) is from 1 wt. % to 99 wt. %, based on the total weight of the stabilizer composition; and the weight ratio of co-synergist to co-active agent (when present) is 1:99 to 99:1. Also disclosed are masterbatch concentrates, stabilized polymer compositions, and stabilized articles of manufacture, all containing the stabilizer composition.

### BACKGROUND

### Field

The present invention generally relates to the field of additivation of organic materials with stabilizer compositions that prevent the deleterious effects of prolonged exposure to UV radiation. More particularly, the instant disclosure relates to stabilizer compositions having UV light stabilizers and their use in a variety of organic materials such as polymer resins to achieve improved service properties.

### Description of Related Art

A variety of organic materials are known to undergo degradation by several mechanisms including exposure to electromagnetic radiation such as sunlight and other sources of ultraviolet (“UV”) radiation and heat. For example, polymeric materials such as plastics often discolor, lose gloss and mechanical properties and/or become brittle as a result of prolonged exposure to the sun. Accordingly, a large body of art has been developed directed toward materials such as UV light absorbers and various other stabilizers, which are capable of inhibiting such degradation in these materials.

In particular, UV light absorbers such as benzotriazoles and benzophenones were initially used to stabilize polymeric materials, and to prevent the degradation of such materials from exposure to UV light. Later, it was discovered that hindered amine light stabilizers (“HALS”), which scavenge free radicals formed in the polymeric material when exposed to UV light, were more effective than UV light absorbers (“UVAs”). Accordingly, the use of HALS and UV light absorbers in combination are conventionally used to stabilize polymeric materials.

The use of UVAs by themselves or in combination with HALS to stabilize polymers such as coatings and plastics against weathering due to the direct or indirect impact of heat and ultraviolet light has remained an active area of research. For example, U.S. Pat. Nos. 4,619,956; 4,740,542; and 5,760,228 disclosed compositions and/or methods of stabilizing a polymer film, coating, or a molded article against the action of light, moisture, or oxygen by incorporating aryl triazines and HALS into said polymers. It was further disclosed that such triazines exhibited an enhanced degree of stabilization due to a synergistic effect when combined with certain HALS.

Synergistic combinations of stabilizer compositions were further demonstrated by U.S. Pat. No. 6,051,164, wherein it was disclosed that polyolefins containing certain ratios of HALS (having a molecular weight of at least 500 Da) and orthohydroxyphenyl triazines provided superior performance properties over polyolefins containing either stabilizer alone or those with both HALS and triazine, but which were not in the synergistic ratio. Similarly, U.S. Pat. No. 6,843,939 disclosed synergistic UV stabilizing additive blends that included orthohydroxyphenyl triazines, HALS, and hindered hydroxybenzoates, and which provided improved performance over either stabilizer alone or combinations of only 2 of the stabilizer additives.

More recently, U.S. Pat. No. 11,091,615 discloses the use of “co-active agents” to further enhance the synergistic effect of combination of UV absorbers and hindered amine light stabilizers (HALS) in the field of polymer stabilization. Some important examples of co-active agents claimed in U.S. Pat. No. 11,091,615 include alkoxylated C₁₂-C₆₀ alcohols or monoalkyl ethers thereof; alkoxylated esters of fatty acids; sorbitan esters or ethoxylates thereof, mono- or polyglycerol esters having from 1 to 20 glycerol units or alkoxylates thereof; alkoxylated fatty amines, esters thereof, or salts thereof, sugar esters; alkoxylated fatty amides; ethylene oxide/propylene oxide copolymers; and mixtures thereof.

Accordingly, synergistic combinations of stabilizer additives can still be discovered even though the compounds themselves are perhaps known for individual use for a particular purpose, or are known to be used together for a particular purpose at concentrations or ratios not previously disclosed or suggested.

The discovery of such synergistic stabilizer additives that substantially improve the performance characteristics of a variety of organic materials subject to mechanical stress, or effects such as oxidation, chain scission, and uncontrolled recombination and cross-linking reactions that are caused by photo-oxidation, as well as heat, would be a useful advance in the art and could find rapid acceptance in a number of industries requiring such stabilized materials.

### SUMMARY

Synergistic stabilizer compositions having a stabilizing amount of a co-synergist selected from the group consisting of bisamides of fatty acids; optionally a stabilizing amount of a co-active agent; a stabilizing amount of an ultraviolet light absorber selected from an ortho-hydroxyphenyl triazines, ortho-hydroxy benzophenones, oxanilides, cyanoacrylates, benzoxazinones, optionally ortho-hydroxyphenyl benzotriazoles, and combinations thereof; and a stabilizing amount of a hindered amine light stabilizer, are provided herein. The total weight of co-synergist (IV) and co-active agent (when present) is from 1 wt. % to 99 wt. %, based on the total weight of the stabilizer composition; and the weight ratio of co-synergist to co-active agent (when present) is 1:99 to 99:1.

Also disclosed are stabilized polymer compositions comprising an organic material to be stabilized and the stabilizer composition. The stabilized polymer composition can comprise from 0.01 wt. % to 15 wt. % of the stabilizer composition, based on the total weight of the stabilized polymer composition.

Also disclosed are masterbatch concentrates comprising an organic material to be stabilized as defined herein and the stabilizer composition, wherein the masterbatch concentrate comprises 10 wt. % to 90 wt. of the stabilizer composition, based on the total weight of the masterbatch concentrate.

Also disclosed are stabilized articles of manufacture comprising from 0.01 wt. % to 15 wt. %, based on the total weight of the stabilized article of manufacture, of a stabilizer composition a stabilizing amount of an ultraviolet light absorber (UVA) selected from the group consisting of: ortho-hydroxyphenyl triazine compounds; ortho-hydroxybenzophenone compounds; oxanilides; cyanoacrylates; benzoxazinone compounds; and mixtures thereof, a stabilizing amount of a hindered amine light stabilizer compound (HALS); a stabilizing amount of a co-synergist selected from the group consisting of bisamides of fatty acids; and a stabilizing amount of a co-active agent; wherein the total weight of co-synergist (IV) and co-active agent is from 1 wt. % to 99 wt. %, based on the total weight of the stabilizer composition; and the ratio of co-synergist (IV) to co-active agent is 1:99 to 99:1; or a masterbatch concentrate as defined herein; such that the final concentration of the combined co-synergist (IV) and co-active agent in the stabilized article of manufacture is from 0.01 wt. % to 5 wt. %, based on the weight of the stabilized article of manufacture.

Also disclosed are stabilized articles of manufacture comprising from 0.01 wt. % to 15 wt. %, based on the total weight of the stabilized article of manufacture, of a stabilizer composition a stabilizing amount of an ultraviolet light absorber (UVA) selected from the group consisting of: ortho-hydroxyphenyl triazine compounds; ortho-hydroxybenzophenone compounds; orthohydroxyphenyl benzotriazole compounds; oxanilides; cyanoacrylates; benzoxazinone compounds; and mixtures thereof, a stabilizing amount of a hindered amine light stabilizer compound (HALS); a stabilizing amount of a co-synergist selected from the group consisting of bisamides of fatty acids; wherein a co-active agent selected from the group consisting of alkoxylated C₁₂-C₆₀ alcohols or monoalkyl ethers thereof; alkoxylated esters of fatty acids; sorbitan esters or ethoxylates thereof, mono- or polyglycerol esters having from 1 to 20 glycerol units or alkoxylates thereof; alkoxylated fatty amines, esters thereof, or salts thereof, sugar esters; alkoxylated fatty amides; ethylene oxide/propylene oxide copolymers; and mixtures thereof, is absent from the stabilizer composition (0 wt. %); and wherein the co-synergist (IV) is present at from 1 wt. % to 99 wt. %, based on the total weight of the stabilizer composition; such that the final concentration of the combined co-synergist (IV) and co-active agent in the stabilized article of manufacture is from 0.01 wt. % to 5 wt. %, based on the weight of the stabilized article of manufacture.

Also disclosed are kits that can include in a single container or in multiple containers any stabilizer composition disclosed herein, or a masterbatch concentrate thereof, an organic material to be stabilized, and optionally one or more other co-stabilizers and/or co-additives.

Also disclosed are processes for combining any stabilizer composition disclosed herein, or a masterbatch concentrate thereof, and optionally one or more other co-stabilizers and/or co-additives, with an organic material to be stabilized.

Also disclosed are processes for forming stabilized articles of manufacture comprising combining any stabilizer composition disclosed herein, or a masterbatch concentrate thereof, and optionally one or more other co-stabilizers and/or co-additives, with an organic material to be stabilized to form a stabilized polymer composition; and shaping the stabilized polymer composition into a stabilized article of manufacture.

Also disclosed are processes for protecting an organic material from the deleterious effects of UV irradiation and heat, the processes comprising combining the organic material with any stabilizer composition disclosed herein, or a masterbatch concentrate thereof, and optionally one or more other co-stabilizers and/or co-additives, with an organic material to be stabilized. These processes comprise adding before, during, or after processing a stabilizing amount of any stabilizer composition described herein to the organic material to be stabilized.

These and other objects, features, and advantages of this disclosure will be apparent from the following detailed description and accompanying examples.

### DETAILED DESCRIPTION

The foregoing and additional objects of the invention are attained in accordance with the principles of the invention described herein, wherein the inventors detail the surprising discovery that certain classes of compounds have a synergistic effect on the stabilization properties of UV absorbers, particularly when combined with radical stabilizers such as hindered amine light stabilizers (HALS), and are effective for stabilizing a variety of organic materials susceptible to the deleterious effects caused by prolonged exposure to heat and/or light such as from electromagnetic radiation. For purposes of describing the present invention, these certain classes of additive compounds are referred to throughout the specification and claims as “co-synergists.” As used throughout the specification and claims the term “UV stabilizer” shall refer to the classes of ultraviolet (“UV”) light absorbers (or “UVA”) or hindered amine light stabilizers (“HALS”) described herein, individually as a class, or in combination with each other. Reference to UVA or HALS alone will just refer to the corresponding individual classes of compounds. Even more surprising is the discovery by the inventors that when “co-synergists” and “co-active agents” are used together there is further synergistic effect to enhance the performance of UV absorbers and hindered amine light stabilizers (HAL S). The term “co-active agents” is described herein and also in U.S. Pat. No. 11,091,615. The action of “co-active agents” and co-synergist” is similar, i.e., to enhance the performance of a UV stabilization composition comprising a UV absorber and a hindered amine light stabilizer (HALS), but they belong to two different classes of compounds.

Organic materials such as polymeric resins containing a stabilizing amount of these co-synergists with and without co-active agents with UV stabilizers described herein have enhanced performance characteristics even when used at lower loading levels.

The present inventors have found that certain additives referred to as “co-synergists” herein, which are currently known in the art as being useful as anti-block agents and for providing a variety of other performance functions for polymer resins have a synergistic effect on the stabilization properties of UV stabilizers, and are thus effective for stabilizing a variety of organic materials susceptible to the deleterious effects caused by exposure to UV light, heat and/or oxidation—even at concentrations lower than those typically used to achieve the other performance functions exemplified in the prior art. Organic materials containing the stabilizer compositions described herein provide such improved performance properties against exposure to electromagnetic and thermal radiation as compared to state of the art stabilizer compositions, that the results are entirely surprising and unexpected. Thus, any additive, or mixtures of additives, described herein that acts synergistically with UV stabilizers (UV absorbers and HALS) to further enhance stabilization of organic materials from the deleterious effects of UV light, heat and/or oxidation are referred to herein as “co-synergists”.

In some instances, further synergistic stabilization effects are obtained when the co-synergist is combined with a “co-active agent” as described herein. The term “co-active agent” as described in U.S. Pat. No. 11,091,615, incorporated herein by reference in its entirety, refers to any such additive compound, or mixtures of additive compounds, that acts synergistically with UV absorbers, optionally in combination with hindered amine light stabilizers, to enhance stabilization of organic materials from the deleterious effects of UV light, heat and/or oxidation. The stabilizer compositions containing these co-active agents are optionally capable of providing a contact angle with water at the surface of an article of manufacture containing the stabilizer compositions according to the invention of greater than 20°.

Stabilizer Compositions. The stabilizer compositions according to the present invention are suitable for use in stabilizing various organic materials subject to mechanical stress, discoloration, or effects such as oxidation, chain scission, and uncontrolled recombination and cross-linking reactions that are caused by photo-oxidation and can be incorporated into such organic material to protect it from these deleterious effects, or it can be used as, or within, a UV filter layer for preventing UV radiation from reaching the organic material or an article of manufacture produced with the organic material.

Accordingly, in a first aspect, disclosed herein are stabilizer compositions having a stabilizing amount of a co-synergist; optionally a stabilizing amount of a co-active agent; a stabilizing amount of an ultraviolet light absorber selected from ortho-hydroxyphenyl triazines, an ortho-hydroxy benzophenones, oxanilides, cyanoacrylates, benzoxazinones, optionally an ortho-hydroxyphenyl benzotriazoles, and combinations thereof; and a stabilizing amount of a hindered amine light stabilizer; wherein the total weight of co-synergist (IV) and co-active agent (when present) is from 1 wt. % to 99 wt. %, based on the total weight of the stabilizer composition; and the weight ratio of co-synergist to co-active agent (when present) is 1:99 to 99:1.

The term “hydrocarbyl” as used herein is a generic term encompassing aliphatic, alicyclic and aromatic groups having an all-carbon backbone and consisting of carbon and hydrogen atoms. In certain cases, as defined herein, one or more of the carbon atoms making up the carbon backbone may be optionally replaced or interrupted by a specified atom or group of atoms, such as by one or more heteroatom of N, O, and/or S. Examples of hydrocarbyl groups include alkyl, cycloalkyl, cycloalkenyl, aryl, substituted aryl, alkenyl, alkynyl, alkylcycloalkyl, cycloalkylalkyl, cycloalkenylalkyl, and carbocyclic aralkyl, alkaryl, aralkenyl and aralkynyl groups.

Such hydrocarbyl groups can also be optionally substituted by one or more substituents as defined herein. The examples and preferences expressed below also apply to each of the hydrocarbyl substituent groups or hydrocarbyl-containing substituent groups referred to in the various definitions of substituents for compounds of the formulas described herein unless the context indicates otherwise.

Preferred non-aromatic hydrocarbyl groups are saturated groups such as alkyl and cycloalkyl groups. Generally, and by way of example, the hydrocarbyl groups can have up to one hundred carbon atoms, unless the context requires otherwise. Hydrocarbyl groups with from 1 to 60 carbon atoms are preferred, with 1 to 36 carbons more preferred. Within the sub-set of hydrocarbyl groups, particular examples are C₁₂₋₆₀ hydrocarbyl groups, C₁₂₋₃₀ hydrocarbyl groups, C₁₂₋₂₂ hydrocarbyl groups, C₁₋₁₀ hydrocarbyl groups, or C₁₋₄ hydrocarbyl groups, although any individual value, range, or combination of values selected from C₁ through C₆₀ hydrocarbyl groups is contemplated by the inventors as if specifically recited herein.

As indicated by the context used herein, the term “alkyl” is intended to include linear, branched, or cyclic hydrocarbon structures and combinations thereof. Lower alkyl refers to alkyl groups of from 1 to 6 carbon atoms. Examples of lower alkyl groups include methyl, ethyl, propyl, isopropyl, butyl, s- and t-butyl, pentyl, hexyl, or cyclohexyl and the like. Preferred alkyl groups include those of C₃₆ or below.

The terms “alkoxy,” “alkoxyalkyl,” or “alkoxylated” as used herein refer to groups of from 1 to 20 carbon atoms of a straight, branched, or cyclic configuration, or combinations thereof either attached to the parent structure through an oxygen atom, or incorporated into the backbone of a moiety via an oxygen atom. Examples include methoxy, ethoxy, propoxy, isopropoxy, butoxy, cyclopropyloxy, cyclohexyloxy, and the like.

Co-synergists. As used herein, the co-synergists refer to a particular class of compounds selected from the group consisting of bisamides of fatty acids represented by the general formula (IV);

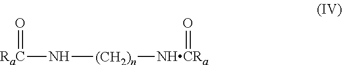

wherein Rₐ is a C₇ to C₂₅ alkyl group with 0 to 6 unsaturated double bonds and n is 2 to 10.

The co-synergist (IV) can be, for example, N,N′-ethylene bis(stearamide) (EBS), N,N′-ethylene bis(oleamide) (EBO), N,N′-hexamethylene bis(stearamide), N,N′-hexamethylene bis(oleamide), N,N′-hexamethylene bis(erucamide), N,N′-hexamethylene bis(behenamide), N,N′-ethylene bis(erucamide), N,N′-ethylene bis(behenamide), or mixtures thereof. In some embodiment, the co-synergist is N,N′-ethylene bis(stearamide) (EBS), N,N′-ethylene bis(oleamide) (EBO), or a mixture thereof.

Co-active Agents. As described in U.S. Pat. No. 11,091,615, incorporated herein by reference, “co-active agents” refer to any additive or additive mixtures that acts synergistically with a UV absorber, optionally in combination with a HALS, to effectively stabilize organic materials from the deleterious effects of UV light, heat and/or oxidation. In some embodiments, the co-active agent in the stabilizer compositions described herein are selected from the group consisting of C₁₂-C₆₀ alcohols; alkoxylated alcohols or monoalkyl ethers thereof; alkoxylated esters of fatty acids; sorbitan esters or ethoxylates thereof; mono- or polyglycerol esters having from 1 to 20 glycerol units, or alkoxylates thereof; alkoxylated fatty amines, esters thereof, or salts thereof; sugar esters; alkoxylated fatty amides; alkoxylated natural oils; ethylene oxide/propylene oxide copolymers; and mixtures thereof.

The co-active agent can be a C₁₂-C₆₀ alcohol, which can be monohydric, polyhydric, or a mixture of the two. When the co-active agent is a monohydric alcohol, the monohydric alcohol can be a C₁₂-C₃₆ alkanol, and preferably C₁₂-C₂₂, that is a primary, secondary, linear, branched, or cyclic (i.e., cycloalkanol) alcohol. Such alcohols are well known to those skilled in the art and are commercially available by a number of suppliers under various trade names. Generally suitable alkanols for the present invention include, but are not limited to, 1-dodecanol; 1-tridecanol; 1-tetradecanol; 1-pentadecanol; 1-hexadecanol; 1-heptadecanol; 1-octadecanol; 1-nonadecanol; 1-eicosanol; 1-docosanol; 1-tetracosanol; 1-hexacosanol; 1 octacosanol; 1-triacontanol; 2-methyl-1-undecanol; 2-propyl-1-nonanol; 2-butyl-1-octanol; 2-methyl-1-tridecanol; 2-ethyl-1-dodecanol; 2-propyl-1-undecanol; 2-butyl-1-decanol; 2-pentyl-1-nonanol; 2-hexyl-1-octanol; 2-methyl-1-pentadecanol; 2-ethyl-1-tetradecanol; 2-propyl-1-tridecanol; 2-butyl-1-dodecanol; 2-pentyl-1-undecanol; 2-hexyl-1-decanol; 2-heptyl-1-decanol; 2-hexyl-1-nonanol; 2-octyl-1-octanol; 2-methyl-1-heptadecanol; 2-ethyl-1-hexadecanol; 2-propyl-1-pentadecanol; 2-butyl-1-tetradecanol; 1-pentyl-1-tridecanol; 2-hexyl-1-dodecanol; 2-octyl-1-decanol; 2-nonyl-1-nonanol; 2-dodecanol; 3-dodecanol; 4-dodecanol; 5-dodecanol; 6-dodecanol; 2-tetradecanol; 3-tetradecanol; 4-tetradecanol; 5-tetradecanol; 6-tetradecanol; tetradecanol; 7-tetradecanol; 2-hexadecanol; 3-hexadecanol; 4-hexadecanol; 5-hexadecanol; 6-hexadecanol; 7-hexadecanol; 8-hexadecanol; 2-octadecanol; 3-octadecanol; 4-octadecanol; 5-octadecanol; 6-octadecanol; 7-octadecanol; 8-octadecanol; 9-octadecanol; 9-octadedcanol-1; 2,4,6-trimethyl-1-heptanol; 2,4,6,8-tetramethyl-1-nonanol; 3,5,5-trimethyl-1-hexanol; 3,5,5,7,7-pentamethyl-1-octanol; 3-butyl-1-nonanol; 3-butyl-1-undecanol; 3-hexyl-1-undecanol; 3-hexyl-1-tridecanol; 3-octyl-1-tridecanol; 2-methyl-2-undecanol; 3-methyl-3-undecanol; 4-methyl-4-undecanol; 2-methyl-2-tridecanol; 3-methyl-3-tridecanol; 4-methyl-3-tridecanol; 4-methyl-4-tridecanol; 3-ethyl-3-decanol; 3-ethyl-3-dodecanol; 2,4,6,8-tetramethyl-2-nonanol; 2-methyl-3-undecanol; 2-methyl-4-undecanol; 4-methyl-2-undecanol; 5-methyl-2-undecanol; 4-ethyl-2-decanol; 4-ethyl-3-decanol; and mixtures thereof.

In the same or other embodiments, the co-active agent can include an alkoxylated alcohol, or a monoalkyl ether thereof. In certain embodiments, the co-active agent can be an alkoxylated alcohol, or monoalkyl ether thereof, according to Formula (III):

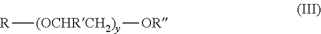

wherein R is a hydrocarbyl group having from 12 to 60 carbon atoms; R′ is chosen from H or C₁-C₄ alkyl; R″ is chosen from H or a hydrocarbyl group having from 1 to 10 carbon atoms; and y is an integer from 1 to 100.

Accordingly, in certain embodiments, R of Formula (III) can be an alkyl group having from 12 to 30 carbon atoms. In other embodiments, R can contain from 12 to 22 carbon atoms, and ideally from 12 to 18 carbons, or 12 to 15 carbons. Thus, in certain embodiments, or in the same embodiments as those previously described with respect to Formula (III), R′ can be methyl or ethyl. In still other embodiments, R′ can be H.

Accordingly, in certain embodiments the stabilizer compositions according to the present invention can include a co-active agent that can be alkoxylated with one or more alkoxide. In some embodiments, the co-active agent according to Formula (III) can be ethoxylated. In other embodiments, the co-active agent according to Formula (III) can be propoxylated. In the same or other embodiments, the co-active agent according to Formula (III) can include a mixture of ethoxylated alcohols and propoxylated alcohols, or can be an alcohol that is both ethoxylated and propoxylated.

While the degree of alkoxylation (i.e., the number of ethoxy and/or propoxy groups in the co-active agent) can vary amongst co-active agents, the degree of alkoxylation contemplated by the inventors for the co-active agents described herein ranges from 1 to 100. In certain embodiments, the degree of alkoxylation given by “y” of the co-active agent according to Formula (III) can range from 1 to 75. In other embodiments, the degree of alkoxylation can range from 2 to 25, or from 2 to 12.

In any of the embodiments discussed above for the co-active agent according to Formula (III), the co-active agent can be an alcohol, such as when R″ is H. In other embodiments, the co-active agent can be a monoalkyl ether derived from such alcohol, such as when R″ is a hydrocarbyl having from 1 to 10 carbon atoms. In one embodiment where the co-active agent is a monoalkyl ether according to Formula (III), R″ is methyl.

In certain embodiments, the co-active agent can be selected from one or more of the following ethoxylated and/or propoxylated alcohols, wherein the alcohol is chosen from docosyl alcohol; stearyl alcohol; oleyl alcohol; cetyl alcohol; isotridecyl alcohol; lauryl alcohol; C₁₂-C₃₀ alcohols; C₁₆/C₁₈ alcohol mixtures; C₂₀-C₅₀ alcohols; or monoalkyl ethers of these ethoxylated and/or propoxylated alcohols. In a particular embodiment, the co-active agent is an ethoxylated and propoxylated C₁₂-C₃₀ alcohol. In another particular embodiment, the co-active agent can be a mixture of ethoxylated and propoxylated C₁₂-C₁₅ alcohols having from 2 to 5 ethylene oxide groups and propylene oxide groups.

While the alkoxylated alcohols or monoalkyl ethers thereof according to Formula (III) of the invention can be made by known methods already available to those of ordinary skill in the art, there are also a host of such compounds presently commercially available. Such commercially available alkoxylated compounds include, but are not limited to, any of the alkoxylated alcohols commercially available or known under the BRIJ® trade name (available from Sigma Aldrich, St. Louis, MO); JEECOL® (available from Jeen Int'l Corp.); NOVEL® (available from Sasol Olefins & Surfactants, Hamburg, Germany); UNITHOX® Ethoxylates (available from Baker Hughes, Inc.); GENAPOL® (available from Clariant SE, Switzerland); and HETOXOL® (available from Global Seven, Rockaway, NJ). While the compounds can generally be in any form (i.e., liquid, solid, semi-solid, flake, pastille), solids or semi-solid forms are preferred.

In certain embodiments, the co-active agent can be chosen from any one or more of diethylene glycol octadecyl ether (available as BRIJ® S2); triethylene glycol octadecyl ether (available as BRIJ® S3); 2-(dodecyloxy) ethanol (available as laureth 2); polyoxyethylene (5) octadecyl ether (available as Steareth-5); polyoxyethylene (10) octadecyl ether (available as JEECOL® SA-10); polyoxyethylene (2) oleyl ether (available as BRIJ® 93); polyoxyethylene docosyl ether (available as NOVEL® 22-4); polyoxyethylene (2.6) saturated linear, C₂₀ to C₅₀ synthetic alcohol (available as UNITHOX® 420); C₁₂-C₁₅ oxo alcohol having 2 EO and 5 PO (available as GENAPOL® EP 2525); C₁₂-C₁₅ oxo alcohol having 5 EO and 2 PO (available as GENAPOL® EP 2552); or polyoxyethylene (4) oleyl ether (available as HETOXOL® OL-4).

Esters of fatty acids have a wide range of commercial applications and their alkoxylated forms are also suitable for use as co-active agents in the stabilizer compositions according to the invention. The term “ester” has its ordinary meaning as used throughout the specification and claims and refers to compounds where a hydroxyl group of the reference compound is replaced with an —OCO-alkyl group. Any acid derived from fats by hydrolysis is suitable but it must include at least one alkoxide. The fatty acid can be linear, branched, or cyclic, and can be monounsaturated, polyunsaturated, or saturated.

In an embodiment, the alkoxylated esters of fatty acids can include mono- or di-esters of (poly)ethylene or (poly)propylene glycol. As used herein the term “(poly)ethylene glycol” refers to “polyethylene glycol” as well as “ethylene glycol.” The same applies to the term “(poly)propylene glycol.” In certain embodiments, one or more ester portion of the (poly)ethylene or (poly)propylene glycol is independently chosen from a hydrocarbyl group having from 12 to 30 carbon atoms. In a particular embodiment, the hydrocarbyl can be an alkyl group having from 12 to 18 carbon atoms.

Commercially available mono- or di-esters of (poly)ethylene or (poly)propylene glycol include any of those under the brand name PEGOSPERSE® (available from Lonza, Ltd. Switzerland). Thus, in various embodiments the co-active agent can be an ethoxylated and/or propoxylated ester of fatty acid chosen from one or more of ethylene glycol monostearate, ethylene glycol distearate, diethylene glycol monostearate, diethylene glycol distearate, diethylene glycol monooleate, diethylene glycol monolaurate, polyethylene glycol monostearate, polyethylene glycol distearate, polyethylene glycol monooleate, polyethylene glycol dioleate, polyethylene glycol monotallate, polyethylene glycol ditallate, polyethylene glycol monocaprylate/caprate, polyethylene glycol monolaurate, polyethylene glycol dilaurate, 2-(2-hydroxyethoxy)ethyl dodecanoate; polyethylene glycol beeswax, mannitol monooleate, natural oil ethoxylates/propoxylates, ricinoleic acid ethoxylates; or pentaerythrityl dioleate.

In other embodiments, the co-active agent can be sorbitan esters, or ethoxylates thereof, which have also been shown to act synergistically with the UV stabilizers to provide improved stabilization properties in an organic material stabilized with these compounds.

Preparation of sorbitan esters can be achieved by reacting sorbitol with a fatty acid of interest to make the corresponding fatty acid ester according to techniques and under conditions well known to those skilled in the art. Sorbitan esters and ethoxylates thereof are also commercially available from various suppliers under different trade names. Sorbitan esters are available under their generally recognized chemical name from Sigma Aldrich, St. Louis, MO, or under the PROTACHEM® tradename from Protameen Chemicals, Totowa, NJ. Sorbitan ester ethoxylates are commercially available as TWEEN® (available from Sigma Aldrich Corp.) or JEESORB® (available from JEEN® Int'l Corp.) among others.

In certain embodiments, the co-active agent can include, but are not limited to, one or more sorbitan ester chosen from sorbitan monolaurate; sorbitan monopalmitate; sorbitan monostearate; sorbitan monooleate; sorbitan monotallate; sorbitan sesquioleate; or sorbitan tristearate. Sorbitan monstearate is a particularly suitable sorbitan ester for use as a co-active agent with the present invention in certain embodiments.

In other embodiments, the co-active agent can include sorbitan ester ethoxylates. While those skilled in the art will recognize that there are many sorbitan ester ethoxylates suitable for use as a co-active agent with the stabilizer compositions according to the present invention, particularly suitable sorbitan ester ethoxylates include one or more chosen from polysorbate 20 (available as TWEEN® 20); polysorbate 21 (available as TWEEN® 21); polysorbate 40 (available as TWEEN® 40); polysorbate 60 (available as TWEEN® 60); polysorbate 61 (available as TWEEN® 61); polysorbate 80 (available as TWEEN® 80); or polysorbate 81 (available as TWEEN® 81).

Monoglycerol and polyglycerol esters, and ethoxylates thereof, are also suitable for use as co-active agents with the stabilizer compositions of the present invention. In certain embodiments the number of glycerol units can be up to and including 20. In other embodiments, the number of glycerol units can be up to and including 10. In the same or other embodiments, the one or more ester portion of the monoglycerol or polyglycerol ester can be independently chosen from a hydrocarbyl group having from 12 to 30 carbon atoms. In a particular embodiment, the ester portion can include a C₁₂-C₁₈ alkyl group, which can also include mixtures of isomers of those alkyl groups.

Accordingly, in certain embodiments the co-active agent can be one or more monoglycerol ester or polyglycerol ester chosen from glycerol monostearate; glycerol distearate; glycerol oleate; glycerol triisostearate; diglycerol monostearate; diglycerol diisostearate; diglycerol monooleate; triglycerol monostearate; hexaglycerol distearate; polyglyceryl-10 monostearate; polyglyceryl-10 monooleate; polyglycerol-10-dipalmitate; polyglycerol-10 decaoleate; polyglycerol-3 polyricinoleate; polyglycerol ester of vegetable-based fatty acids; polyglycerol-4 caprate; polyglycerol-3 caprate; polyglycerol-4 isostearate; polyglycerol-3 oleate; polyglycerol-6 distearate; polyglyceryl-9 stearate; or polyglycerol-4 oleate. Such compounds are generally commercially available from various suppliers under different trade names such as POLYALDO®™ (from Lonza Ltd, Switzerland) or CITHROL®™ (from Croda Int'l Plc, UK).

Ethoxylated forms of the monoglycerol esters and polyglycerol esters described above are also useful as co-active agents in the stabilizer compositions of the present invention. Thus, in certain embodiments the co-active agent includes, but is not limited to, diglycerol distearate ethoxylates; glycerol stearate ethoxylates; glycerol oleate ethoxylates; glycerol laurate ethoxylates; glycerol cocoate ethoxylates; diglycerol distearate ethoxylates; and diglycerol laurate ethoxylates.

Other ethoxylated monoglycerol esters include ethoxylated castor oil or its hydrogenated form, and are also suitable for use as co-active agents in the stabilizer compositions according to the invention. Such ethoxylated castor oil or ethoxylated hydrogenated castor oil include those available from Croda Int'l Plc (UK) under the tradenames ETOCAS®™ 5, CRODURET®™ 7, and CRODURET®™ 25. Those skilled in the art will appreciate that various natural oil ethoxylates can also be suitable for use as a co-active agent and can include, for example, those from soya oil; groundnut oil; neem oil; and palm oil.

Sugar esters can also be used as co-active agents in the stabilizer compositions described herein. The sugars can be monosaccharides, disaccharides, or oligosaccharides and the ester portion is preferably derived from a fatty acid having from 12 to 24 carbon atoms. Representative monosaccharides include, but are not limited to, glucose, fructose, and galactose. Preferred disaccharides include, but are not limited to, sucrose, maltose, and lactose. While those skilled in the art will appreciate that there are, therefore, numerous sugar esters of fatty acids that can be used as the co-active agent, particularly suitable compounds include, but are not limited to, sucrose stearate; sucrose distearate; sucrose polystearate; sucrose monopalmitate; sucrose laurate; and sucrose polypalmitate. One such sucrose stearate is commercially available from Croda Int'l Plc (UK) under the trade name CRODESTA® F-160.

In still further embodiments, the co-active agent can be an alkoxylated fatty amine according to Formula (V)

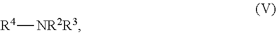

esters thereof, or salts thereof, or

an alkoxylated fatty amide according to Formula (VI)

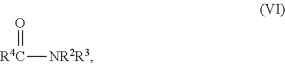

wherein R⁴ of Formula (V) and Formula (VI) is independently chosen from a C₅-C₆₀ hydrocarbyl group, optionally interrupted with one or more hetero atoms; and each of R² and R³ of Formula (V) and Formula (VI) is independently chosen from H, a C₁-C₃₀ alkyl, or (—CH₂CHR⁵O—)ₙ—H, wherein R⁵ is chosen from H or methyl, and n is an integer from 1 to 100; and provided that at least one of R² or R³ of Formula (V) and Formula (VI) is chosen from (—CH₂CHR⁵O—)n-H.

In some embodiments, R⁴ of Formula (V) and Formula (VI) can be independently chosen from an alkyl group having from 8 to 30 carbon atoms. In certain embodiments of the co-active agent according to Formula (V) or Formula (VI), the alkyl group may contain from 12 to 22 carbon atoms. In the same or other embodiments, the alkyl group may be interrupted by one or more hetero atom chosen from N, O, or S. In one particular embodiment when the co-active agent according to either Formula (V) or Formula (VI) is interrupted, it is interrupted by one or more oxygen atom.

As previously indicated, the degree of alkoxylation contemplated by the co-active agents according to Formula (V) and Formula (VI) ranges from 1 to 100 for each of R² and/or R³ when chosen from (—CH₂CHR⁵O—)n-H, as provided by the value assigned to “n”. In certain embodiments, the degree of alkoxylation of the co-active agent according to Formula (V) or Formula (VI) can range from 1 to 75. In other embodiments, the degree of alkoxylation can range from 2 to 25, or from 2 to 12. For all embodiments, the degree of alkoxylation can be as between either one of R² or R³, or as a combined total for the co-active agent of either Formula (V) or Formula (VI). In a particular embodiment, the total degree of alkoxylation can be 20 (i.e., the total value of “n” among R² and/or R³ in either Formula (V) or Formula (VI) is 20).

Commercially available alkoxylated fatty amines include, but are not limited to, any of the alkoxylated fatty amines under the brand name TOMAMINE® (available from Air Products and Chemicals Inc., Allentown, PA); ETHOMEEN® (available from Akzo Nobel N.V., Netherlands); and GENAMIN® (available from Clariant SE, Switzerland). Thus, in certain embodiments the co-active agent of the stabilizer composition according to the present invention can be an alkoxylated fatty amine according to Formula (V) and may be chosen from ethoxylated and/or propoxylated forms of one or more chosen from stearyl amines; oleyl amines; tallow amines; hydrogenated tallow amines; cetyl amines; capryl amines; or cocoamines. In a particular embodiment, oleyl amine can be ethoxylated and propoxylated.

Salts of any of the alkoxylated fatty amines according to Formula (V) are also suitable as co-active agents. While those skilled in the art will recognize that any fatty acid salts of the alkoxylated fatty amines according to Formula (V) would be suitable for use as a co-active agent for use in the stabilizer compositions according to the invention, a particularly advantageous salt includes carboxylic acid salts. In certain embodiments, the carboxylic acid salts of alkoxylated fatty amines according to Formula (V) can be derived from a carboxylic acid moiety having from 2 to 30 carbon atoms. In a particular embodiment, the carboxylic acid moiety can have from 12 to 24 carbon atoms.

Commercially available alkoxylated fatty amides include, but are not limited to, any of the alkoxylated fatty amides under the brand name PROTAMIDE®™ (available from Protameen Chemicals, Totowa, NJ); or SERDOX® (available from Elementis Specialties, East Windsor, NJ). Thus, in some embodiments of the invention the co-active agent of the stabilizer composition according to the present invention can be an alkoxylated fatty amide according to Formula (V) and can be chosen from one or more of cocoamide monoethanolamine; cocoamide diethanolamine; lauramide diethanolamine; oleamide diethanolamine; oleamide monoethanolamine; or ethoxylated and/or propoxylated forms thereof.

In certain instances, it may be desirable to further alkoxylate the fatty amides according to Formula (VI). Thus, in some embodiments the alkoxylated fatty amides according to Formula (VI) can be further alkoxylated with from 1 to 50 ethylene oxide and/or propylene oxide groups.

Yet another class of co-active agent suitable for use in the stabilizer compositions according to the present invention includes block copolymers of ethylene oxide/propylene oxide (EO/PO) monomers. In certain embodiments, the ratio of EO/PO monomers can be from 1:99 to 99:1. In a particular embodiment, the ratio of EO/PO can be from 1:9 to 9:1. In the same or other embodiments, the weight average molecular weight of such copolymers can be up to and including 15,000 Da, wherein the wt. % of oxy ethylene is from 10 wt. % to 90 wt. % based on the total weight of the copolymer. In some embodiments, the weight average molecular weight of the EO/PO block copolymers can be up to and including 10,000 Da. Commercially available forms of such EO-PO block copolymers include any of those under the PLURONIC® brand (available from BASF, Germany) including, but not limited to, PLURONIC® L31; L81; L101; L62; L43; L35; and F38.

In some embodiments, the co-active agent is absent from the stabilizer composition, the masterbatch concentrate, the stabilized polymer composition, and the stabilized article of manufacture. As used herein, “absent” can mean less than 0.1 wt. %, less than 0.01 wt. %, less than 0.001 wt. %, or less than 0.0001 wt. % of the co-active agent is present. As used herein, “absent” can also mean that no co-active agent is intentionally added, or that no co-active agent can be detected analytically.

UV stabilizers. With regard to the UV stabilizer system of the stabilizer composition, the inventors have also surprisingly discovered that ortho-hydroxyphenyl triazines are an effective class of triazines for use in combination with the co-synergist and optionally co-active agent of the stabilizer composition. Ortho-hydroxyphenyl triazines are well known in the art and in the field of stabilizer additive technology. They have been disclosed and treated in many references and patents including U.S. Pat. Nos. 6,051,164; and 6,843,939, the orthohydroxyphenyl triazines compounds of which are incorporated herein by reference. Particularly preferred orthohydroxyphenyl triazines include 2-(2′-hydroxyphenyl)-1,3,5-triazine compounds according to Formula (I):

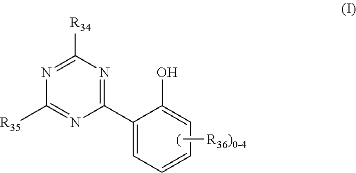

wherein
R₃₄ and R₃₅ are the same or different and are independently chosen from
a C₆-C₁₀ aryl group, wherein the C₆-C₁₀ aryl group is optionally substituted at from 1 to 3 substitutable positions with one or more group chosen from OH, halogen, C₁-C₁₂ alkyl, C₁-C₁₂ alkoxy, C₁₋₁₂ alkoxyester, C₂₋₁₂ alkanoyl, or phenyl, wherein the phenyl is optionally substituted at from 1 to 3 substitutable positions with one or more group chosen from: hydroxyl, halogen, C₁₋₁₂ alkyl, C₁₋₁₂ alkoxy, C₁₋₁₂ alkoxyester, or C₂₋₁₂ alkanoyl;
mono- or di-C₁-C₁₂ hydrocarbyl-substituted amino;
C₂-C₁₂ alkanoyl;
C₁-C₁₂ alkyl;
C₁-C₁₀ acyl; or
C₁-C₁₀ alkoxyl; and
R₃₆ is a substituent that is the same or different at from 0 to 4 positions of the phenoxy portion of Formula (I) and is independently chosen from hydroxyl, halogen, C₁-C₁₂ alkyl, C₁-C₁₂ alkoxy, C₁-C₁₂ alkoxyester, C₂-C₁₂ alkanoyl; phenyl; or C₁-C₁₂ acyl.

Commercially available orthohydroxyphenyl triazines include, but are not limited to, those under the trade names CYASORB® UV-1164 (available from Cytec Industries Inc., Woodland Park, NJ); TINUVIN® 1577FF or TINUVIN® 400 (available from BASF, Ludwigshafen, Germany). In certain embodiments the orthohydroxyphenyl triazine compound of the stabilizer composition includes, but is not limited to, one or more of the following compounds:
4,6-bis-(2,4-dimethylphenyl)-2-(2-hydroxy-4-octyloxyphenyl)-s-triazine;
2-(4,6-Diphenyl-1,3,5-triazin-2-yl-)-5-((hexyl)oxyl-phenol;
4,6-bis-(2,4-dimethylphenyl)-2-(2,4-dihydroxyphenyl)-s-triazine;
2,4-bis(2,4-dihydroxyphenyl)-6-(4-chlorophenyl)-s-triazine;
2,4-bis[2-hydroxy-4-(2-hydroxy-ethoxy)phenyl]-6-(4-chlorophenyl)-s-triazine;
2,4-bis[2-hydroxy-4-(2-hydroxy-4-(2-hydroxy-ethoxy)phenyl]-6-(2,4-dimethylphenyl)-s-triazine;
2,4-bis[2-hydroxy-4-(2-hydroxyethoxy)phenyl]-6-(4-bromophenyl)-s-triazine;
2,4-bis[2-hydroxy-4-(2-acetoxyethoxy)phenyl]-6-(4-chlorophenyl)-s-triazine;
2,4-bis(2,4-dihydroxyphenyl)-6-(2,4-dimethylphenyl)-s-triazine;
2,4-bis(4-biphenylyl)-6-[2-hydroxy-4-[(octyloxycarbonyl)ethylideneoxy]phenyl]-s-triazine;
2,4-bis(4-biphenylyl)-6-[2-hydroxy-4-(2-ethylhexyloxy)phenyl]-s-triazine;
2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine;
2,4-bis(2,4-dimethylphenyl)-6-[2-hydroxy-4(-3-benzyloxy-2-hydroxypropyloxy)phenyl]-s-triazine;
2,4-bis(2-hydroxy-4-n-butyloxyphenyl)-6-(2,4-di-n-butyloxyphenyl)-s-triazine;
2,4-bis(2,4-dimethylphenyl)-6-[2-hydroxy-4-(3-nonyloxy-2-hydroxypropyloxy)-5-α-cumylphenyl]-s-triazine;
methylenebis-{2,4-bis(2,4-dimethylphenyl)-6-[2-hydroxy-4-(3-butyloxy-2-hydroxypropoxy)phenyl]-s-triazine;
methylene bridged dimer mixture bridged in the 3:5′, 5:5′ and 3:3′ positions in a 5:4:1 ratio;
2,4,6-tris(2-hydroxy-4-isooctyloxycarbonyliso-propylideneoxy-phenyl)-s-triazine;
2,4,6,-tris(2-hydroxy-4-octyloxy-phenyl)-1,3,5-triazine;
2,4-bis(2,4-dimethylphenyl)-6-(2-hydroxy-4-hexyloxy-5-α-cumylphenyl)-s-triazine;
2-(2,4,6-trimethylphenyl)-4,6-bis[2-hydroxy-4-(3-butyloxy-2-hydroxypropyloxy)phenyl]-s-triazine;
2,4,6-tris[2-hydroxy-4-(3-sec-butyloxy-2-hydroxypropyloxy)-phenyl]-s-triazine;
mixture of 4,6-bis-(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine;
4,6-bis-(2,4-dimethylphenyl)-2-(2-hydroxy-4(3-(2-ethylhexyloxy)-2-hydroxypropoxy)-phenyl)-s-triazine; or
4,6-diphenyl-2-(4-hexyloxy-2-hydroxyphenyl)-s-triazine.

Other UVAs that are suitable for use with the co-active agents described herein include one or more of orthohydroxybenzophenones, orthohydroxyphenylbenzotriazoles, or benzoxazinone compounds. In some embodiments, the UVA component of the stabilizer composition includes ortho-hydroxytriazines, ortho-hydroxybenzophenones, ortho-hydroxyphenyl benzotriazoles, or benzoxazinones individually. In other embodiments, the UVA component includes a combination of two or more of such UVA compounds. Ortho-hydroxybenzophenones, ortho-hydroxybenzotriazoles, oxanilides, cyanoacrylates, and benzoxazinones are also well known to those skilled in the art of stabilizer additive technology. Their suitability for use as a component of stabilizer compositions has been previously disclosed and treated in at least U.S. Pat. Nos. 2,976,259; 3,049,443; 3,399,169; 4,322,455; 4,446,262; 5,264,539; 6,051,164; 6,677,392; and 6,774,232, as well as U.S Publication No. 2006/0052491, the ortho-hydroxybenzophenones, ortho-hydroxybenzotriazoles, and benzoxazinones of which are incorporated herein by reference as suitable for use with the stabilizer compositions of the instant invention.

Some other non-limiting examples of orthohydroxybenzophenones for use with the stabilizer compositions contemplated herein include any one or more of 2-hydroxy-4-methoxybenzophenone (commercially available from Cytec Industries Inc. as CYASORB® UV-9); 2,2′-dihydroxy-4-methoxybenzophenone (commercially available from Cytec Industries Inc. as CYASORB® UV-24); 2-hydroxy-4-octyloxybenzophenone (commercially available from Cytec Industries Inc. as CYASORB® UV-531); 2′-dihydroxy-4,4′-di-methoxybenzophenone; 2,2′-dihydroxybenzophenone; 2,2′,4,4′-tetrahydroxybenzophenone; 2,2′-dihydroxy-4,4′-dimethoxybenzophenone; 2,2′-dihydroxy-4,4′-diethoxybenzophenone; 2,2′-dihydroxy-4,4′-dipropoxybenzophenone; 2,2′-dihydroxy-4,4′-dibutoxybenzophenone; 2,2′-dihydroxy-4-methoxy-4′-ethoxybenzophenone; 2,2′-dihydroxy-4-methoxy-4′-propoxybenzophenone; 2,2′-dihydroxy-4-methoxy-4′-butoxybenzophenone; 2,2′-dihydroxy-4-ethoxy-4′-propoxybenzophenone; 2,2′-dihydroxy-4-ethoxy-4′-butoxybenzophenone; 2,3′-dihydroxy-4,4′-dimethoxybenzophenone; 2,3′-dihydroxy-4-methoxy-4′-butoxybenzophenone; 2-hydroxy-4,4′,5′-trimethoxybenzophenone; 2-hydroxy-4,4′,6′-tributoxybenzophenone; 2-hydroxy-4-butoxy-4′,5′-dimethoxybenzophenone; 2-hydroxy-4-ethoxy-2′,4′-dibutylbenzophenone; 2-hydroxy-4-propoxy-4′,6′-dichlorobenzophenone; 2-hydroxy-4-propoxy-4′,6′-dibromobenzophenone; 2,4-dihydroxybenzophenone; 2-hydroxy-4-ethoxybenzophenone; 2-hydroxy-4-propoxybenzophenone; 2-hydroxy-4-butoxybenzophenone; 2-hydroxy-4-methoxy-4′-methylbenzophenone; 2-hydroxy-4-methoxy-4′-ethylbenzophenone; 2-hydroxy-4-methoxy-4′-propylbenzophenone; 2-hydroxy-4-methoxy-4′-butylbenzophenone; 2-hydroxy-4-methoxy-4′-tertiary butylbenzophenone; 2-hydroxy-4-methoxy-4′-chlorobenzophenone; 2-hydroxy-4-methoxy-2′-chlorobenzophenone; 2-hydroxy-4-methoxy-4′-bromobenzophenone; 2-hydroxy-4,4′-dimethoxybenzophenone; 2-hydroxy-4,4′-dimethoxy-3-methylbenzophenone; 2-hydroxy-4,4′-dimethoxy-2′-ethylbenzophenone; 2-hydroxy-4,4′,5′-trimethoxybenzophenone; 2-hydroxy-4-ethoxy-4′-methylbenzophenone; 2-hydroxy-4-ethoxy-4′-ethylbenzophenone; 2-hydroxy-4-ethoxy-4′-propylbenzophenone; 2-hydroxy-4-ethoxy-4′-butylbenzophenone; 2-hydroxy-4-ethoxy-4′-methoxybenzophenone; 2-hydroxy-4,4′-diethoxybenzophenone; 2-hydroxy-4-ethoxy-4′-propoxybenzophenone; 2-hydroxy-4-ethoxy-4′-butoxybenzophenone; 2-hydroxy-4-ethoxy-4′-chlorobenzophenone; or 2-hydroxy-4-ethoxy-4′-bromobenzophenone.

Some other non-limiting examples of ortho-hydroxyphenyl benzotriazoles useful in the UVA component of the stabilizer compositions described herein include any one or more of those commercially available from Cytec Industries Inc. (e.g., CYASORB® UV-5411), or 2-(2′-hydroxy-5′-methylphenyl)-benzotriazole; 2-(2′-hydroxy-5′-tert-butylphenyl)benzotriazole; 2-(2′-hydroxy-3′-methyl-5′-tert-butylphenyl)-benzotriazole; 2-(2′-hydroxy-5′-cyclohexylphenyl)-benzotriazole; 2-(2′-hydroxy-3′,5′-dimethylphenyl)-benzotriazole; 2-(2′-hydroxy-5′-tert-butylphenyl)-5-chloro-benzotriazole; 2-(2′-hydroxy-5-tert-octylphenyl)-2H-benzotriazole; 2-(2′-hydroxy-5-octylphenyl)-2H-benzotriazole; 2-(3′,5′-di-tert-butyl-2′-hydroxyphenyl)-5-chlorobenzotriazole; 2-(3′,5′-di-tert-amyl-2′-hydroxyphenyl)benzotriazole (commercially available from Cytec Industries Inc. as CYASORB® UV-2337); 2-(3′,5′-bis(α,α-dimethylbenzyl)-2′-hydroxyphenyl)benzotriazole; 2-(3′-tert-butyl-2′-hydroxy-5′-(2-octyloxycarbonylethyl)phenyl)benzotriazole; 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; 2-[2′-hydroxy-3′-(α,α-dimethylbenzyl)-5′-(1,1,3,3-tetramethyl-butyl)phenyl]benzotriazole; 5-trifluoromethyl-2-(2-hydroxy-3-α-cumyl-5-tert-octylphenyl)-2H-benzotriazole; 2-(2′-hydroxy-5′-(2-hydroxyethyl)phenyl)benzotriazole; 2-(2′-hydroxy-5′-(2-methacryloyloxyethyl)phenyl)benzotriazole; 2-(3′-tert-butyl-5′-methyl-2′-hydroxyphenyl)-5-chloro-benzotriazole; 2-(3′-sec-butyl-5′-tert.butyl-2′-hydroxyphenyl)-benzotriazole; 2-(3′,5′-di-tert-butyl-2′-hydroxyphenyl)-benzotriazole; 2-(5′-tert-octyl-2′-hydroxyphenyl)-benzotriazole; 2-(3′-dodecyl-5′-methyl-2′-hydroxyphenyl)-benzotriazole; 2-(3′-tert-butyl-5′-(2-octyloxycarbonylethyl)-2′-hydroxyphenyl)-5-chlorobenzotriazole; 2-(5′-methyl-2′-hydroxyphenyl)-benzotriazole; 2-(5′-tert-butyl-2′-hydroxyphenyl)-benzotriazole; or 2-(2′-hydroxy-3′-di-tert-butylphenyl)-benzotriazole.

Non-limiting examples of benzoxazinones useful in the UVA portion of the stabilizer compositions described herein include any one or more chosen from 2-methyl-3,1-benzoxazin-4-one; 2-butyl-3,1-benzoxazin-4-one; 2-phenyl-3,1-benzoxazin-4-one; 2-(1- or 2-naphthyl)-3,1-benzoxazin-4-one; 2-(4-biphenyl)-3,1-benzoxazin-4-one; 2-p-nitrophenyl-3,1-benzoxazin-4-one; 2-m-nitrophenyl-3,1-benzoxazin-4-one; 2-p-benzoylphenyl-3,1-benzoxazin-4-one; 2-p-methoxyphenyl-3,1-benzoxazin-4-one; 2-O-methoxyphenyl-3,1-benzoxazin-4-one; 2-cyclohexyl-3,1-benzoxazin-4-one; 2-p-(or m-)phthalimidephenyl-3,1-benzoxazin-4-one; N-phenyl-4-(3,1-benzoxazin-4-one-2-yl)phthalimide; N-benzoyl-4-(3,1-benzoxazine-4-one-2-yl)aniline; N-benzoyl-N-methyl-4-(3,1-benzoxazin-4-one-2-yl)-aniline; 2-[p-(N-phenylcarbamonyl)phenyl]-3,1-benzoxazin-4-one; 2-[p-(N-phenyl N-methylcarbamoyl)phenyl]-3,1-benzoxazin-4-one; 2,2′-bis(3,1-benzoxazin-4-one); 2,2′-ethylenebis(3,1-benzoxazin-4-one); 2,2′-tetramethylenebis(3,1-benzoxazin-4-one); 2,2′-hexamethylenebis(3,1-benzoxazin-4-one); 2,2′-decamethylenebis(3,1-benzoxazin-4-one); 2,2′-p-phenylenebis(3,1-benzoxazin-4-one); 2,2′-m-phenylenebis(3,1-benzoxazin-4-one); 2,2′-(4,4′-diphenylene)bis(3,1-benzoxazin-4-one); 2,2′-(2,6- or 1,5-naphthalene)bis(3,1-benzoxazin-4-one); 2,2′-(2-methyl-p-phenylene)bis(3,1-benzoxazin-4-one); 2,2′-(2-nitro-p-phenylene)bis(3,1-benzoxazin-4-one); 2,2′-(2-chloro-p-phenylene)bis(3,1-benzoxazin-4-one); 2,2′-(1,4-cyclohexylene)bis(3,1-benzoxazin-4-one); N-p-(3,1-benzoxazin-4-on-2-yl)phenyl; 4-(3,1-benzoxazin-4-on-2-yl)phthalimide; N-p-(3,1-benzoxazin-4-on-2-yl)benzoyl; 4-(3,1-benzoxazin-4-on-2-yl)aniline; 1,3,5-tri(3,1-benzoxazin-4-on-2-yl)benzene; 1,3,5-tri(3,1-benzoxazin-4-on-2-yl)naphthalene; or 2,4,6-tri(3,1-benzoxazin-4-on-2-yl)naphthalene.

HALS compounds scavenge free radicals formed in polymeric materials when exposed to UV light, and are more effective than when certain UVAs are used alone. The benefits imparted by various HALS compounds in combination with UVAs have been demonstrated in at least U.S. Pat. Nos. 6,051,164 and 6,843,939, which teachings are incorporated herein by reference. Accordingly, in certain embodiments the stabilizer compositions described herein can further include a stabilizing amount of one or more HALS compound that includes a functional group according to Formula (II):

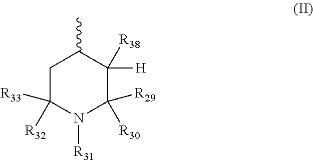

wherein
R₃₁ is chosen from: hydrogen; OH; C₁-C₂₀ hydrocarbyl; CH₂CN; C₁-C₁₂ acyl; or C₁-C₁₈ alkoxy;
R₃₈ is chosen from: hydrogen; or C₁-C₈ hydrocarbyl; and
each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or
a functional group according to Formula (IIa):

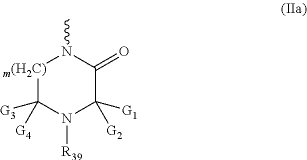

wherein
m is an integer from 1 to 2;
R₃₉ is chosen from: hydrogen; OH; C₁-C₂₀ hydrocarbyl; CH₂CN; C₁-C₁₂ acyl; or C₁-C₁₈ alkoxy; and
each of G₁-G₄ is independently chosen from C₁-C₂₀ hydrocarbyl.

Exemplary HALS compounds contemplated for use as a component of the stabilizer compositions described herein can include one or more of those commercially available from Cytec Industries Inc. such as mixture of 4-hexadecyloxy- and 4-stearyloxy-2,2,6,6-tetramethylpiperidine (e.g., CYASORB® UV-3853), or bis(2,2,6,6-tetramethylpiperidin-4-yl) sebacate; bis(2,2,6,6-tetramethylpiperidin-4-yl)succinate; bis(1,2,2,6,6-pentamethylpiperidin-4-yl)sebacate; bis(1-octyloxy-2,2,6,6-tetramethylpiperidin-4-yl)sebacate; bis(1,2,2,6,6-pentamethylpiperidin-4-yl) n-butyl 3,5-di-tert-butyl-4-hydroxybenzylmalonate; a condensate of 1-(2-hydroxyethyl)-2,2,6,6-tetramethyl-4-hydroxypiperidine and succinic acid; 2,2,6,6-tetramethylpiperidin-4-yl stearate; 2,2,6,6-tetramethylpiperidin-4-yl dodecanate; 1,2,2,6,6-pentamethylpiperidin-4-yl stearate; 1,2,2,6,6-pentamethylpiperidin-4-yl dodecanate; a condensate of N,N′-bis(2,2,6,6-tetramethylpiperidin-4-yl)hexamethylenediamine and 4-tert-octylamino-2,6-dichloro-1,3,5-triazine; tris(2,2,6,6-tetramethylpiperidin-4-yl) nitrilotriacetate; tetrakis(2,2,6,6-tetramethylpiperidin-4-yl)-1,2,3,4-butanetetracarboxylate; 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; a condensate of N,N′-bis(2,2,6,6-tetramethylpiperidin-4-yl)hexamethylenediamine and 4-morpholino-2,6-dichloro-1,3,5-triazine (commercially available from Cytec Industries Inc. as CYASORB® UV-3346); a condensate of N,N′-bis(2,2,6,6-tetramethylpiperidin-4-yl)hexamethylenediamine and 4-morpholino-2,6-dichloro-1,3,5-triazine, methylated (commercially available from Cytec Industries Inc. as CYASORB® UV-3529); a condensate of 2-chloro-4,6-bis(4-n-butylamino-2,2,6,6-tetramethylpiperidyl)-1,3,5-triazine and 1,2-bis(3-aminopropylamino)ethane; a condensate of 2-chloro-4,6-bis(4-n-butylamino-1,2,2,6,6-pentamethylpiperidyl)-1,3,5-triazine and 1,2-bis-(3-aminopropylamino)ethane; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; a mixture of 4-hexadecyloxy- and 4-stearyloxy-2,2,6,6-tetramethylpiperidine; a mixture of 4-hexadecyloxy- and 4-stearyloxy-1,2,2,6,6-pentamethylpiperidine; a condensate of N,N′-bis(2,2,6,6-tetramethylpiperidin-4-yl)hexamethylenediamine and 4-cyclohexylamino-2,6-dichloro-1,3,5-triazine; a condensate of 1,2-bis(3-aminopropylamino)ethane, 2,4,6-trichloro-1,3,5-triazine and 4-butylamino-2,2,6,6-tetramethylpiperidine; 2-undecyl-7,7,9,9-tetramethyl-1-oxa-3,8-diaza-4-oxospiro[4.5]decane; oxo-piperanzinyl-triazines; a reaction product of 7,7,9,9-tetramethyl-2-cycloundecyl-1-oxa-3,8-diaza-4-oxospiro[4.5]decane and epichlorohydrin; tetrakis(2,2,6,6-tetramethyl-4-piperidyl) butane-1,2,3,4-tetracarboxylate; 1,2,3,4-butanetetracarboxylic acid, tetrakis(1,2,2,6,6-pentamethyl-4-piperidinyl)ester; 1,2,3,4-butanetetracarboxylic acid, 1,2,2,6,6-pentamethyl-4-piperdinyl tridecyl ester; 1,2,3,4-butanetetracarboxylic acid, 2,2,6,6-tetramethyl-4-piperidinyl tridecyl ester; 1,2,3,4-butanetetracarboxylic acid, polymer with 2,2,6,6-tetramethyl-2,4,8,10-tetraoxaspiro[5.5]-undecane-3,9-diethanol,1,2,2,6,6-pentamethyl-4-piperdinyl ester; 1,2,3,4-butanetetracarboxylic acid, polymer with 2,2,6,6-tetramethyl-2,4,8,10-tetraoxaspiro[5.5]-undecane-3,9-diethanol, 2,2,6,6-tetramethyl-4-piperdinyl ester; bis(1-undecanoxy-2,2,6,6-tetramethylpiperidin-4-yl)carbonate; 1-(2-hydroxy-2-methylpropoxy)-2,2,6,6-tetramethyl-4-piperdinol; 1-(2-hydroxy-2-methylpropoxy)-4-octadecanoyloxy-2,2,6,6-tetramethylpiperidine; 1-(4-octadecanoyloxy-2,2,6,6-tetramethylpiperidin-1-yloxy)-2-octadecanoyloxy-2-methylpropane; 1-(2-hydroxyethyl)-2,2,6,6-tetramethyl-4-piperdinol; a reaction product of 1-(2-hydroxyethyl)-2,2,6,6-tetramethyl-4-piperdinol and dimethylsuccinate; 2,2,4,4-tetramethyl-7-oxa-3,20-diazadispiro[5.1.11.2]heneicosan-21-one; the ester of 2,2,6,6-tetramethyl-4-piperidinol with higher fatty acids; 3-dodecyl-1-(2,2,6,6-tetramethyl-4-piperidyl)pyrrolidine-2,5-dione; 1H-Pyrrole-2,5-dione, 1-octadecyl-, polymer with (1-methylethenyl)benzene and 1-(2,2,6,6-tetramethyl-4-piperidinyl)-1H-pyrrole-2,5-dione; piperazinone, 1,1′,1″-[1,3,5-triazine-2,4,6-triyltris[(cyclohexylimino)-2,1-ethanediyl]]tris[3,3,5,5-tetramethyl-; piperazinone, 1,1′,1″-[1,3,5-triazine-2,4,6-triyltris[(cyclohexylimino)-2,1-ethanediyl]]tris[3,3,4,5,5-pentamethyl-; the reaction product of 7,7,9,9-tetramethyl-2-cycloundecyl-1-oxa-3,8-diaza-4-oxospiro[4.5]decane and epichlorohydrin; the condensate of N,N′-bis(2,2,6,6-tetramethylpiperidin-4-yl)hexamethylenediamine and 4-cyclohexylamino-2,6-dichloro-1,3,5-triazine; the condensate of 1,2-bis(3-aminopropylamino)ethane, 2,4,6-trichloro-1,3,5-triazine and 4-butylamino-2,2,6,6-tetramethylpiperidine; the condensate of N,N′-bis(2,2,6,6-tetramethylpiperidin-4-yl)hexamethylenediamine and 4-morpholino-2,6-dichloro-1,3,5-triazine; the condensate of 2-chloro-4,6-bis(4-n-butylamino-2,2,6,6-tetramethylpiperidyl)-1,3,5-triazine and 1,2-bis(3-aminopropylamino)ethane; the condensate of 2-chloro-4,6-bis(4-n-butylamino-1,2,2,6,6-pentamethylpiperidyl)-1,3,5-triazine and 1,2-bis-(3-aminopropylamino)ethane; 2-[(2-hydroxyethyl)amino]-4,6-bis[N-(1-cyclohexyloxy-2,2,6,6-tetramethylpiperidin-4-yl)butylamino-1,3,5-triazine; propanedioic acid, [(4-methoxyphenyl)-methylene]-bis-(1,2,2,6,6-pentamethyl-4-piperidinyl) ester; tetrakis(2,2,6,6-tetramethylpiperidin-4-yl)-1,2,3,4-butanetetracarboxylate; benzenepropanoic acid, 3,5-bis(1,1-dimethylethyl)-4-hydroxy-, 1-[2-[3-[3,5-bis(1,1-dimethylethyl)-4-hydroxyphenyl]-1-oxopropoxy]ethyl]-2,2,6,6-tetramethyl-4-piperidinyl ester; N-(1-octyloxy-2,2,6,6-tetramethylpiperidin-4-yl)-N′-dodecyloxalamide; tris(2,2,6,6-tetramethylpiperidin-4-yl) nitrilotriacetate; 1,5-dioxaspiro{5,5}undecane-3,3-dicarboxylic acid, bis(1,2,2,6,6-pentamethyl-4-piperidinyl): 1,5-dioxaspiro{5,5}undecane-3,3-dicarboxylic acid, bis(2,2,6,6-tetramethyl-4-piperidinyl); the condensate of 1-(2-hydroxyethyl)-2,2,6,6-tetramethyl-4-hydroxypiperidine and succinic acid; the condensate of N,N′-bis(2,2,6,6-tetramethylpiperidin-4-yl)hexamethylenediamine and 4-tert-octylamino-2,6-dichloro-1,3,5-triazine; 1,2,3,4-butanetetracarboxylic acid, 1,2,2,6,6-pentamethyl-4-piperidinyl tridecyl ester; tetrakis(2,2,6,6-tetramethylpiperidin-4-yl)-1,2,3,4-butanetetracarboxylate; 1,2,3,4-butanetetracarboxylic acid, 2,2,6,6-tetramethyl-4-piperidinyl tridecyl ester; tetrakis(1,2,2,6,6-pentamethylpiperidin-4-yl)-1,2,3,4-butanetetracarboxylate; mixture of 2,2,4,4-tetramethyl-21-oxo-7-oxa-3.20-diazaspiro(5.1.11.2)-heneicosane-20-propanoic acid-dodecylester and 2,2,4,4-tetramethyl-21-oxo-7-oxa-3.20-diazaspiro(5.1.11.2)-heneicosane-20-propanoic acid-tetradecylester; 1H,4H,5H,8H-2,3a,4a,6,7a,8a-hexaazacyclopenta[def]fluorene-4,8-dione, hexahydro-2,6-bis(2,2,6,6-tetramethyl-4-piperidinyl)-; polymethyl[propyl-3-oxy(2′,2′,6′,6′-tetramethyl-4,4′-piperidinyl)]siloxane; polymethyl[propyl-3-oxy(1′,2′,2′,6′,6′-pentamethyl-4,4′-piperidinyl)]siloxane; copolymer of methylmethacrylate with ethyl acrylate and 2,2,6,6-tetramethylpiperidin-4-yl acrylate; copolymer of mixed C₂₀ to C₂₄ alpha-olefins and (2,2,6,6-tetramethylpiperidin-4-yl)succinimide; 1,2,3,4-butanetetracarboxylic acid, polymer with β,β,β′,β′-tetramethyl-2,4,8,10-tetraoxaspiro[5.5]undecane-3,9-diethanol, 1,2,2,6,6-pentamethyl-4-piperidinyl ester; 1,2,3,4-butanetetracarboxylic acid, polymer with β,β,β′,β′-tetramethyl-2,4,8,10-tetraoxaspiro[5.5]undecane-3,9-diethanol, 2,2,6,6-tetramethyl-4-piperidinyl ester copolymer; 1,3-benzenedicarboxamide, N,N′-bis(2,2,6,6-tetramethyl-4-piperidinyl; 1,1′-(1,10-dioxo-1,10-decanediyl)-bis(hexahydro-2,2,4,4,6-pentamethylpyrimidine; ethane diamide, N-(1-acetyl-2,2,6,6-tetramethylpiperidinyl)-N′-dodecyl; formamide, N,N′-1,6-hexanediylbis[N-(2,2,6,6-tetramethyl-4-piperidinyl); D-glucitol, 1,3:2,4-bis-O-(2,2,6,6-tetramethyl-4-piperidinylidene)-; 2,2,4,4-tetramethyl-7-oxa-3,20-diaza-21-oxo-dispiro[5.1.11.2]heneicosane; propanamide, 2-methyl-N-(2,2,6,6-tetramethyl-4-piperidinyl)-2-[(2,2,6,6-tetramethyl-4-piperidinyl)amino]-; 7-oxa-3,20-diazadispiro[5.1.11.2]heneicosane-20-propanoic acid, 2,2,4,4-tetramethyl-21-oxo-, dodecyl ester; N-(2,2,6,6-tetramethylpiperidin-4-yl)-p-aminopropionic acid dodecyl ester; N-(2,2,6,6-tetramethylpiperidin-4-yl)-N′-aminooxalamide; propanamide, N-(2,2,6,6-tetramethyl-4-piperidinyl)-3-[(2,2,6,6-tetramethyl-4-piperidinyl)amino]-; mixture of 4-hexadecyloxy- and 4-stearyloxy-2,2,6,6-tetramethylpiperidine; 3-dodecyl-1-(1,2,2,6,6-pentamethylpiperidin-4-yl)pyrrolidine-2,5-dione; 3-dodecyl-1-(1-ethanoyl-2,2,6,6-pentamethylpiperidin-4-yl)pyrrolidine-2,5-dione; bis(2,2,6,6-tetramethylpiperidin-4-yl)succinate; bis(1,2,2,6,6-pentamethylpiperidin-4-yl) n-butyl 3,5-di-tert-butyl-4-hydroxybenzylmalonate; tris(2,2,6,6-tetramethylpiperidin-4-yl) nitrilotriacetate; 1,1′-(1,2-ethanediyl)bis(3,3,5,5-tetramethylpiperazinone); 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; a mixture of 4-hexadecyloxy- and 4-stearyloxy-2,2,6,6-tetramethylpiperidine; 2-undecyl-7,7,9,9-tetramethyl-1-oxa-3,8-diaza-4-oxospiro[4.5]decane; 1,5-dioxaspiro{5,5}undecane-3,3-dicarboxylic acid, bis(2,2,6,6-tetramethyl-4-piperidinyl) and 1,5-dioxaspiro{5,5}undecane-3,3-dicarboxylic acid, bis(1,2,2,6,6-pentamethyl-4-piperidinyl); N¹-(3-hydroxyethyl)3,3-pentamethylene-5,5-dimethylpiperazin-2-one; N¹-tert-octyl-3,3,5,5-tetramethyl-diazepin-2-one; N¹-tert-octyl-3,3-pentamethylene-5,5-hexamethylene-diazepin-2-one; N¹-tert-octyl-3,3-pentamethylene-5,5-dimethylpiperazin-2-one; trans-1,2-cyclohexane-bis-(N¹-5,5-dimethyl-3,3-pentamethylene-2-piperazinone; trans-1,2-cyclohexane-bis-(N¹-3,3,5,5-dispiropentamethylene-2-piperazinone); N¹-isopropyl-1,4-diazadispiro-(3,3,5,5)pentamethylene-2-piperazinone; N¹-isopropyl-1,4-diazadispiro-3,3-pentamethylene-5,5-tetramethylene-2-piperazinone; N¹-isopropyl-5,5-dimethyl-3,3-pentamethylene-2-piperazinone; trans-1,2-cyclohexane-bis-N¹-(dimethyl-3,3-pentamethylene-2-piperazinone); N¹-octyl-5,5-dimethyl-3,3-pentamethylene-1,4-diazepin-2-one; N¹-octyl-1,4-diazadispiro-(3,3,5,5)pentamethylene-1,5-diazepin-2-one; TINUVIN® XT 200 (available from BASF); or TINUVIN© NOR 371 (available from BASF).

The UVA portion of the stabilizer composition as described herein is specifically contemplated to include in various embodiments a combination of one or more ortho-hydroxyphenyl triazines and one or more HALS compounds. The weight ratio of HALS compound(s) to triazine compound(s) in such embodiments can be from 1:5 to 30:1, and preferably from 3:1 to 20:1. In some embodiments, it may be advantageous to replace the ortho-hydroxyphenyl triazines in the UVA portion of the stabilizer composition with an ortho-hydroxybenzophenone compound, an ortho-hydroxyphenyl benzotriazole compound, oxanilide, cyanoacrylate, benzoxazinone compound, and mixtures thereof, in combination with a HALS compound in various suitable ratios to achieve a desired performance property of an organic material to be stabilized.

Similarly, in some embodiments the stabilizer compositions as heretofore described can include any one or more further class of conventional co-stabilizers that include, but are not limited to, hindered benzoates, thioesters, hydroxylamines, antioxidants, hindered phenols, phosphites, phosphonites, benzofuranones, or nitrones. One or more conventional co-additive known to those skilled in the art can also be included, such as, but not limited to, nucleating agents, fillers, metallic stearates, metal oxides, reinforcing agents, plasticizers, lubricants, rheology agents, catalysts, leveling agents, optical brighteners, anti-static agents, blowing agents, flame retardants, dyes, or pigments. Such conventional co-stabilizers and co-additives are well known to those skilled in the art and can include, for example, any of those described in at least U.S. Pat. Nos. 7,642,320, 8,207,070, and 11,267,951.

Suitable hindered benzoates or benzamides for use with the UVA portion of the stabilizer composition include those according to Formula (VII):

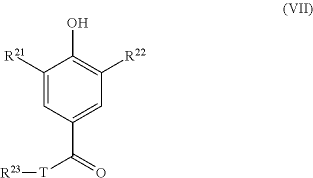

wherein
each of R²¹ and R²² is independently chosen from a C₁₋₁₂ alkyl;
T is chosen from O or NR²⁴, where R²⁴ is H or a C₁₋₃₀ hydrocarbyl; and
R²³ is H or a C₁₋₃₀ hydrocarbyl.

Preferred hindered benzoates can include any one or more of those commercially available from Cytec Industries Inc. such as hexadecyl-3,5-di-tert-butyl-4-hydroxybenzoate (e.g., CYASORB® UV-2908), or 2,4-di-tert-butylphenyl-3,5-di-tert-butyl-4-hydroxybenzoate; octadecyl-3,5-di-tert-butyl-4-hydroxybenzoate; octyl-3,5-di-tert-butyl-4-hydroxybenzoate; decyl-3,5-di-tert-butyl-4-hydroxybenzoate; dodecyl-3,5-di-tert-butyl-4-hydroxybenzoate; tetradecyl-3,5-di-tert-butyl-4-hydroxybenzoate; behenylyl-3,5-di-tert-butyl-4-hydroxybenzoate; 2-methyl-4,6-di-tert-butylphenyl-3,5-di-tert-butyl-4-hydroxybenzoate; or butyl-3-[3-t-butyl-4-(3,5-di-t-butyl-4-hydroxybenzoyloxy)phenyl]propionate.

Suitable thioesters, hydroxylamines, antioxidants, hindered phenols, phosphites, phosphonites, benzofuranones, nitrones, and co-additives include any of those disclosed in U.S. Publication Nos. 2004/0152807; 2009/0085252; 2012/0146257; and 2013/0145962, which are expressly incorporated herein by reference, or known to those skilled in the art.

Preferred hydroxylamines include, but are not limited to, any one or more of N,N-dihydrocarbylhydroxylamine chosen from: N,N-dibenzylhydroxylamine; N,N-diethylhydroxylamine; N,N-dioctylhydroxylamine; N,N-dilaurylhydroxylamine; N,N-didodecylhydroxylamine; N,N-ditetradecylhydroxylaamine; N,N-dihexadecylhydroxylamine; N,N-dioctadecylhydroxylamine; N-hexadecyl-N-tetradecylhydroxylamine; N-hexadecyl-N-heptadecylhydroxylamine; N-hexadecyl-N-octadecylhydroxylamine; N-heptadecyl-N-octadecylhydroxylamine; and N,N-di(hydrogenated tallow)hydroxylamine.

The weight ratio of the combined co-synergist (IV) and co-active agent (when present) to the ultraviolet light absorber (UVA) can vary depending on the components within the UV stabilizer portion, the type of material to be stabilized, and/or the end-use of the stabilized material. In general, the weight ratio of the combined co-synergist (IV) and co-active agent to the ultraviolet light absorber (UVA) can be from 200:1 to 1:50; 100:1 to 1:40; or 50:1 to 1:30. In certain embodiments, the weight ratio of the combined co-synergist (IV) and co-active agent to the ultraviolet light absorber (UVA) can be 50:1 to 1:30. In other embodiments, the weight ratio of the combined co-synergist (IV) and co-active agent to the ultraviolet light absorber (UVA) can be 40:1 to 1:10; or from 20:1 to 1:5.

Similarly, in general, the weight ratio of the co-synergist (IV) to the ultraviolet light absorber (UVA) can be from 200:1 to 1:50; 100:1 to 1:40; or 50:1 to 1:30. In certain embodiments, the weight ratio of the co-synergist (IV) to the ultraviolet light absorber (UVA) can be 50:1 to 1:30. In other embodiments, the weight ratio of the co-synergist (IV) to the ultraviolet light absorber (UVA) can be 40:1 to 1:10; or from 20:1 to 1:5.

The weight ratio of the co-synergist to the UVA+HALS portion of the stabilizer composition can vary depending on the components within the UV stabilizer portion, the type of material to be stabilized, and/or the end-use of the stabilized material. In general, the ratio of the co-synergist to the combined UVA+HALS can be present at a weight ratio from 1:50 to 50:1. In certain embodiments, the weight ratio of the co-synergist to the combined UVA+HALS of the stabilizer composition can be from 1:20 to 50:1. In other embodiments, the ratio of the co-synergist to the combined UVA+HALS portion can be from 1:10 to 40:1; or from 1:5 to 20:1.

Similarly, in general, the ratio of the combined co-synergist (IV) and co-active agent to the combined UVA+HALS can be present at a weight ratio from 1:50 50:1. In certain embodiments, the weight ratio of the combined co-synergist (IV) and co-active agent to the combined UVA+HALS of the stabilizer composition can be from 1:20 to 50:1. In other embodiments, the ratio of the combined co-synergist (IV) and co-active agent to the combined UVA+HALS portion can be from 1:10 to 40:1; or from 1:5 to 20:1.

A stabilized polymer composition comprises an organic material to be stabilized and any stabilizer composition described herein. In some embodiments, the stabilizer composition, optionally added as a masterbatch concentrate, can be present in a stabilized polymer composition or a stabilized article of manufacture in an amount from 0.02 wt. % to 20 wt. % based on the total weight of the stabilized polymer composition or stabilized article of manufacture, or from 0.05 wt. % to 10 wt. %, based on the total weight of the stabilized polymer composition or stabilized article of manufacture. In some embodiments, the final concentration of the co-synergist or of the co-active agent in the stabilized polymer composition or stabilized article of manufacture can be from 0.01 wt. % to 2 wt. %; from 0.01 wt. % to 1 wt. %; or from 0.05 wt. % to 0.50 wt. %, based on the total weight of the stabilized polymer composition or stabilized article of manufacture.

Masterbatch Concentrate. Reference has been made to this point to the stabilizer composition of the invention as a “neat” composition (i.e., not diluted or mixed with other substances) containing a stabilizing amount of a co-synergist; optionally a stabilizing amount of a co-active agent; a stabilizing amount of an ultraviolet light absorber selected from an ortho-hydroxyphenyl triazine, an ortho-hydroxy benzophenone, a benzoxazinone, optionally an ortho-hydroxyphenyl benzotriazole, and combinations thereof; and a stabilizing amount of a hindered amine light stabilizer, which can optionally include other UV stabilizers, co-stabilizers, and/or co-additives. Also disclosed are masterbatch concentrates containing any stabilizer composition described herein and at least one organic material that is identical to or compatible with an organic material to be stabilized. In this context, the organic material identical to or compatible with the organic material to be stabilized acts as a convenient carrier vehicle of the stabilizer compositions described herein, which is then admixed with the organic material to be stabilized. While the amount of stabilizer composition present as a portion of the total masterbatch concentrate will vary based on, for example, the type of material to be stabilized and/or its end-use application, in some embodiments the stabilizer composition will be present in an amount from 10 wt. % to 90 wt. %, based on the total weight of the masterbatch concentrate. In other embodiments, the stabilizer composition can be present at from 30 wt. % to 80 wt. %; or from 40 wt. % to 75 wt. %, based on the total weight of masterbatch concentrate.

Kits. Also disclosed are kits having in one or more containers a stabilizer composition as described herein. The kit can include in a single container or in multiple containers any stabilizer composition disclosed herein, a masterbatch concentrate, the material to be stabilized (e.g., a polymer composition such as a polyolefin), and optionally one or more other co-stabilizers and/or co-additives.

For example, one or more components of a stabilizer composition as herein described (e.g., UVA+HALS+co-synergist; UVA+HALS+co-synergist+co-active agent) can be present in first container, and the kit can optionally include one or more other components of the stabilizer composition and/or a material to be stabilized in a second or further container. The container or containers can be placed within a package, and the package can optionally include administration or mixing instructions in the form of a label or website address on the package, or in the form of an insert included in the packaging of the kit. A kit can also include additional components or other means for administering or mixing the components, as well as solvents or other means for formulation.

Processes. The stabilizer compositions can be readily combined with an organic material to be stabilized, or vice versa, by any suitable method known to those of skill in the art. As used herein the term “combined” or “combining” in reference to the stabilizer composition and the organic material to be stabilized includes all manners and/or techniques known to those skilled in the art for intermixing, admixing, integrating, mixing, or blending two or more substances. In certain embodiments, the components of the stabilizer compositions can be combined with the material to be stabilized by at least one technique chosen from extruding, pelletizing, grinding, and molding. In other embodiments, combining can be performed by at least one of melting, dissolution in a solvent, direct mixing, and dry mixing.

The incorporation of the stabilizer compositions, and of optionally other co-stabilizers and/or co-additives, into the organic materials to be stabilized can be carried out, for example, by dry blending in the form of a powder, or wet mixing in the form of solutions, dispersions, or suspensions, for example in an inert solvent, water, or oil. Such stabilizer compositions are preferably non-aqueous. The incorporation of co-synergist and co-active agent and UV stabilizers for the stabilizer composition, and optional further co-stabilizers and/or co-additives, into the organic material to be stabilized can be carried out, for example, before or after molding, or also by applying the dissolved or dispersed stabilizer mixture to the organic material to be stabilized, with or without subsequent evaporation of the solvent or suspension/dispersion agent. The stabilizer compositions, masterbatch concentrates, and optionally other co-stabilizers and/or co-additives can be added along with the organic material to be stabilized directly into processing apparatus (e.g., extruders, internal mixers, kneaders etc.) as a dry mixture or powder, as a solution, as a dispersion or suspension, or as a melt.

Individual components of the stabilizer compositions, and optionally other co-stabilizers and/or co-additives, can also be combined with organic materials, such as polymers, before, during, or just after, for example, polymerization of the corresponding monomers, or before crosslinking. The stabilizer compositions can be combined into the organic material to be stabilized in pure form (i.e., neat and directly to the resin) and can also be encapsulated in waxes, oils or polymers that are compatible with the organic material to be stabilized.

Individual components of the stabilizer composition and optionally other co-stabilizers and/or co-additives can also be preblended (i.e., mixed together) for simple addition to an organic material to be stabilized. Solutions, dispersions, or suspensions of individual components of the stabilizer composition, and optionally other co-stabilizers and/or co-additives, can be sprayed onto the organic material to be stabilized. Solutions, dispersions, or suspensions of individual components of the stabilizer composition can also be used to dilute co-stabilizers and/or co-additives, or their melts so that they can be sprayed together onto the materials to be stabilized. Mixing by spraying in the presence of water during the deactivation of polymerization catalysts can be particularly advantageous as the steam evolved can be used for deactivation of the catalyst. It can be particularly advantageous to mix individual components of the stabilizer composition and optionally other co-stabilizers and/or co-additives by spraying in the case of spherically polymerized polymers.

Also disclosed are processes for forming stabilized articles of manufacture comprising combining any stabilizer composition disclosed herein, or a masterbatch concentrate thereof, and optionally one or more other co-stabilizers and/or co-additives, with an organic material to be stabilized to form a stabilized polymer composition; and shaping the stabilized polymer composition into a stabilized article of manufacture, thereby forming a stabilized article of manufacture. Consequently, stabilized articles of manufacture made from an organic material to be stabilized, and any stabilizer composition or masterbatch concentrate described herein are also provided.

Also disclosed are processes for protecting an organic material from the deleterious effects of UV irradiation and heat, the processes comprising combining the organic material with any stabilizer composition disclosed herein, or a masterbatch concentrate thereof, and optionally one or more other co-stabilizers and/or co-additives, with an organic material to be stabilized. These processes comprise adding before, during, or after processing a stabilizing amount of any stabilizer composition described herein to the organic material to be stabilized. The stabilizer composition can be added to the organic material to be stabilized as a neat composition or as a masterbatch concentrate as described herein.

Also described are processes for forming a stabilized article of manufacture, by adding before, during, or after processing a stabilizing amount of any stabilizer composition described herein, or a masterbatch concentrate thereof, to the organic material to be stabilized; and shaping the stabilized polymer composition into a stabilized article of manufacture.

The stabilizer compositions, masterbatch concentrates, stabilized polymer compositions, and processes are suitable for use with, and readily adapted to, any industrial polymeric molding process including, but not limited to, injection molding, rotomolding, blow molding, reel-to-reel molding, metal injection molding, compression molding, transfer molding, dip molding, gas assist molding, insert injection molding, micro molding, reaction injection molding, two shot injection molding, as well as any variations or combinations thereof.

In certain embodiments, the stabilizer composition can be present in the stabilized polymer composition, or stabilized article of manufacture, in ranges from 0.01 wt. % to 15.0 wt. % (i.e., any value from 0.01 wt. % to 15.0 wt. %, including any value therebetween such as 0.01 wt. %; 0.02 wt. %; 0.03 wt. %; 0.04 wt. %; 0.05 wt. %; 0.075 wt. %; 0.10 wt. %; 0.15 wt. %; 0.20 wt. %; 0.25 wt. %; 0.30 wt. %; 0.35 wt. %; 0.50 wt. %; 0.75 wt. %; 1.0 wt. %; 1.5 wt. %; 2.0 wt. %; 2.5 wt. %; 3.0 wt. %; 3.5 wt. %; 5.0 wt. %; 7.5 wt. %; 10.0 wt. %; 12.0 wt. %; 14.0 wt. %; or 15.0 wt. %) based on the total weight of the stabilized polymer composition. The amount depends on the stabilizer composition or masterbatch concentrate being added, the properties of the material to be stabilized, and the end-use application.

A stabilized article of manufacture comprising an organic material to be stabilized comprises:
a) from 0.01 wt. % to 15 wt. %, based on the total weight of the stabilized article of manufacture, of a stabilizer composition comprising:
i) a stabilizing amount of an ultraviolet light absorber (UVA) selected from the group consisting of: orthohydroxyphenyl triazine compounds;
orthohydroxybenzophenone compounds; oxanilides; cyanoacrylates; benzoxazinone compounds; and mixtures thereof,
ii) a stabilizing amount of a hindered amine light stabilizer compound (HALS) comprising a functional group according to Formula (II):

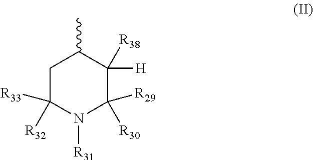

wherein R₃₁ is chosen from: hydrogen; OH; C₁-C₂₀ hydrocarbyl; —CH₂CN; C₁-C₁₂ acyl; or C₁-C₁₈ alkoxy; R₃₈ is chosen from: hydrogen; or C₁-C₈ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or
a functional group according to Formula (IIa):

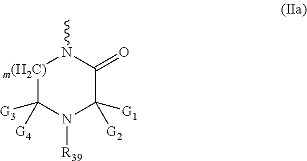

wherein
m is an integer from 1 to 2;
R₃₉ is chosen from: hydrogen; OH; C₁-C₂₀ hydrocarbyl; —CH₂CN; C₁-C₁₂ acyl; or C₁-C₁₈ alkoxy; and
each of G₁-G₄ is independently chosen from C₁-C₂₀ hydrocarbyl; or
mixtures of HALS compounds having functional groups according to Formula (II) and Formula (IIa);
iii) a stabilizing amount of a co-synergist selected from the group consisting of bisamides of fatty acids of the general formula (IV):

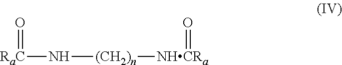

wherein Rₐ is a C₇ to C₂₅ alkyl group with 0 to 6 unsaturated double bonds and n is 2 to 10; and,
iv) a stabilizing amount of a co-active agent selected from the group consisting of alkoxylated C₁₂-C₆₀ alcohols or monoalkyl ethers thereof; alkoxylated esters of fatty acids; sorbitan esters or ethoxylates thereof; mono- or polyglycerol esters having from 1 to 20 glycerol units or alkoxylates thereof; alkoxylated fatty amines, esters thereof, or salts thereof; sugar esters; alkoxylated fatty amides; ethylene oxide/propylene oxide copolymers; and mixtures thereof;
wherein the total weight of co-synergist (IV) and co-active agent is from 1 wt. % to 99 wt. %, based on the total weight of the stabilizer composition; and
the ratio of co-synergist (IV) to co-active agent is 1:99 to 99:1; or
b) a masterbatch concentrate as disclosed herein;
such that the final concentration of the combined co-synergist (IV) and co-active agent in the stabilized article of manufacture is from 0.01 wt. % to 5 wt. %, based on the weight of the stabilized article of manufacture.

A stabilized article of manufacture can also comprise an organic material to be stabilized; and
a) from 0.01 wt. % to 15 wt. %, based on the total weight of the stabilized article of manufacture, of a stabilizer composition comprising:
i) a stabilizing amount of an ultraviolet light absorber (UVA) selected from the group consisting of: orthohydroxyphenyl triazine compounds;
orthohydroxybenzophenone compounds; orthohydroxyphenyl benzotriazole compounds; oxanilides; cyanoacrylates; benzoxazinone compounds; and mixtures thereof,
ii) a stabilizing amount of a hindered amine light stabilizer compound (HALS) comprising a functional group according to Formula (II):

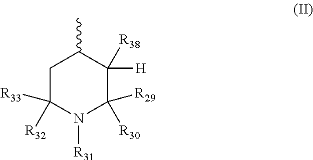

wherein R₃₁ is chosen from: hydrogen; OH; C₁-C₂₀ hydrocarbyl; —CH₂CN; C₁-C₁₂ acyl; or C₁-C₁₈ alkoxy; R₃₈ is chosen from: hydrogen; or C₁-C₈ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or a functional group according to Formula (IIa):

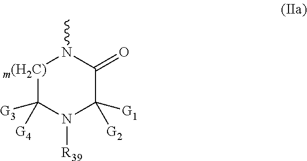

wherein
m is an integer from 1 to 2;
R₃₉ is chosen from: hydrogen; OH; C₁-C₂₀ hydrocarbyl; —CH₂CN; C₁-C₁₂ acyl; or C₁-C₁₈ alkoxy; and
each of G₁-G₄ is independently chosen from C₁-C₂₀ hydrocarbyl; or
mixtures of HALS compounds having functional groups according to Formula (II) and Formula (IIa);
iii) a stabilizing amount of a co-synergist selected from the group consisting of bisamides of fatty acids of the general formula (IV):

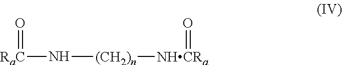

wherein Rₐ is a C₇ to C₂₅ alkyl group with 0 to 6 unsaturated double bonds and n is 2 to 10; and,
wherein a co-active agent selected from the group consisting of alkoxylated C₁₂-C₆₀ alcohols or monoalkyl ethers thereof; alkoxylated esters of fatty acids; sorbitan esters or ethoxylates thereof, mono- or polyglycerol esters having from 1 to 20 glycerol units or alkoxylates thereof; alkoxylated fatty amines, esters thereof, or salts thereof, sugar esters; alkoxylated fatty amides; ethylene oxide/propylene oxide copolymers; and mixtures thereof, is absent from the stabilizer composition (0 wt. %); and
wherein the co-synergist (IV) is present at from 1 wt. % to 99 wt. %, based on the total weight of the stabilizer composition
or
b) a masterbatch concentrate as described herein;
such that the final concentration of the combined co-synergist (IV) and co-active agent in the stabilized article of manufacture is from 0.01 wt. % to 5 wt. %, based on the weight of the stabilized article of manufacture.

In certain embodiments, stabilized polymer compositions or stabilized articles of manufacture comprising the stabilizer compositions as herein described can be further characterized and distinguished in that the contact angle of water droplets at the surface of the stabilized material can be from 10° to 100°; preferably greater than 20°; more preferably greater than 50°; still more preferably greater than 75°.

Organic materials to be stabilized. Various nonliving organic materials suitable for stabilizing include, but are not limited to, polyolefins, poly(ethylene-vinyl acetate) (EVA); polyesters, polyethers, polyketones, polyamides, natural and synthetic rubbers, polyurethanes, polystyrenes, high-impact polystyrenes, polyacrylates, polymethacrylates, polyacetals, polyacrylonitriles, polybutadienes, polystyrenes, acrylonitrile-butadiene-styrene, styrene acrylonitrile, acrylate styrene acrylonitrile, cellulosic acetate butyrate, cellulosic polymers, polyimides, polyamideimides, polyetherimides, polyphenylsulfides, polyphenyloxidepolysulfones, polyethersulfones, polyvinylchlorides, polycarbonates, polyketones, aliphatic polyketones, thermoplastic olefins (TPO), polyolefin elastomers (POE), amino resin cross-linked polyacrylates and polyesters, polyisocyanate cross-linked polyesters and polyacrylates, phenol/formaldehyde, urea/formaldehyde and melamine/formaldehyde resins, drying and non-drying alkyd resins, alkyd resins, polyester resins, acrylate resins cross-linked with melamine resins, urea resins, isocyanates, isocyanurates, carbamates, epoxy resins, cross-linked epoxy resins derived from aliphatic, cycloaliphatic, heterocyclic and aromatic glycidyl compounds, which are cross-linked with anhydrides or amines, polysiloxanes, Michael addition polymers, amines, blocked amines with activated unsaturated and methylene compounds, ketimines with activated unsaturated and methylene compounds, polyketimines in combination with unsaturated acrylic polyacetoacetate resins, polyketimines in combination with unsaturated acrylic resins, coating compositions, radiation curable compositions, epoxy melamine resins, organic dyes, cosmetic products, cellulose-based paper formulations, photographic film paper, fibers, waxes, and inks.

In certain embodiments, the organic material to be stabilized comprises a polyolefin. Polyolefins suitable for use with the stabilizer compositions defined herein include, but are not limited to:
(A) Polymers of monoolefins, for example polypropylene, polyisobutylene, polybut-1-ene, and poly-4-methylpent-1-ene, polymers of diolefins such as polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE);
(B) Polyolefins, i.e. the polymers of monoolefins exemplified in (A), preferably polyethylene and polypropylene, can be prepared by different, and especially by the following, methods: i) radical polymerisation (normally under high pressure and at elevated temperature); or ii) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either p- or s-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler(-Natta), TNZ (DuPont), metallocene or single site catalysts (SSC);
(C) Mixtures of the polymers mentioned under (A), for example mixtures of polypropylene with polyisobutylene, polypropylene with polyethylene (for example PP/HDPE, PP/LDPE) and mixtures of different types of polyethylene (for example LDPE/HDPE); and
(D) Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in (A) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

Particularly preferred organic materials for stabilizing and providing stabilized articles of manufacture include polyolefin polymers such as i) polymers of monoolefins chosen from polyethylene, polypropylene, polyisobutylene, polybut-1-ene, or poly-4-methylpent-1-ene; ii) polymers of diolefins chosen from polyisoprene or polybutadiene; iii) polymers of cycloolefins chosen from cyclopentene or norbornene; iv) polyethylene chosen from optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); v) thermoplastic olefins (TPO); vi) polyolefin elastomers (POE); vii) copolymers thereof, and viii) mixtures thereof.

In some embodiments, the stabilizer composition and the polymer composition containing the instant stabilizer composition does not contain a functionalized olefin polymers or co-polymers or carboxylic reagent functionalized olefin polymer or co-polymer functionalized with carboxylic acids or functional equivalents thereof. The functionalized olefin polymers and co-polymers can be reaction products of an olefin polymer or copolymer with an α,β-unsaturated carboxylic acid reagent, wherein the carboxylic acid reagent is a carboxylic acid, ester, or anhydride.

In some embodiments, the organic material can be polyethylene or polypropylene and can be combined with a stabilizer composition to provide: from 0.01 wt. % to 5 wt. %, based on the weight of the organic material, of co-active agent in the form of ethylene bis stearamide; from 0.001 wt. % to 5 wt. %, based on the weight of the stabilized material, of ortho-hydroxyphenyl triazine in the form of 4,6-bis-(2,4-dimethylphenyl)-2-(2-hydroxy-4-octyloxyphenyl)-s-triazine; from 0.01 wt. % to 5 wt. %, based on the weight of the stabilized material, of hindered amine light stabilizer in the form of a condensate of N,N′-bis(2,2,6,6-tetramethyl-4-piperidinyl)-1,6-hexanediamine polymers with morpholine-2,4-dichloro-1,3,5-triazine reaction products, methylated, or non-methylated; optionally from 0.01 wt. % to 5 wt. %, based on the weight of the stabilized material, of a co-active agent in the form of diethylene glycol octadecyl ether; and optionally from 0.01 wt. % to 5 wt. %, based on the weight of the stabilized material, of a hindered benzoate in the form of 3,5-di-[t-butyl]-4-hydroxybenzoic acid hexadecyl ester. In some embodiments, the final amounts of co-synergist, ortho-hydroxyphenyl triazine, hindered amine light stabilizer, and optionally co-active agent, and optionally hindered benzoate is from 0.01 wt. % to 1.0 wt. %.

### EMBODIMENTS

As described herein, the present invention includes at least the following embodiments:

Embodiment 1. A stabilizer composition comprising:
i) a stabilizing amount of an ultraviolet light absorber (UVA) selected from the group consisting of orthohydroxyphenyl triazine compounds, orthohydroxybenzophenone compounds, oxanilides, cyanoacrylates, benzoxazinone compounds, and mixtures thereof,
ii) a stabilizing amount of a hindered amine light stabilizer compound (HALS) comprising a functional group according to Formula (II):

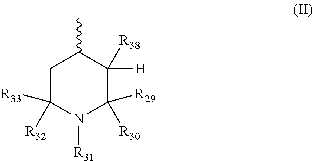

wherein R₃₁ is chosen from: hydrogen; OH; C₁-C₂₀ hydrocarbyl; —CH₂CN; C₁-C₁₂ acyl; or C₁-C₁₈ alkoxy; R₃₈ is chosen from: hydrogen; or C₁-C₈ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or
a functional group according to Formula (IIa):

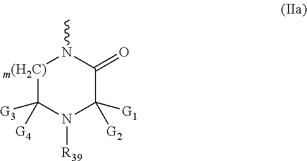

wherein
m is an integer from 1 to 2;
R₃₉ is chosen from: hydrogen; OH; C₁-C₂₀ hydrocarbyl; —CH₂CN; C₁-C₁₂ acyl; or C₁-C₁₈ alkoxy; and
each of G₁-G₄ is independently chosen from C₁-C₂₀ hydrocarbyl; or
mixtures of HALS compounds having functional groups according to Formula (II) and Formula (IIa);
iii) a stabilizing amount of a co-synergist selected from the group consisting of bisamides of fatty acids of the general formula (IV):

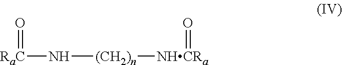

wherein Rₐ is a C₇ to C₂₅ alkyl group with 0 to 6 unsaturated double bonds and n is 2 to 10; and
iv) a stabilizing amount of a co-active agent selected from the group consisting of alkoxylated C₁₂-C₆₀ alcohols or monoalkyl ethers thereof; alkoxylated esters of fatty acids; sorbitan esters or ethoxylates thereof; mono- or polyglycerol esters having from 1 to 20 glycerol units or alkoxylates thereof; alkoxylated fatty amines, esters thereof, or salts thereof; sugar esters; alkoxylated fatty amides; ethylene oxide/propylene oxide copolymers; and mixtures thereof;
wherein the total weight of co-synergist (IV) and co-active agent is from 1 wt. % to 99 wt. %, based on the total weight of the stabilizer composition; and the weight ratio of co-synergist to co-active agent is 1:99 to 99:1.

Embodiment 2. A stabilizer composition comprising:
i) a stabilizing amount of an ultraviolet light absorber (UVA) selected from the group consisting of orthohydroxyphenyl triazine compounds; orthohydroxybenzophenone compounds; orthohydroxyphenyl benzotriazole compounds; oxanilides; cyanoacrylates; benzoxazinone compounds; and mixtures thereof,
ii) a stabilizing amount of a hindered amine light stabilizer compound (HALS) comprising a functional group according to Formula (II):

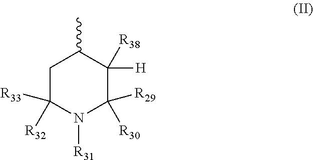

wherein R₃₁ is chosen from: hydrogen; OH; C₁-C₂₀ hydrocarbyl; —CH₂CN; C₁-C₁₂ acyl; or C₁-C₁₈ alkoxy; R₃₈ is chosen from: hydrogen; or C₁-C₈ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or a functional group according to Formula (IIa):

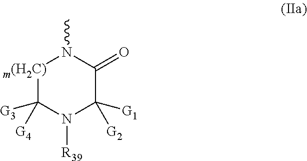

wherein
m is an integer from 1 to 2;
R₃₉ is chosen from: hydrogen; OH; C₁-C₂₀ hydrocarbyl; —CH₂CN; C₁-C₁₂ acyl; or C₁-C₁₈ alkoxy; and
each of G₁-G₄ is independently chosen from C₁-C₂₀ hydrocarbyl; or
mixtures of HALS compounds having functional groups according to Formula (II) and Formula (IIa);
iii) a stabilizing amount of a co-synergist selected from the group consisting of bisamides of fatty acids of the general formula (IV):

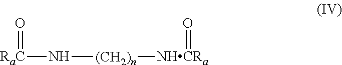

wherein Rₐ is a C₇ to C₂₅ alkyl group with 0 to 6 unsaturated double bonds and n is 2 to 10; and
wherein the co-synergist (IV) is present at from 1 wt. % to 99 wt. %, based on the total weight of the stabilizer composition; and
wherein a co-active agent selected from the group consisting of alkoxylated C₁₂-C₆₀ alcohols or monoalkyl ethers thereof; alkoxylated esters of fatty acids; sorbitan esters or ethoxylates thereof, mono- or polyglycerol esters having from 1 to 20 glycerol units or alkoxylates thereof; alkoxylated fatty amines, esters thereof, or salts thereof, sugar esters; alkoxylated fatty amides; ethylene oxide/propylene oxide copolymers; and mixtures thereof, is absent from the stabilizer composition (0 wt. %).

Embodiment 3. A stabilizer composition according to embodiment 1, wherein the combined co-synergist and co-active agent, and the combined UV absorber and HALS (co-synergist+co-active agent):(UVA+HALS) are present in a weight ratio from 1:50 to 50:1.

Embodiment 4. A stabilizer composition according to any one of claims 1 to 3, wherein the ortho-hydroxyphenyl triazine compound is a 2-(2′-hydroxyphenyl)-1,3,5-triazine compound according to Formula (I):

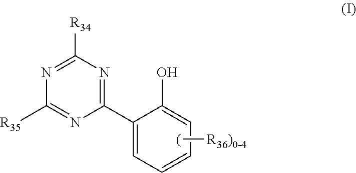

wherein
R₃₄ and R₃₅ are the same or different and are independently chosen from
   a C₆-C₁₀ aryl group, wherein the C₆-C₁₀ aryl group is optionally substituted at from 1 to 3 substitutable positions with one or more group chosen from OH, halogen, C₁-C₁₂ alkyl, C₁-C₁₂ alkoxy, C₁₋₁₂ alkoxyester, C₂₋₁₂ alkanoyl, or phenyl, wherein the phenyl is optionally substituted at from 1 to 3 substitutable positions with one or more group chosen from: hydroxyl, halogen, C₁₋₁₂ alkyl, C₁₋₁₂ alkoxy, C₁₋₁₂ alkoxyester, or C₂₋₁₂ alkanoyl;
   mono- or di-C₁-C₁₂ hydrocarbyl-substituted amino;
   C₂-C₁₂ alkanoyl;
   C₁-C₁₂ alkyl;
   C₁-C₁₀ acyl; or
   C₁-C₁₀ alkoxyl; and
R₃₆ is a substituent that is the same or different at from 0 to 4 positions of the phenoxy portion of Formula (I) and is independently chosen from hydroxyl, halogen, C₁-C₁₂ alkyl, C₁-C₁₂ alkoxy, C₁-C₁₂ alkoxyester, C₂-C₁₂ alkanoyl; phenyl; or C₁-C₁₂ acyl.

Embodiment 5. A stabilizer composition according to embodiment 4, wherein the 2-(2′-hydroxyphenyl)-1,3,5-triazine compound is selected from the group consisting of:
4,6-bis-(2,4-dimethylphenyl)-2-(2-hydroxy-4-octyloxyphenyl)-s-triazine;
2-(4,6-Diphenyl-1,3,5-triazin-2-yl-)-5-((hexyl)oxyl-phenol;
4,6-bis-(2,4-dimethylphenyl)-2-(2,4-dihydroxyphenyl)-s-triazine;
2,4-bis(2,4-dihydroxyphenyl)-6-(4-chlorophenyl)-s-triazine;
2,4-bis[2-hydroxy-4-(2-hydroxy-ethoxy)phenyl]-6-(4-chlorophenyl)-s-triazine;
2,4-bis[2-hydroxy-4-(2-hydroxy-4-(2-hydroxy-ethoxy)phenyl]-6-(2,4-dimethylphenyl)-s-triazine;
2,4-bis[2-hydroxy-4-(2-hydroxyethoxy)phenyl]-6-(4-bromophenyl)-s-triazine;
2,4-bis[2-hydroxy-4-(2-acetoxyethoxy)phenyl]-6-(4-chlorophenyl)-s-triazine;
2,4-bis(2,4-dihydroxyphenyl)-6-(2,4-dimethylphenyl)-s-triazine;
2,4-bis(4-biphenylyl)-6-[2-hydroxy-4-[(octyloxycarbonyl)ethylideneoxy]phenyl]-s-triazine;
2,4-bis(4-biphenylyl)-6-[2-hydroxy-4-(2-ethylhexyloxy)phenyl]-s-triazine;
2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine;
2,4-bis(2,4-dimethylphenyl)-6-[2-hydroxy-4(-3-benzyloxy-2-hydroxypropyloxy)phenyl]-s-triazine;
2,4-bis(2-hydroxy-4-n-butyloxyphenyl)-6-(2,4-di-n-butyloxyphenyl)-s-triazine;
2,4-bis(2,4-dimethylphenyl)-6-[2-hydroxy-4-(3-nonyloxy-2-hydroxypropyloxy)-5-α-cumylphenyl]-s-triazine;
methylenebis-{2,4-bis(2,4-dimethylphenyl)-6-[2-hydroxy-4-(3-butyloxy-2-hydroxypropoxy)phenyl]-s-triazine};
methylene bridged dimer mixture bridged in the 3:5′, 5:5′ and 3:3′ positions in a 5:4:1 ratio;
2,4,6-tris(2-hydroxy-4-isooctyloxycarbonyliso-propylideneoxy-phenyl)-s-triazine;
2,4,6,-tris(2-hydroxy-4-octyloxy-phenyl)-1,3,5-triazine;
2,4-bis(2,4-dimethylphenyl)-6-(2-hydroxy-4-hexyloxy-5-α-cumylphenyl)-s-triazine;
2-(2,4,6-trimethylphenyl)-4,6-bis[2-hydroxy-4-(3-butyloxy-2-hydroxypropyloxy)phenyl]-s-triazine;
2,4,6-tris[2-hydroxy-4-(3-sec-butyloxy-2-hydroxypropyloxy)-phenyl]-s-triazine; mixture of 4,6-bis-(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine;
4,6-bis-(2,4-dimethylphenyl)-2-(2-hydroxy-4(3-(2-ethylhexyloxy)-2-hydroxypropoxy)-phenyl)-s-triazine;
4,6-diphenyl-2-(4-hexyloxy-2-hydroxyphenyl)-s-triazine; and mixtures thereof.

Embodiment 6. A stabilizer composition according to any one of embodiments 1 to 3, wherein the orthohydroxybenzophenone compound is selected from the group consisting of 2-hydroxy-4-methoxybenzophenone; 2,2′-dihydroxy-4-methoxybenzophenone; 2-hydroxy-4-octyloxybenzophenone; 2,2′-dihydroxy-4,4′-di-methoxybenzophenone; 2,2′-dihydroxybenzophenone; 2,2′,4,4′-tetrahydroxybenzophenone; 2,2′-dihydroxy-4,4′-dimethoxybenzophenone; 2,2′-dihydroxy-4,4′-diethoxybenzophenone; 2,2′-dihydroxy-4,4′-dipropoxybenzophenone; 2,2′-dihydroxy-4,4′-dibutoxybenzophenone; 2,2′-dihydroxy-4-methoxy-4′-ethoxybenzophenone; 2,2′-dihydroxy-4-methoxy-4′-propoxybenzophenone; 2,2′-dihydroxy-4-methoxy-4′-butoxybenzophenone; 2,2′-dihydroxy-4-ethoxy-4′-propoxybenzophenone; 2,2′-dihydroxy-4-ethoxy-4′-butoxybenzophenone; 2,3′-dihydroxy-4,4′-dimethoxybenzophenone; 2,3′-dihydroxy-4-methoxy-4′-butoxybenzophenone; 2-hydroxy-4,4′,5′-trimethoxybenzophenone; 2-hydroxy-4,4′,6′-tributoxybenzophenone; 2-hydroxy-4-butoxy-4′,5′-dimethoxybenzophenone; 2-hydroxy-4-ethoxy-2′,4′-dibutylbenzophenone; 2-hydroxy-4-propoxy-4′,6′-dichlorobenzophenone; 2-hydroxy-4-propoxy-4′,6′-dibromobenzophenone; 2,4-dihydroxybenzophenone; 2-hydroxy-4-ethoxybenzophenone; 2-hydroxy-4-propoxybenzophenone; 2-hydroxy-4-butoxybenzophenone; 2-hydroxy-4-methoxy-4′-methylbenzophenone; 2-hydroxy-4-methoxy-4′-ethylbenzophenone; 2-hydroxy-4-methoxy-4′-propylbenzophenone; 2-hydroxy-4-methoxy-4′-butylbenzophenone; 2-hydroxy-4-methoxy-4′-tertiary-butylbenzophenone; 2-hydroxy-4-methoxy-4′-chlorobenzophenone; 2-hydroxy-4-methoxy-2′-chlorobenzophenone; 2-hydroxy-4-methoxy-4′-bromobenzophenone; 2-hydroxy-4,4′-dimethoxybenzophenone; 2-hydroxy-4,4′-dimethoxy-3-methylbenzophenone; 2-hydroxy-4,4′-dimethoxy-2′-ethylbenzophenone; 2-hydroxy-4,4′,5′-trimethoxybenzophenone; 2-hydroxy-4-ethoxy-4′-methylbenzophenone; 2-hydroxy-4-ethoxy-4′-ethylbenzophenone; 2-hydroxy-4-ethoxy-4′-propylbenzophenone; 2-hydroxy-4-ethoxy-4′-butylbenzophenone; 2-hydroxy-4-ethoxy-4′-methoxybenzophenone; 2-hydroxy-4,4′-diethoxybenzophenone; 2-hydroxy-4-ethoxy-4′-propoxybenzophenone; 2-hydroxy-4-ethoxy-4′-butoxybenzophenone; 2-hydroxy-4-ethoxy-4′-chlorobenzophenone; 2-hydroxy-4-ethoxy-4′-bromobenzophenone; and mixtures thereof.

Embodiment 7. A stabilizer composition according any one of embodiments 1 to 3, wherein the benzoxazinone compound is selected from the group consisting of 2-methyl-3,1-benzoxazin-4-one; 2-butyl-3,1-benzoxazin-4-one; 2-phenyl-3,1-benzoxazin-4-one; 2-(1- or 2-naphthyl)-3,1-benzoxazin-4-one; 2-(4-biphenyl)-3,1-benzoxazin-4-one; 2-p-nitrophenyl-3,1-benzoxazin-4-one; 2-m-nitrophenyl-3,1-benzoxazin-4-one; 2-p-benzoylphenyl-3,1-benzoxazin-4-one; 2-p-methoxyphenyl-3,1-benzoxazin-4-one; 2-O-methoxyphenyl-3,1-benzoxazin-4-one; 2-cyclohexyl-3,1-benzoxazin-4-one; 2-p-(or m-)phthalimidephenyl-3,1-benzoxazin-4-one; N-phenyl-4-(3,1-benzoxazin-4-one-2-yl)phthalimide; N-benzoyl-4-(3,1-benzoxazine-4-one-2-yl)aniline; N-benzoyl-N-methyl-4-(3,1-benzoxazin-4-one-2-yl)-aniline; 2-[p-(N-phenylcarbamonyl)phenyl]-3,1-benzoxazin-4-one; 2-[p-(N-phenyl N-methylcarbamoyl)phenyl]-3,1-benzoxazin-4-one; 2,2′-bis(3,1-benzoxazin-4-one); 2,2′-ethylenebis(3,1-benzoxazin-4-one); 2,2′-tetramethylenebis(3,1-benzoxazin-4-one); 2,2′-hexamethylenebis(3,1-benzoxazin-4-one); 2,2′-decamethylenebis(3,1-benzoxazin-4-one); 2,2′-p-phenylenebis(3,1-benzoxazin-4-one); 2,2′-m-phenylenebis(3,1-benzoxazin-4-one); 2,2′-(4,4′-diphenylene)bis(3,1-benzoxazin-4-one); 2,2′-(2,6- or 1,5-naphthalene)bis(3,1-benzoxazin-4-one); 2,2′-(2-methyl-p-phenylene)bis(3,1-benzoxazin-4-one); 2,2′-(2-nitro-p-phenylene)bis(3,1-benzoxazin-4-one); 2,2′-(2-chloro-p-phenylene)bis(3,1-benzoxazin-4-one); 2,2′-(1,4-cyclohexylene)bis(3,1-benzoxazin-4-one); N-p-(3,1-benzoxazin-4-on-2-yl)phenyl; 4-(3,1-benzoxazin-4-on-2-yl)phthalimide; N-p-(3,1-benzoxazin-4-on-2-yl)benzoyl; 4-(3,1-benzoxazin-4-on-2-yl)aniline; 1,3,5-tri(3,1-benzoxazin-4-on-2-yl)benzene; 1,3,5-tri(3,1-benzoxazin-4-on-2-yl)naphthalene; 2,4,6-tri(3,1-benzoxazin-4-on-2-yl)naphthalene; and mixtures thereof.

Embodiment 8. A stabilizer composition according to any one of embodiments 1 to 7, wherein the ratio of combined co-synergist (IV) and co-active agent to total amount of ultraviolet light absorber (UVA) is from 200:1 to 1:50.

Embodiment 9. A stabilizer composition according to embodiment 8, wherein the ratio of combined co-synergist (IV) and co-active agent to total amount of ultraviolet light absorber (UVA) is 50:1 to 1:30.

Embodiment 10. A stabilizer composition according to any one of embodiments 1 to 9, wherein the hindered amine light stabilizer compound is selected from the group consisting of bis(2,2,6,6-tetramethylpiperidin-4-yl) sebacate; bis(2,2,6,6-tetramethylpiperidin-4-yl)succinate; bis(1,2,2,6,6-pentamethylpiperidin-4-yl)sebacate; bis(1-octyloxy-2,2,6,6-tetramethylpiperidin-4-yl)sebacate; bis(1,2,2,6,6-pentamethylpiperidin-4-yl) n-butyl 3,5-di-tert-butyl-4-hydroxybenzylmalonate; a condensate of 1-(2-hydroxyethyl)-2,2,6,6-tetramethyl-4-hydroxypiperidine and succinic acid; 2,2,6,6-tetramethylpiperidin-4-yl stearate; 2,2,6,6-tetramethylpiperidin-4-yl dodecanate; 1,2,2,6,6-pentamethylpiperidin-4-yl stearate; 1,2,2,6,6-pentamethylpiperidin-4-yl dodecanate; a condensate of N,N′-bis(2,2,6,6-tetramethylpiperidin-4-yl)hexamethylenediamine and 4-tert-octylamino-2,6-dichloro-1,3,5-triazine; tris(2,2,6,6-tetramethylpiperidin-4-yl) nitrilotriacetate; tetrakis(2,2,6,6-tetramethylpiperidin-4-yl)-1,2,3,4-butanetetracarboxylate; 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; a condensate of N,N′-bis(2,2,6,6-tetramethylpiperidin-4-yl)hexamethylenediamine and 4-morpholino-2,6-dichloro-1,3,5-triazine; a condensate of N,N′-bis(2,2,6,6-tetramethylpiperidin-4-yl)hexamethylenediamine and 4-morpholino-2,6-dichloro-1,3,5-triazine, methylated; a condensate of 2-chloro-4,6-bis(4-n-butylamino-2,2,6,6-tetramethylpiperidyl)-1,3,5-triazine and 1,2-bis(3-aminopropylamino)ethane; a condensate of 2-chloro-4,6-bis(4-n-butylamino-1,2,2,6,6-pentamethylpiperidyl)-1,3,5-triazine and 1,2-bis-(3-aminopropylamino)ethane; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; a mixture of 4-hexadecyloxy- and 4-stearyloxy-2,2,6,6-tetramethylpiperidine; a mixture of 4-hexadecyloxy- and 4-stearyloxy-1,2,2,6,6-pentamethylpiperidine; a condensate of N,N′-bis(2,2,6,6-tetramethylpiperidin-4-yl)hexamethylenediamine and 4-cyclohexylamino-2,6-dichloro-1,3,5-triazine; a condensate of 1,2-bis(3-aminopropylamino)ethane, 2,4,6-trichloro-1,3,5-triazine and 4-butylamino-2,2,6,6-tetramethylpiperidine; 2-undecyl-7,7,9,9-tetramethyl-1-oxa-3,8-diaza-4-oxospiro[4.5]decane; oxo-piperanzinyl-triazines; a reaction product of 7,7,9,9-tetramethyl-2-cycloundecyl-1-oxa-3,8-diaza-4-oxospiro[4.5]decane and epichlorohydrin; tetrakis(2,2,6,6-tetramethyl-4-piperidyl) butane-1,2,3,4-tetracarboxylate; 1,2,3,4-butanetetracarboxylic acid, tetrakis(1,2,2,6,6-pentamethyl-4-piperidinyl)ester; 1,2,3,4-butanetetracarboxylic acid, 1,2,2,6,6-pentamethyl-4-piperdinyl tridecyl ester; 1,2,3,4-butanetetracarboxylic acid, 2,2,6,6-tetramethyl-4-piperidinyl tridecyl ester; 1,2,3,4-butanetetracarboxylic acid, polymer with 2,2,6,6-tetramethyl-2,4,8,10-tetraoxaspiro[5.5]-undecane-3,9-diethanol,1,2,2,6,6-pentamethyl-4-piperdinyl ester; 1,2,3,4-butanetetracarboxylic acid, polymer with 2,2,6,6-tetramethyl-2,4,8,10-tetraoxaspiro[5.5]-undecane-3,9-diethanol, 2,2,6,6-tetramethyl-4-piperdinyl ester; bis(1-undecanoxy-2,2,6,6-tetramethylpiperidin-4-yl)carbonate; 1-(2-hydroxy-2-methylpropoxy)-2,2,6,6-tetramethyl-4-piperdinol; 1-(2-hydroxy-2-methylpropoxy)-4-octadecanoyloxy-2,2,6,6-tetramethylpiperidine; 1-(4-octadecanoyloxy-2,2,6,6-tetramethylpiperidin-1-yloxy)-2-octadecanoyloxy-2-methylpropane; 1-(2-hydroxyethyl)-2,2,6,6-tetramethyl-4-piperdinol; a reaction product of 1-(2-hydroxyethyl)-2,2,6,6-tetramethyl-4-piperdinol and dimethylsuccinate; 2,2,4,4-tetramethyl-7-oxa-3,20-diazadispiro[5.1.11.2]heneicosan-21-one; the ester of 2,2,6,6-tetramethyl-4-piperidinol with higher fatty acids; 3-dodecyl-1-(2,2,6,6-tetramethyl-4-piperidyl)pyrrolidine-2,5-dione; 1H-Pyrrole-2,5-dione, 1-octadecyl-, polymer with (1-methylethenyl)benzene and 1-(2,2,6,6-tetramethyl-4-piperidinyl)-1H-pyrrole-2,5-dione; piperazinone, 1,1′,1″-[1,3,5-triazine-2,4,6-triyltris[(cyclohexylimino)-2,1-ethanediyl]]tris[3,3,5,5-tetramethyl-; piperazinone, 1,1′,1″-[1,3,5-triazine-2,4,6-triyltris[(cyclohexylimino)-2,1-ethanediyl]]tris[3,3,4,5,5-pentamethyl-; the reaction product of 7,7,9,9-tetramethyl-2-cycloundecyl-1-oxa-3,8-diaza-4-oxospiro[4.5]decane and epichlorohydrin; the condensate of N,N′-bis(2,2,6,6-tetramethylpiperidin-4-yl)hexamethylenediamine and 4-cyclohexylamino-2,6-dichloro-1,3,5-triazine; the condensate of 1,2-bis(3-aminopropylamino)ethane, 2,4,6-trichloro-1,3,5-triazine and 4-butylamino-2,2,6,6-tetramethylpiperidine; the condensate of N,N′-bis(2,2,6,6-tetramethylpiperidin-4-yl)hexamethylenediamine and 4-morpholino-2,6-dichloro-1,3,5-triazine; the condensate of 2-chloro-4,6-bis(4-n-butylamino-2,2,6,6-tetramethylpiperidyl)-1,3,5-triazine and 1,2-bis(3-aminopropylamino)ethane; the condensate of 2-chloro-4,6-bis(4-n-butylamino-1,2,2,6,6-pentamethylpiperidyl)-1,3,5-triazine and 1,2-bis-(3-aminopropylamino)ethane; 2-[(2-hydroxyethyl)amino]-4,6-bis[N-(1-cyclohexyloxy-2,2,6,6-tetramethylpiperidin-4-yl)butylamino-1,3,5-triazine; propanedioic acid, [(4-methoxyphenyl)-methylene]-bis-(1,2,2,6,6-pentamethyl-4-piperidinyl) ester; tetrakis(2,2,6,6-tetramethylpiperidin-4-yl)-1,2,3,4-butanetetracarboxylate; benzenepropanoic acid, 3,5-bis(1,1-dimethylethyl)-4-hydroxy-, 1-[2-[3-[3,5-bis(1,1-dimethylethyl)-4-hydroxyphenyl]-1-oxopropoxy]ethyl]-2,2,6,6-tetramethyl-4-piperidinyl ester; N-(1-octyloxy-2,2,6,6-tetramethylpiperidin-4-yl)-N′-dodecyloxalamide; tris(2,2,6,6-tetramethylpiperidin-4-yl) nitrilotriacetate; 1,5-dioxaspiro{5,5}undecane-3,3-dicarboxylic acid, bis(1,2,2,6,6-pentamethyl-4-piperidinyl): 1,5-dioxaspiro{5,5}undecane-3,3-dicarboxylic acid, bis(2,2,6,6-tetramethyl-4-piperidinyl); the condensate of 1-(2-hydroxyethyl)-2,2,6,6-tetramethyl-4-hydroxypiperidine and succinic acid; the condensate of N,N′-bis(2,2,6,6-tetramethylpiperidin-4-yl)hexamethylenediamine and 4-tert-octylamino-2,6-dichloro-1,3,5-triazine; 1,2,3,4-butanetetracarboxylic acid, 1,2,2,6,6-pentamethyl-4-piperidinyl tridecyl ester; tetrakis(2,2,6,6-tetramethylpiperidin-4-yl)-1,2,3,4-butanetetracarboxylate; 1,2,3,4-butanetetracarboxylic acid, 2,2,6,6-tetramethyl-4-piperidinyl tridecyl ester; tetrakis(1,2,2,6,6-pentamethylpiperidin-4-yl)-1,2,3,4-butanetetracarboxylate; mixture of 2,2,4,4-tetramethyl-21-oxo-7-oxa-3.20-diazaspiro(5.1.11.2)-heneicosane-20-propanoic acid-dodecylester and 2,2,4,4-tetramethyl-21-oxo-7-oxa-3.20-diazaspiro(5.1.11.2)-heneicosane-20-propanoic acid-tetradecylester; 1H,4H,5H,8H-2,3a,4a,6,7a,8a-hexaazacyclopenta[def]fluorene-4,8-dione, hexahydro-2,6-bis(2,2,6,6-tetramethyl-4-piperidinyl)-; polymethyl[propyl-3-oxy(2′,2′,6′,6′-tetramethyl-4,4′-piperidinyl)]siloxane; polymethyl[propyl-3-oxy(1′,2′,2′,6′,6′-pentamethyl-4,4′-piperidinyl)]siloxane; copolymer of methylmethacrylate with ethyl acrylate and 2,2,6,6-tetramethylpiperidin-4-yl acrylate; copolymer of mixed C₂₀ to C₂₄ alpha-olefins and (2,2,6,6-tetramethylpiperidin-4-yl)succinimide; 1,2,3,4-butanetetracarboxylic acid, polymer with β,β,β′,β′-tetramethyl-2,4,8,10-tetraoxaspiro[5.5]undecane-3,9-diethanol, 1,2,2,6,6-pentamethyl-4-piperidinyl ester; 1,2,3,4-butanetetracarboxylic acid, polymer with β,β,β′,β′-tetramethyl-2,4,8,10-tetraoxaspiro[5.5]undecane-3,9-diethanol, 2,2,6,6-tetramethyl-4-piperidinyl ester copolymer; 1,3-benzenedicarboxamide, N,N′-bis(2,2,6,6-tetramethyl-4-piperidinyl; 1,1′-(1,10-dioxo-1,10-decanediyl)-bis(hexahydro-2,2,4,4,6-pentamethylpyrimidine; ethane diamide, N-(1-acetyl-2,2,6,6-tetramethylpiperidinyl)-N′-dodecyl; formamide, N,N′-1,6-hexanediylbis[N-(2,2,6,6-tetramethyl-4-piperidinyl); D-glucitol, 1,3:2,4-bis-O-(2,2,6,6-tetramethyl-4-piperidinylidene)-; 2,2,4,4-tetramethyl-7-oxa-3,20-diaza-21-oxo-dispiro[5.1.11.2]heneicosane; propanamide, 2-methyl-N-(2,2,6,6-tetramethyl-4-piperidinyl)-2-[(2,2,6,6-tetramethyl-4-piperidinyl)amino]-; 7-oxa-3,20-diazadispiro[5.1.11.2]heneicosane-20-propanoic acid, 2,2,4,4-tetramethyl-21-oxo-, dodecyl ester; N-(2,2,6,6-tetramethylpiperidin-4-yl)-p-aminopropionic acid dodecyl ester; N-(2,2,6,6-tetramethylpiperidin-4-yl)-N′-aminooxalamide; propanamide, N-(2,2,6,6-tetramethyl-4-piperidinyl)-3-[(2,2,6,6-tetramethyl-4-piperidinyl)amino]-; mixture of 4-hexadecyloxy- and 4-stearyloxy-2,2,6,6-tetramethylpiperidine; 3-dodecyl-1-(1,2,2,6,6-pentamethylpiperidin-4-yl)pyrrolidine-2,5-dione; 3-dodecyl-1-(1-ethanoyl-2,2,6,6-pentamethylpiperidin-4-yl)pyrrolidine-2,5-dione; bis(2,2,6,6-tetramethylpiperidin-4-yl)succinate; bis(1,2,2,6,6-pentamethylpiperidin-4-yl) n-butyl 3,5-di-tert-butyl-4-hydroxybenzylmalonate; tris(2,2,6,6-tetramethylpiperidin-4-yl) nitrilotriacetate; 1,1′-(1,2-ethanediyl)bis(3,3,5,5-tetramethylpiperazinone); 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; a mixture of 4-hexadecyloxy- and 4-stearyloxy-2,2,6,6-tetramethylpiperidine; 2-undecyl-7,7,9,9-tetramethyl-1-oxa-3,8-diaza-4-oxospiro[4.5]decane; 1,5-dioxaspiro{5,5}undecane-3,3-dicarboxylic acid, bis(2,2,6,6-tetramethyl-4-piperidinyl) and 1,5-dioxaspiro{5,5}undecane-3,3-dicarboxylic acid, bis(1,2,2,6,6-pentamethyl-4-piperidinyl); N¹-(3-hydroxyethyl)3,3-pentamethylene-5,5-dimethylpiperazin-2-one; N¹-tert-octyl-3,3,5,5-tetramethyl-diazepin-2-one; N¹-tert-octyl-3,3-pentamethylene-5,5-hexamethylene-diazepin-2-one; N¹-tert-octyl-3,3-pentamethylene-5,5-dimethylpiperazin-2-one; trans-1,2-cyclohexane-bis-(N¹-5,5-dimethyl-3,3-pentamethylene-2-piperazinone; trans-1,2-cyclohexane-bis-(N¹-3,3,5,5-dispiropentamethylene-2-piperazinone); N¹-isopropyl-1,4-diazadispiro-(3,3,5,5)pentamethylene-2-piperazinone; N¹-isopropyl-1,4-diazadispiro-3,3-pentamethylene-5,5-tetramethylene-2-piperazinone; N¹-isopropyl-5,5-dimethyl-3,3-pentamethylene-2-piperazinone; trans-1,2-cyclohexane-bis-N¹-(dimethyl-3,3-pentamethylene-2-piperazinone); N¹-octyl-5,5-dimethyl-3,3-pentamethylene-1,4-diazepin-2-one; N¹-octyl-1,4-diazadispiro-(3,3,5,5)pentamethylene-1,5-diazepin-2-one; and mixtures thereof.

Embodiment 11. A stabilizer composition according to any one of embodiments 1 to 10, wherein the co-synergist (IV) is selected from the group consisting of N,N′-ethylene bis(stearamide) (EBS), N.N′-ethylene bis(oleamide) (EBO), N,N′-hexamethylene bis(stearamide), N,N′-hexamethylene bis(oleamide), N,N′-hexamethylene bis(erucamide), N.N′-hexamethylene bis(behenamide), N,N′-ethylene bis(erucamide), N,N′-ethylene bis(behenamide), and mixtures thereof.

Embodiment 12. A stabilizer composition according to embodiment 11, wherein the co-synergist (IV) is selected from the group consisting of N,N′-ethylene bis(stearamide) (EBS), N,N′-ethylene bis(oleamide) (EBO), and mixtures thereof.

Embodiment 13. A stabilizer composition according to any one of embodiments 1 to 12, wherein the co-active agent is an alkoxylated alcohol, or monoalkyl ether thereof, according to Formula (III):

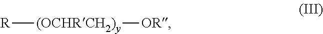

wherein R is a hydrocarbyl group having from 12 to 60 carbon atoms; R′ is chosen from H or C₁-C₄ alkyl; R″ is chosen from H or a hydrocarbyl group having from 1 to 10 carbon atoms; and y is an integer from 1 to 100.

Embodiment 14. A stabilizer composition according to embodiment 13, wherein R is a C₁₂-C₃₀ alkyl.

Embodiment 15. A stabilizer composition according to embodiment 13, wherein R is C₁₂-C₂₂ alkyl.

Embodiment 16. A stabilizer composition according to any one of embodiments 13 to 15, wherein R″ is H.

Embodiment 17. A stabilizer composition according to any one of embodiments 13 to 16, wherein y is from 1 to 75.

Embodiment 18. A stabilizer composition according to any one of embodiments 13 to 17, wherein the co-active agent comprises an ethoxylated and/or propoxylated alcohol, wherein the ethoxylated and/or propoxylated alcohol is selected from the group consisting of ethoxylated and/or propoxylated docosyl alcohol, stearyl alcohol, oleyl alcohol, cetyl alcohol, isotridecyl alcohol, lauryl alcohol, C₁₂-C₁₅ alcohols, C₁₆/C₁₈ alcohols, and C₂₀-C₅₀ alcohols.

Embodiment 19. A stabilizer composition according to embodiment 18, wherein the co-active agent comprises a mixture of ethoxylated alcohol and propoxylated alcohol.

Embodiment 20. A stabilizer composition according to embodiment 19, wherein the ethoxylated alcohol and propoxylated alcohol comprise ethoxylated C₁₂-C₃₀ alcohols and propoxylated C₁₂-C₃₀ alcohols.

Embodiment 21. A stabilizer composition according to embodiment 19 or embodiment 20, wherein the co-active agent is selected from the group consisting of C₁₂-C₁₅ oxo alcohols having 2 ethylene oxide and 5 propylene oxide groups; and C₁₂-C₁₅ oxo alcohols having 5 ethylene oxide and 2 propylene oxide groups.

Embodiment 22. A stabilizer composition according to embodiment 13, wherein R″ is methyl and the co-active agent comprises a monomethyl ether of an ethoxylated and/or propoxylated alcohol, wherein the alcohol is selected from the group consisting of docosyl alcohol; stearyl alcohol; oleyl alcohol; cetyl alcohol; isotridecyl alcohol; lauryl alcohol; C₁₂-C₁₅ alcohols; C₁₆/C₁₈ alcohols; and C₂₀-C₅₀ alcohols.

Embodiment 23. A stabilizer composition according to any one of embodiments 1 and 3 to 22, further comprising an orthohydroxyphenyl benzotriazole compound selected from the group consisting of 2-(2′-hydroxy-5′-methylphenyl)-benzotriazole; 2-(2′-hydroxy-5′-tert-butylphenyl)benzotriazole; 2-(2′-hydroxy-3′-methyl-5′-tert-butylphenyl)-benzotriazole; 2-(2′-hydroxy-5′-cyclohexylphenyl)-benzotriazole; 2-(2′-hydroxy-3′,5′-dimethylphenyl)-benzotriazole; 2-(2′-hydroxy-5′-tert-butylphenyl)-5-chloro-benzotriazole; 2-(2′-hydroxy-5-tert-octylphenyl)-2H-benzotriazole; 2-(2′-hydroxy-5-octylphenyl)-2H-benzotriazole; 2-(3′,5′-di-tert-butyl-2′-hydroxyphenyl)-5-chlorobenzotriazole; 2-(3′-tert-butyl-5′-methyl-butyl-2′hydroxyphenyl)-5-chlorobenzotriazole; 2-(3′,5′-di-tert-amyl-2′-hydroxyphenyl)benzotriazole; 2-(3′,5′-bis(α,α-dimethylbenzyl)-2′-hydroxyphenyl)benzotriazole; 2-(3′-tert-butyl-2′-hydroxy-5′-(2-octyloxycarbonylethyl)phenyl)benzotriazole; 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; 2-[2′-hydroxy-3′-(α,α-dimethylbenzyl)-5′-(1,1,3,3-tetramethyl-butyl)phenyl]benzotriazole; 5-trifluoromethyl-2-(2-hydroxy-3-α-cumyl-5-tert-octylphenyl)-2H-benzotriazole; 2-(2′-hydroxy-5′-(2-hydroxyethyl)phenyl)benzotriazole; 2-(2′-hydroxy-5′-(2-methacryloyloxyethyl)phenyl)benzotriazole; 2-(3′-tert-butyl-5′-methyl-2′-hydroxyphenyl)-5-chloro-benzotriazole; 2-(3′-sec-butyl-5′-tert.butyl-2′-hydroxyphenyl)-benzotriazole; 2-(3′,5′-di-tert-butyl-2′-hydroxyphenyl)-benzotriazole; 2-(5′-tert-octyl-2′-hydroxyphenyl)-benzotriazole; 2-(3′-dodecyl-5′-methyl-2′-hydroxyphenyl)-benzotriazole; 2-(3′-tert-butyl-5′-(2-octyloxycarbonylethyl)-2′-hydroxyphenyl)-5-chlorobenzotriazole; 2-(5′-methyl-2′-hydroxyphenyl)-benzotriazole; 2-(5′-tert-butyl-2′-hydroxyphenyl)-benzotriazole; 2-(2′-hydroxy-3′-di-tert-butylphenyl)-benzotriazole; and mixtures thereof.

Embodiment 24. A stabilizer composition according to embodiment 2, wherein the orthohydroxyphenyl benzotriazole compound is selected from the group consisting of 2-(2′-hydroxy-5′-methylphenyl)-benzotriazole; 2-(2′-hydroxy-5′-tert-butylphenyl)benzotriazole; 2-(2′-hydroxy-3′-methyl-5′-tert-butylphenyl)-benzotriazole; 2-(2′-hydroxy-5′-cyclohexylphenyl)-benzotriazole; 2-(2′-hydroxy-3′,5′-dimethylphenyl)-benzotriazole; 2-(2′-hydroxy-5′-tert-butylphenyl)-5-chloro-benzotriazole; 2-(2′-hydroxy-5-tert-octylphenyl)-2H-benzotriazole; 2-(2′-hydroxy-5-octylphenyl)-2H-benzotriazole; 2-(3′,5′-di-tert-butyl-2′-hydroxyphenyl)-5-chlorobenzotriazole; 2-(3′-tert-butyl-5′-methyl-butyl-2′hydroxyphenyl)-5-chlorobenzotriazole; 2-(3′,5′-di-tert-amyl-2′-hydroxyphenyl)benzotriazole; 2-(3′,5′-bis(α,α-dimethylbenzyl)-2′-hydroxyphenyl)benzotriazole; 2-(3′-tert-butyl-2′-hydroxy-5′-(2-octyloxycarbonylethyl)phenyl)benzotriazole; 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; 2-[2′-hydroxy-3′-(α,α-dimethylbenzyl)-5′-(1,1,3,3-tetramethyl-butyl)phenyl]benzotriazole; 5-trifluoromethyl-2-(2-hydroxy-3-α-cumyl-5-tert-octylphenyl)-2H-benzotriazole; 2-(2′-hydroxy-5′-(2-hydroxyethyl)phenyl)benzotriazole; 2-(2′-hydroxy-5′-(2-methacryloyloxyethyl)phenyl)benzotriazole; 2-(3′-tert-butyl-5′-methyl-2′-hydroxyphenyl)-5-chloro-benzotriazole; 2-(3′-sec-butyl-5′-tert.butyl-2′-hydroxyphenyl)-benzotriazole; 2-(3′,5′-di-tert-butyl-2′-hydroxyphenyl)-benzotriazole; 2-(5′-tert-octyl-2′-hydroxyphenyl)-benzotriazole; 2-(3′-dodecyl-5′-methyl-2′-hydroxyphenyl)-benzotriazole; 2-(3′-tert-butyl-5′-(2-octyloxycarbonylethyl)-2′-hydroxyphenyl)-5-chlorobenzotriazole; 2-(5′-methyl-2′-hydroxyphenyl)-benzotriazole; 2-(5′-tert-butyl-2′-hydroxyphenyl)-benzotriazole; 2-(2′-hydroxy-3′-di-tert-butylphenyl)-benzotriazole; and mixtures thereof.

Embodiment 25. A stabilizer composition according to any one of embodiments 1 to 24, further comprising a stabilizing amount of a co-stabilizer selected from the group consisting of hindered benzoates or benzamides, thioesters, hydroxylamines, antioxidants, hindered phenols, phosphites, phosphonites, benzofuranones, nitrones, and mixtures thereof.

Embodiment 26. A stabilizer composition according to embodiment 25, wherein the co-stabilizer is a hindered benzoate or benzamide compound according to Formula (VII):

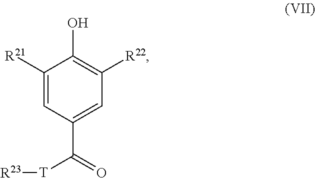

wherein
each of R²¹ and R²² is independently chosen from a C₁-C₁₂ alkyl;
T is chosen from O or NR²⁴, where R²⁴ is H or a C₁-C₃₀ hydrocarbyl; and
R²³ is H or a C₁-C₃₀ hydrocarbyl.

Embodiment 27. A stabilizer composition according to embodiment 26, wherein the hindered benzoate compound is selected from the group consisting of 2,4-di-tert-butylphenyl-3,5-di-tert-butyl-4-hydroxybenzoate; hexadecyl-3,5-di-tert-butyl-4-hydroxybenzoate; octadecyl-3,5-di-tert-butyl-4-hydroxybenzoate; octyl-3,5-di-tert-butyl-4-hydroxybenzoate; decyl-3,5-di-tert-butyl-4-hydroxybenzoate; dodecyl-3,5-di-tert-butyl-4-hydroxybenzoate; tetradecyl-3,5-di-tert-butyl-4-hydroxybenzoate; behenylyl-3,5-di-tert-butyl-4-hydroxybenzoate; 2-methyl-4,6-di-tert-butylphenyl-3,5-di-tert-butyl-4-hydroxybenzoate; butyl-3-[3-t-butyl-4-(3,5-di-t-butyl-4-hydroxybenzoyloxy)phenyl]propionate; and mixtures thereof.

Embodiment 28. A stabilizer composition according to any one of embodiments 1 to 27, further comprising a co-additive selected from the group consisting of nucleating agents, fillers, metallic stearates, metal oxides, reinforcing agents, plasticizers, lubricants, rheology agents, catalysts, leveling agents, optical brighteners, anti-static agents, blowing agents, flame retardants, dyes, pigments, and mixtures thereof.

Embodiment 29. A masterbatch concentrate comprising a stabilizer composition according to any one of embodiments 1 to 28; and at least one organic material identical to, or compatible with, an organic material to be stabilized by the masterbatch concentrate, wherein the masterbatch concentrate comprises 10 wt. % to 90 wt. of the stabilizer composition, based on the total weight of the masterbatch concentrate.

Embodiment 30. A stabilized polymer composition comprising an organic material to be stabilized and the stabilizer composition according to any one of embodiments 1 to 29.

Embodiment 31. A stabilized polymer composition according to embodiment 30, wherein the organic material to be stabilized is selected from the group consisting of polyolefins, poly(ethylene-vinyl acetate) (EVA), polyesters, polyethers, polyketones, polyamides, natural and synthetic rubbers, polyurethanes, polystyrenes, high-impact polystyrenes, polyacrylates, polymethacrylates, polybutyl acrylates, polyacetals, polyacrylonitriles, polybutadienes, polystyrenes, acrylonitrile-butadiene-styrene, styrene acrylonitrile, acrylate styrene acrylonitrile, cellulosic acetate butyrate, cellulosic polymers, polyimides, polyamideimides, polyetherimides, polyphenylsulfides, polyphenyloxidepolysulfones, polyethersulfones, polyvinylchlorides, polycarbonates, polyketones, aliphatic polyketones, thermoplastic olefins (TPO), polyolefin elastomers (POE), amino resin cross-linked polyacrylates and polyesters, polyisocyanate cross-linked polyesters and polyacrylates, phenol/formaldehyde, urea/formaldehyde and melamine/formaldehyde resins, drying and non-drying alkyd resins, alkyd resins, polyester resins, acrylate resins cross-linked with melamine resins, urea resins, isocyanates, isocyanurates, carbamates, epoxy resins, cross-linked epoxy resins derived from aliphatic, cycloaliphatic, heterocyclic and aromatic glycidyl compounds, which are cross-linked with anhydrides or amines, polysiloxanes, Michael addition polymers, amines, blocked amines with activated unsaturated and methylene compounds, ketimines with activated unsaturated and methylene compounds, polyketimines in combination with unsaturated acrylic polyacetoacetate resins, polyketimines in combination with unsaturated acrylic resins, coating compositions, radiation curable compositions, epoxy melamine resins, organic dyes, cosmetic products, cellulose-based paper formulations, photographic film paper, fibers, waxes, and inks.

Embodiment 32. A stabilized polymer composition according to embodiment 31, wherein the organic material to be stabilized is a polyolefin selected from the group consisting of i) polymers of monoolefins chosen from polyethylene, polypropylene, polyisobutylene, polybut-1-ene, or poly-4-methylpent-1-ene; ii) polymers of diolefins chosen from polyisoprene or polybutadiene; iii) polymers of cycloolefins chosen from cyclopentene or norbornene; iv) polyethylene chosen from optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); v) thermoplastic olefins (TPO); vi) polyolefin elastomers (POE); vii) copolymers thereof, and viii) mixtures thereof.

Embodiment 33. A stabilized polymer composition according to any one of embodiments 29 to 32, wherein olefin polymers or co-polymers functionalized with carboxylic acids or functional equivalents thereof are absent from the composition.

Embodiment 34. A stabilized polymer composition according to embodiment 33, wherein the functionalized olefin polymers and co-polymers are reaction products of an olefin polymer or copolymer with an α,β-unsaturated carboxylic acid reagent, wherein the carboxylic acid reagent is a carboxylic acid, ester, or anhydride.

Embodiment 35. A stabilized article of manufacture comprising an organic material to be stabilized; and
a) from 0.01 wt. % to 15 wt. %, based on the total weight of the stabilized article of manufacture, of a stabilizer composition comprising:
i) a stabilizing amount of an ultraviolet light absorber (UVA) selected from the group consisting of: orthohydroxyphenyl triazine compounds;
orthohydroxybenzophenone compounds; oxanilides; cyanoacrylates; benzoxazinone compounds; and mixtures thereof,
ii) a stabilizing amount of a hindered amine light stabilizer compound (HALS) comprising a functional group according to Formula (II):

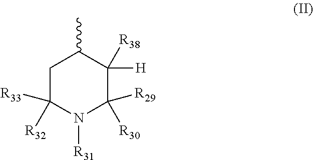

wherein R₃₁ is chosen from: hydrogen; OH; C₁-C₂₀ hydrocarbyl; —CH₂CN; C₁-C₁₂ acyl; or C₁-C₁₈ alkoxy; R₃₈ is chosen from: hydrogen; or C₁-C₈ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or a functional group according to Formula (IIa):

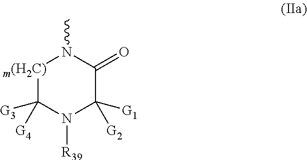

wherein
m is an integer from 1 to 2;
R₃₉ is chosen from: hydrogen; OH; C₁-C₂₀ hydrocarbyl; —CH₂CN; C₁-C₁₂ acyl; or C₁-C₁₈ alkoxy; and
each of G₁-G₄ is independently chosen from C₁-C₂₀ hydrocarbyl; or
mixtures of HALS compounds having functional groups according to Formula (II) and Formula (IIa);
iii) a stabilizing amount of a co-synergist selected from the group consisting of bisamides of fatty acids of the general formula (IV):

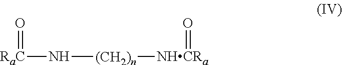

wherein Rₐ is a C₇ to C₂₅ alkyl group with 0 to 6 unsaturated double bonds and n is 2 to 10; and,
iv) a stabilizing amount of a co-active agent selected from the group consisting of alkoxylated C₁₂-C₆₀ alcohols or monoalkyl ethers thereof; alkoxylated esters of fatty acids; sorbitan esters or ethoxylates thereof; mono- or polyglycerol esters having from 1 to 20 glycerol units or alkoxylates thereof; alkoxylated fatty amines, esters thereof, or salts thereof; sugar esters; alkoxylated fatty amides; ethylene oxide/propylene oxide copolymers; and mixtures thereof;
wherein the total weight of co-synergist (IV) and co-active agent is from 1 wt. % to 99 wt. %, based on the total weight of the stabilizer composition; and
the ratio of co-synergist (IV) to co-active agent is 1:99 to 99:1;
or
b) a masterbatch concentrate according to embodiment 29;
such that the final concentration of the combined co-synergist (IV) and co-active agent in the stabilized article of manufacture is from 0.01 wt. % to 5 wt. %, based on the weight of the stabilized article of manufacture.

Embodiment 36. A stabilized article of manufacture according to embodiment 35, wherein the final concentration of combined co-synergist (IV) and co-active agent in the stabilized article of manufacture is from 0.01 wt. % to 1 wt. %, based on the weight of the stabilized article of manufacture.

Embodiment 37. A stabilized article of manufacture according to embodiment 35 or embodiment 36, wherein the ratio of combined co-synergist (IV) and co-active agent to ultraviolet light absorber (UVA) is from 200:1 to 1:50.

Embodiment 38. A stabilized article of manufacture according to embodiment 37, wherein the ratio of combined co-synergist (IV) and co-active agent to ultraviolet light absorber (UVA) is 50:1 to 1:30.

Embodiment 39. A stabilized article of manufacture comprising an organic material to be stabilized; and
a) from 0.01 wt. % to 15 wt. %, based on the total weight of the stabilized article of manufacture, of a stabilizer composition comprising:
i) a stabilizing amount of an ultraviolet light absorber (UVA) selected from the group consisting of: orthohydroxyphenyl triazine compounds; orthohydroxybenzophenone compounds; orthohydroxyphenyl benzotriazole compounds; oxanilides; cyanoacrylates; benzoxazinone compounds; and mixtures thereof,
ii) a stabilizing amount of a hindered amine light stabilizer compound (HALS) comprising a functional group according to Formula (II):

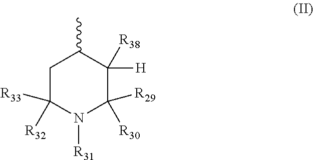

wherein R₃₁ is chosen from: hydrogen; OH; C₁-C₂₀ hydrocarbyl; —CH₂CN; C₁-C₁₂ acyl; or C₁-C₁₈ alkoxy; R₃₈ is chosen from: hydrogen; or C₁-C₈ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or a functional group according to Formula (IIa):

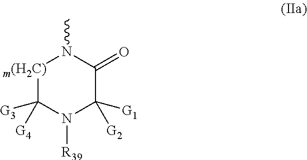

wherein
m is an integer from 1 to 2;
R₃₉ is chosen from: hydrogen; OH; C₁-C₂₀ hydrocarbyl; —CH₂CN; C₁-C₁₂ acyl; or C₁-C₁₈ alkoxy; and
each of G₁-G₄ is independently chosen from C₁-C₂₀ hydrocarbyl; or
mixtures of HALS compounds having functional groups according to Formula (II) and Formula (IIa);
iii) a stabilizing amount of a co-synergist selected from the group consisting of bisamides of fatty acids of the general formula (IV):

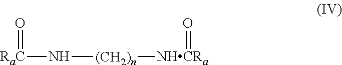

wherein Rₐ is a C₇ to C₂₅ alkyl group with 0 to 6 unsaturated double bonds and n is 2 to 10; and,
wherein a co-active agent selected from the group consisting of alkoxylated C₁₂-C₆₀ alcohols or monoalkyl ethers thereof; alkoxylated esters of fatty acids; sorbitan esters or ethoxylates thereof, mono- or polyglycerol esters having from 1 to 20 glycerol units or alkoxylates thereof; alkoxylated fatty amines, esters thereof, or salts thereof, sugar esters; alkoxylated fatty amides; ethylene oxide/propylene oxide copolymers; and mixtures thereof, is absent from the stabilizer composition (0 wt. %); and
wherein the co-synergist (IV) is present at from 1 wt. % to 99 wt. %, based on the total weight of the stabilizer composition
or
b) a masterbatch concentrate according to embodiment 29;
such that the final concentration of the combined co-synergist (IV) and co-active agent in the stabilized article of manufacture is from 0.01 wt. % to 5 wt. %, based on the weight of the stabilized article of manufacture.

Embodiment 40. A stabilized article of manufacture according to any of embodiments 35 to 39, wherein the organic material to be stabilized is selected from the group consisting of polyolefins, poly(ethylene-vinyl acetate) (EVA), polyesters, polyethers, polyketones, polyamides, natural and synthetic rubbers, polyurethanes, polystyrenes, high-impact polystyrenes, polyacrylates, polymethacrylates, polybutyl acrylates, polyacetals, polyacrylonitriles, polybutadienes, polystyrenes, acrylonitrile-butadiene-styrene, styrene acrylonitrile, acrylate styrene acrylonitrile, cellulosic acetate butyrate, cellulosic polymers, polyimides, polyamideimides, polyetherimides, polyphenylsulfides, polyphenyloxidepolysulfones, polyethersulfones, polyvinylchlorides, polycarbonates, polyketones, aliphatic polyketones, thermoplastic olefins (TPO), polyolefin elastomers (POE), amino resin cross-linked polyacrylates and polyesters, polyisocyanate cross-linked polyesters and polyacrylates, phenol/formaldehyde, urea/formaldehyde and melamine/formaldehyde resins, drying and non-drying alkyd resins, alkyd resins, polyester resins, acrylate resins cross-linked with melamine resins, urea resins, isocyanates, isocyanurates, carbamates, epoxy resins, cross-linked epoxy resins derived from aliphatic, cycloaliphatic, heterocyclic and aromatic glycidyl compounds, which are cross-linked with anhydrides or amines, polysiloxanes, Michael addition polymers, amines, blocked amines with activated unsaturated and methylene compounds, ketimines with activated unsaturated and methylene compounds, polyketimines in combination with unsaturated acrylic polyacetoacetate resins, polyketimines in combination with unsaturated acrylic resins, coating compositions, radiation curable compositions, epoxymelamine resins, organic dyes, cosmetic products, cellulose-based paper formulations, photographic film paper, fibers, waxes, and inks.

Embodiment 41. An stabilized article of manufacture according to embodiment 40, wherein the organic material to be stabilized is a polyolefin polymer selected from the group consisting of i) polymers of monoolefins chosen from polyethylene, polypropylene, polyisobutylene, polybut-1-ene, or poly-4-methylpent-1-ene; ii) polymers of diolefins chosen from polyisoprene or polybutadiene; iii) polymers of cycloolefins chosen from cyclopentene or norbornene; iv) polyethylene chosen from optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); v) thermoplastic olefins (TPO); vi) polyolefin elastomers (POE); vii) copolymers thereof, and viii) mixtures thereof.

Embodiment 42. A stabilized polymer composition according to any one of embodiments 35 to 41, wherein olefin polymers or co-polymers functionalized with carboxylic acids or functional equivalents thereof are absent from the composition.

Embodiment 43. A stabilized polymer composition according to Embodiment 42, wherein the functionalized olefin polymers and co-polymers are reaction products of an olefin polymer or copolymer with an α,β-unsaturated carboxylic acid reagent, wherein the carboxylic acid reagent is a carboxylic acid, ester, or anhydride.

### Processes/Methods of Use:

### UV Weathering Performance of Polypropylene (60° Gloss Data)

Sample Preparation. The various additive materials are compounded with polypropylene (Pro-fax 6301) polymer from Lyondell Basell Industries and extruded using conventional single-screw extrusion parameters. After extrusion, standard 2×2×0.125 inch plaques and tensile bars are injection molded using an Arburg injection molding machine. The conditions during injection molding are as follows: nozzle temperature: 230° C.; injection pressure: 60, shot size: 14.5. The additives are used as received, except that certain ethoxylated alcohols are methylated according to the methods below.

UV weathering. Samples are exposed to QUV-313 under ASTM G-154 testing conditions. Gloss (600) values are measured at set exposure intervals. High gloss value indicates smooth surface without surface crazing or blooming effects. Samples are considered failed when they start to show surface crazing.

The results are shown in the Tables below. The various co-active agents and other additives used in formulating the examples is provided below by trade name, chemical name, and source of supply. In some cases these same chemicals may be available from other suppliers under different trade name.

Table of Chemical Sources

| Sample Name | Chemical Name | Supplier |
|---|---|---|
| Ethylene Bis | N,N′-(Ethane-1,2- | Sigma Aldrich |
| Stearamide (EBS) | diyl)di(octadecanamide) | |
| Ethylene Bis | N,N′-Dioleoylethylenediamine | Wako Chemical |
| Oleamide (OBS) | | Ltd. |
| Erucamide | 13-Docosenamide | Tokyo Chemical |
| | | Industry Co., Ltd. |
| BRIJ ® S2 | Polyoxyethylene (2 EO) | Sigma Aldrich |
| | stearyl ether | |
| CYASORB ® | 2-[4,6-bis(2,4-dimethylphenyl)- | Cytec Industries |
| UV-1164 | 1,3,5-triazin-2-yl]-5- | Inc. |
| | (octyloxy) phenol | |
| Methylated | 2-(2-methoxy-4-octyloxyphenyl)- | Cytec Industries |
| CYASORB ® | 4,6-bis(2,4-dimethylphenyl)- | Inc. |
| UV-1164 | 1,3,5-triazine | |
| CYASORB ® | Substituted amine oligomer | Cytec Industries |
| UV-3346 | (1,6-hexanediamine, N,N′- | Inc. |
| | bis(2,2,6,6-tetramethyl-4- | |
| | piperidinyl)-, polymers with | |
| | morpholine-2,4,6-trichloro- | |
| | 1,3,5-triazine reaction | |
| | products | |
| CYASORB ® | mixture of 4-hexadecyloxy- | Cytec Industries |
| UV-3853 | and 4-stearyloxy-2,2,6,6- | Inc. |
| | tetramethylpiperidine | |
| CYASORB ® | 3,5-di-[t-butyl]-4- | Cytec Industries |
| UV-2908 | hydroxybenzoic acid | Inc. |
| | hexadecyl ester | |
| CYASORB ® | 2-Hydroxy-4-n- | Cytec Industries |
| UV-531 | octyloxybenzophenone | Inc. |
| CYASORB ® | 2-(2-Hydroxy-5-t- | Cytec Industries |
| UV-5411 | octylphenyl)benzotriazole | Inc. |

TABLE 1
UV Weathering Performance of Polypropylene Stabilized
with HALS + UV Absorber + Ethylene
Bis Stearamide (60° Gloss Data)

| | | 60° | 60° | 60° |
|---|---|---|---|---|
| | 60° | Gloss | Gloss | Gloss |
| | Gloss | (After | (After | (After |
| Description | (Initial) | 300 hr) | 800 hr) | 1000 hr) |
| 1-(1) No additive | 88.0 | Failed* | — | — |
| 1-(2) 0.15% Ethylene | 88.5 | Failed* | — | — |
| Bis Stearamide | | | | |
| 1-(3) 0.09% UV-3346 + | 88.4 | 88 | Failed* | — |
| 0.01% UV-1164 | | | | |
| 1-(4) 0.09% UV-3346 + | 89.2 | 88.8 | 85.6 | 84.8 |
| 0.01% UV-1164 + 0.15% | | | | |
| Ethylene Bis Stearamide | | | | |

*Sample failed due to surface crazing.

Formulation 1-(4) demonstrate that Ethylene Bis Stearamide shows synergistic performance when used in combination with UV-1164 (UV absorber)/UV-3346 (HALS).

TABLE 2
UV Weathering Performance of Polypropylene Stabilized
with HALS + UV Absorber + Ethylene
Bis Stearamide (60° Gloss Data)

| | | 60° | 60° | 60° |
|---|---|---|---|---|
| | 60° | Gloss | Gloss | Gloss |
| | Gloss | (After | (After | (After |
| Description | (Initial) | 300 hr) | 1200 hr) | 1300 hr) |
| 2-(1) No additive | 88.0 | Failed* | — | |
| 2-(2) 0.15% 0.15% Ethylene | 88.5 | Failed* | — | |
| Bis Stearamide | | | | |
| 2-(3) 0.09% UV-3853 + | 87.8 | 88.8 | Failed* | |
| 0.01% UV-1164 | | | | |
| 2-(4) 0.09% UV-3853 + | 88.3 | 77.7 | 66.7 | 69 |
| 0.01% UV-1164 + 0.15% | | | | |
| Ethylene Bis Stearamide | | | | |

*Sample failed due to surface crazing.

Formulation 2-(4) demonstrates that Ethylene Bis Stearamide shows synergistic performance when used in combination with UV-1164 (UV absorber)/UV-3853 (HALS).

TABLE 3
UV Weathering Performance of Polypropylene Stabilized with
HALS + UV Absorber + Hindered Benzoate +
Ethylene Bis Stearamide (60° Gloss Data)

| | | 60° | 60° | 60° |
|---|---|---|---|---|
| | 60° | Gloss | Gloss | Gloss |
| | Gloss | (After | (After | (After |
| Description | (Initial) | 300 hr) | 800 hr) | 1000 hr) |
| 3-(1) No additive | 88.0 | Failed* | — | — |
| 3-(2) 0.15% Ethylene | 88.5 | Failed* | — | — |
| Bis Stearamide | | | | |
| 3-(3) 0.06% UV-3346 + | 88.9 | 87.4 | Failed* | — |
| 0.01% UV-1164 + 0.03% | | | | |
| UV-2908 | | | | |
| 3-(4) 0.06% UV-3346 + | 88.7 | 85.9 | 77.5 | 76.9 |
| 0.01% UV-1164 + 0.03% | | | | |
| UV-2908 + 0.15% Ethylene | | | | |
| Bis Stearamide | | | | |

*Sample failed due to surface crazing.

Formulation 3-(4) demonstrates that ethylene bis stearamide shows synergistic performance when used in combination with UV-1164 (UV absorber)/UV-3346 (HALS)/UV-2908 (Hindered Benzoate).

TABLE 4
UV Weathering Performance of Polypropylene Stabilized with
UV Absorbers + Ethylene Bis Stearamide +
Ethoxylated Alcohol (60° Gloss Data)

| | | 60° | 60° | 60° | 60° |
|---|---|---|---|---|---|
| | 60° | Gloss | Gloss | Gloss | Gloss |
| | Gloss | (After | (After | (After | (After |
| Description | (Initial) | 300 hr) | 1000 hr) | 1100 hr) | 1200 hr) |
| 4-(1) No Additive | 88.0 | Failed* | — | — | — |
| 4-(2) 0.09% UV- | 87.3 | 86.3 | Failed* | — | — |
| 3346 + 0.01% | | | | | |
| UV-1164 + | | | | | |
| 0.15% BRIJ ® | | | | | |
| S2 | | | | | |
| 4-(3) 0.09% UV- | 89.2 | 88.8 | 84.8 | Failed* | — |
| 3346 + 0.01% | | | | | |
| UV-1164 + | | | | | |
| 0.15% Ethylene | | | | | |
| Bis Stearamide | | | | | |
| 4-(4) 0.09% UV- | 88.7 | 88.3 | 86.7 | 86.1 | 86.0 |
| 3346 + 0.01% | | | | | |
| UV-1164 + | | | | | |
| 0.075% BRIJ ® | | | | | |
| S2 + 0.075% | | | | | |
| Ethylene Bis | | | | | |
| Stearamide | | | | | |

*Sample failed due to surface crazing.

Formulation 4-(4) demonstrates that Ethylene Bis Stearamide shows synergistic performance when used in combination with UV-1164 (UV absorber)/UV-3346 (HALS)/BRIJ® S2 (Ethoxylated Alcohol). Formulation 4-(2) and 4-(3) show that Ethylene Bis Stearamide contributes to better synergistic performance than BRIJ® S2 in terms of enhancing UV weathering stability.

TABLE 5
UV Weathering Performance of Polypropylene Stabilized with
HALS + UV Absorbers + Hindered Benzoate + Ethylene
Bis Stearamide + Ethoxylated Alcohol (60° Gloss Data)

| | | 60° | 60° | 60° | 60° |
|---|---|---|---|---|---|
| | 60° | Gloss | Gloss | Gloss | Gloss |
| | Gloss | (After | (After | (After | (After |
| Description | (Initial) | 300 hr) | 800 hr) | 1000 hr) | 1100 hr) |
| 5-(1) No Additive | 88.0 | Failed* | — | — | — |
| 5-(2) 0.06% UV- | 88.3 | 87.8 | Failed* | — | — |
| 3346 + 0.01% | | | | | |
| UV-1164 + | | | | | |
| 0.03% UV- | | | | | |
| 2908 + 0.15% | | | | | |
| BRIJ ® S2 | | | | | |
| 5-(3) 0.06% UV- | 88.7 | 85.9 | 77.5 | Failed* | — |
| 3346 + 0.01% | | | | | |
| UV-1164 + | | | | | |
| 0.03% UV- | | | | | |
| 2908 + 0.15% | | | | | |
| Ethylene | | | | | |
| Bis Stearamide | | | | | |
| 5-(4) 0.06% UV- | 89.4 | 87.4 | 81.3 | 80.8 | 80.7 |
| 3346 + 0.01% | | | | | |
| UV-1164 + | | | | | |
| 0.03% UV- | | | | | |
| 2908 + 0.075% | | | | | |
| BRIJ ® S2 + | | | | | |
| 0.075% Ethylene | | | | | |
| Bis Stearamide | | | | | |

*Sample failed due to surface crazing.

Formulation 5-(4) demonstrates that Ethylene Bis Stearamide shows synergistic performance when used in combination with UV-1164 (UV absorber)/UV-3346 (HALS)/UV-2908 (Hindered Benzoate)/BRIJ® S2 (Ethoxylated Alcohol). Formulation 5-(2) and 5-(3) show that Ethylene Bis Stearamide contributes to better synergistic performance than BRIJ® S2 in terms of enhancing UV weathering stability.

TABLE 6
UV Weathering Performance of Polypropylene Stabilized
with HALS + UV Absorber + Ethylene
Bis Stearamide (60° Gloss Data)

| | | 60° | 60° | 60° | 60° |
|---|---|---|---|---|---|
| | 60° | Gloss | Gloss | Gloss | Gloss |
| | Gloss | (After | (After | (After | (After |
| Description | (Initial) | 300 hr) | 600 hr) | 900 hr) | 1000 hr) |
| 6-(1) No additive | 88.0 | Failed* | — | — | — |
| 6-(2) 0.15% | 88.5 | Failed* | — | — | — |
| Ethylene | | | | | |
| Bis Stearamide | | | | | |
| 6-(3) 0.09% UV- | 89.1 | 89.4 | Failed* | — | — |
| 3346 + | | | | | |
| 0.01% UV-5411 | | | | | |
| 6-(4) 0.09% UV- | 88.5 | 87.4 | 83.9 | 80.8 | Failed* |
| 3346 + 0.01% | | | | | |
| UV-5411 + | | | | | |
| 0.15% Ethylene | | | | | |
| Bis Stearamide | | | | | |

*Sample failed due to surface crazing.

Formulation 6-(4) demonstrates that Ethylene Bis Stearamide shows synergistic performance when used in combination with UV-5411 (UV absorber)/UV-3346 (HALS).

TABLE 7
UV Weathering Performance of Polypropylene Stabilized
with HALS + UV Absorber + Ethylene
Bis Stearamide (60° Gloss Data)

| | | 60° | 60° | 60° | 60° |
|---|---|---|---|---|---|
| | 60° | Gloss | Gloss | Gloss | Gloss |
| | Gloss | (After | (After | (After | (After |
| Description | (Initial) | 300 hr) | 600 hr) | 900 hr) | 1000 hr) |
| 7-(1) No additive | 88.0 | Failed* | — | — | — |
| 7-(2) 0.15% Ethylene | 88.5 | Failed* | — | — | — |
| Bis Stearamide | | | | | |
| 7-(3) 0.09% UV- | 89.1 | 89.0 | Failed* | — | — |
| 3346 + | | | | | |
| 0.01% UV-531 | | | | | |
| 7-(4) 0.09% UV- | 89.2 | 88.2 | 85.9 | 87.3 | Failed* |
| 3346 + | | | | | |
| 0.01% UV- | | | | | |
| 531 + 0.15% | | | | | |
| Ethylene | | | | | |
| Bis Stearamide | | | | | |

*Sample failed due to surface crazing.

Formulation 7-(4) demonstrates that Ethylene Bis Stearamide shows synergistic performance when used in combination with UV-531 (UV absorber)/UV-3346 (HALS). Comparison of formulation 7-(4) with formulation 6-(4) and 1-(4) shows Ethylene Bis Stearamide has better synergistic performance with triazines based UV absorbers (UV-1164) than benzophenone based UV absorbers (UV-531) and benzotriazole based UV absorbers (UV-5411).

TABLE 8
UV Weathering Performance of Polypropylene Stabilized with HALS + UV
Absorber + Ethylene Bis Stearamide (60° Gloss Data)

| | | 60° | 60° | 60° | 60° | 60° |
|---|---|---|---|---|---|---|
| | 60° | Gloss | Gloss | Gloss | Gloss | Gloss |
| | Gloss | (After | (After | (After | (After | (After |
| Description | (Initial) | 100 hr) | 600 hr) | 800 hr) | 900 hr) | 1000 hr) |
| 8-(1) No additive | 88.0 | Failed* | — | — | — | — |
| 8-(2) 0.15% Ethylene Bis | 88.5 | Failed* | — | — | — | — |
| Stearamide | | | | | | |
| 8-(3) 0.09% UV-3346 + | 88.4 | 88 | Failed* | — | — | — |
| 0.01% UV-1164 | | | | | | |
| 8-(4) 0.09% UV-3346 + | 89.2 | 88.8 | 84 | 80 | 71 | 45 |
| 0.01% UV-1164 + 0.075% | | | | | | |
| Ethylene Bis Stearamide | | | | | | |
| 8-(5) 0.09% UV-3346 + | 88 | 86 | 75 | 72 | 66 | 55 |
| 0.01% UV-1164 + 0.15% | | | | | | |
| Ethylene Bis Stearamide | | | | | | |
| 8-(6) 0.09% UV-3346 + | 88 | 88 | 75 | 62 | 60 | 51 |
| 0.01% UV-1164 + 0.3% | | | | | | |
| Ethylene Bis Stearamide | | | | | | |
| 8-(7) 0.09% UV-3346 + | 88 | 87 | 84 | 65 | 40 | Failed* |
| 0.01% UV-1164 + 0.6% | | | | | | |
| Ethylene Bis Stearamide | | | | | | |
| 8-(8) 0.09% UV-3346 + | 88 | 88 | 88 | 84 | 57 | Failed* |
| 0.01% UV-1164 + 1.0% | | | | | | |
| Ethylene Bis Stearamide | | | | | | |

*Sample failed due to surface crazing.

Formulation 8-(4) to 8-(8) demonstrates that Ethylene Bis Stearamide at different loading levels all shows synergistic performance when used in combination with UV-1164 (UV absorber)/UV-3346 (HALS). Ethylene Bis Stearamide at 0.075% significantly improves the UV weathering stability. Further increase of Ethylene Bis Stearamide loading level does not significantly help improve UV weathering stability.

TABLE 9
UV Weathering Performance of Polypropylene Stabilized with HALS +
UV Absorber + Ethylene Bis Oleamide (60° Gloss Data)

| | | 60° | 60° | 60° | 60° |
|---|---|---|---|---|---|
| | 60° | Gloss | Gloss | Gloss | Gloss |
| | Gloss | (After | (After | (After | (After |
| Description | (Initial) | 100 hr) | 600 hr) | 700 hr) | 1000 hr) |
| 9-(1) No additive | 88 | Failed* | — | — | — |
| 9-(2) 0.075% | 88 | Failed* | — | — | — |
| Ethylene | | | | | |
| Bis Oleamide | | | | | |
| 9-(3) 0.15% | 88 | Failed* | — | — | — |
| Ethylene | | | | | |
| Bis Oleamide | | | | | |
| 9-(4) 0.09% | 88 | 88 | Failed* | — | — |
| UV-3346 + | | | | | |
| 0.01% UV-1164 | | | | | |
| 9-(5) 0.09% UV- | 88 | 89 | 89 | 64 | Failed* |
| 3346 + 0.01% | | | | | |
| UV-1164 + | | | | | |
| 0.075% Ethylene | | | | | |
| Bis Oleamide | | | | | |
| 9-(6) 0.09% UV- | 89 | 87 | 90 | 90 | 63 |
| 3346 + 0.01% | | | | | |
| UV-1164 + | | | | | |
| 0.15% Ethylene | | | | | |
| Bis Oleamide | | | | | |

*Sample failed due to surface crazing.

Formulation 9-(5) and 9-(6) demonstrates that Ethylene Bis Oleamide shows synergistic performance when used in combination with UV-1164 (UV absorber)/UV-3346 (HALS).

TABLE 10
UV Weathering Performance of Polypropylene Stabilized with HALS + UV
Absorber + Stearamide/Erucamide (60° Gloss Data)

| | | 60° | 60° | 60° | 60° | 60° |
|---|---|---|---|---|---|---|
| | 60° | Gloss | Gloss | Gloss | Gloss | Gloss |
| | Gloss | (After | (After | (After | (After | (After |
| Description | (Initial) | 100 hr) | 600 hr) | 800 hr) | 900 hr) | 1000 hr) |
| 10-(1) No additive | 88 | Failed* | — | — | — | — |
| 10-(2) 0.09% UV-3346 + | 88 | 88 | Failed* | — | — | — |
| 0.01% UV-1164 | | | | | | |
| 10-(3) 0.09% UV-3346 + | 88 | 86 | 75 | 72 | 66 | 55 |
| 0.01% UV-1164 + 0.15% | | | | | | |
| Ethylene Bis Stearamide | | | | | | |
| 10-(4) 0.09% UV-3346 + | 89 | 87 | 90 | 89 | 88 | 63 |
| 0.01% UV-1164 + 0.15% | | | | | | |
| Ethylene Bis Oleamide | | | | | | |
| 10-(5) 0.09% UV-3346 + | 88 | 46 | Failed** | — | — | — |
| 0.01% UV-1164 + 0.15% | | | | | | |
| Stearamide | | | | | | |
| 10-(6) 0.09% UV-3346 + | 88 | 68 | 62 | Failed** | — | — |
| 0.01% UV-1164 + 0.15% | | | | | | |
| Erucamide | | | | | | |

*Sample failed due to surface crazing.
**Sample failed due to surface blooming on the exposed side.

Formulation 10-(5) and 10-(6) demonstrates that Stearamide or Erucamide does not show synergistic performance when used in combination with UV-1164 (UV absorber)/UV-3346 (HALS). Both 10-(5) and 10-(6) show strong blooming on the exposed side of plaque. Comparison of 10-(3) and 10-(4) with 10-(5) and 10-(6) show Ethylene Bis Stearamide and Ethylene Bis Oleamide perform much better than Stearamide and Erucamide in terms of enhancing the UV weathering performance of polymers.

### Thermal Aging Performance of Polypropylene (60° Gloss Data)

For thermal aging, samples are exposed to 150° C. convection oven conditions. Gloss (60°) values are measured at set exposure intervals. High gloss value indicates smooth surface without surface crazing or blooming effects. Samples are considered failed when they start to show surface crazing.

TABLE 11
Thermal Aging Performance of Polypropylene Stabilized with
HALS + UV Absorber + Hindered Benzoate + Ethylene
Bis Stearamide at 150° C. (60° Gloss Data)

| | | 60° | 60° | 60° |
|---|---|---|---|---|
| | 60° | Gloss | Gloss | Gloss |
| | Gloss | (After | (After | (After |
| Description | (Initial) | 100 hr) | 200 hr) | 400 hr) |
| 11-(1) No additive | 88.0 | Failed* | — | — |
| 11-(2) 0.15% | 88.5 | Failed* | — | — |
| Ethylene | | | | |
| Bis Stearamide | | | | |
| 11-(3) 0.06% UV- | 88.9 | 89.7 | Failed* | — |
| 3346 + 0.01% | | | | |
| UV-1164 + | | | | |
| 0.03% UV-2908 | | | | |
| 11-(4) 0.06% UV- | 88.7 | 85.2 | 80.5 | 77.2 |
| 3346 + 0.01% | | | | |
| UV-1164 + | | | | |
| 0.03% UV- | | | | |
| 2908 + 0.15% | | | | |
| Ethylene | | | | |
| Bis Stearamide | | | | |

*Sample failed due to surface crazing.

Formulation 11-(4) demonstrates that Ethylene Bis Stearamide enhances thermal performance when used in synergistic combination with UV-1164 (UV absorber)/UV-3346 (HALS)/UV-2908 (Hindered Benzoate).

As those skilled in the art will appreciate, all ranges described herein include the upper and lower limits, as well as any value in between as if specifically recited herein, and each value is contemplated by the inventors. Thus, disclosure of a narrower range or more specific group in addition to a broader range is not a disclaimer of the broader range or larger group. Various patent and/or scientific literature references have been referred to throughout this application. The disclosures of these publications in their entireties are hereby incorporated by reference as if written herein. However, if a term in the present application contradicts or conflicts with a term in the incorporated reference, the term from the present application takes precedence over the conflicting term from the incorporated reference. In view of the above description and the examples, one of ordinary skill in the art will be able to practice the disclosure as claimed without undue experimentation.

Although the foregoing description has shown, described, and pointed out the fundamental novel features of the typical embodiments of the invention, it will be understood that various omissions, substitutions, and changes may be made by those skilled in the art, without departing from the scope of the present teachings.

TABLE 12
UV Weathering Performance of Polypropylene Stabilized with UV Stabilizer +
Ethylene Bis Stearamide (EBS) (60° Gloss Data)

| | | 60° | 60° | 60° | 60° | 60° |
|---|---|---|---|---|---|---|
| | 60° | Gloss | Gloss | Gloss | Gloss | Gloss |
| | Gloss | (After | (After | (After | (After | (After |
| Description | (Initial) | 100 hr) | 200 hr) | 300 hr) | 500 hr) | 800 hr) |
| 12-(1) No additive | 88.0 | Failed* | | | | |
| 12-(2) 0.01% UV-1164 | 88.0 | Failed* | | | | |
| 12-(3) 0.10% UV-1164 | 88.0 | 88.2 | 88.0 | Failed* | | |
| 12-(4) 0.01% UV-1164 + | 88.0 | Failed* | | | | |
| 0.075% Ethylene Bis Stearamide | | | | | | |
| 12-(5) 0.10% UV-1164 + | 88.0 | 88.2 | Failed* | | | |
| 0.075% Ethylene Bis Stearamide | | | | | | |
| 12-(6) 0.09% UV-3346 | 88.2 | 88.0 | 88.2 | 87.8 | 88.0 | Failed* |
| 12-(7) 0.09% UV-3346 + | 88.4 | 88 | 88.2 | 88.0 | Failed* | |
| 0.075% Ethylene Bis Stearamide | | | | | | |
| 12-(8) 0.10% UV-2908 | 88.2 | Failed* | | | | |
| 12-(9) 0.10% UV-2908 + | 88.0 | Failed* | | | | |
| 0.075% Ethylene Bis Stearamide | | | | | | |

*Sample failed due to surface crazing.

Formulations 12-(2) to 12-(5) demonstrate that Ethylene Bis Stearamide (EBS) shows no synergistic performance advantage when used in combination with UV-1164 alone. Instead comparing 12-(3) to 12-(5), shows that EBS in fact has an adverse effect on the performance of UV-1164. Similarly, Formulations 12-(6) to 12-(7) demonstrate that Ethylene Bis Stearamide (EBS) shows no synergistic performance advantage when used in combination with UV-3346, rather EBS once again has an adverse effect on the performance of UV-3346 alone. Formulations 12-(8) to 12-(9) demonstrate that Ethylene Bis Stearamide shows no synergistic performance when used in combination with UV-2908 alone.

1. A stabilizer composition comprising:
i) a stabilizing amount of an ultraviolet light absorber (UVA) selected from the group consisting of orthohydroxyphenyl triazine compounds, orthohydroxybenzophenone compounds, oxanilides, cyanoacrylates, benzoxazinone compounds, and mixtures thereof;
ii) a stabilizing amount of a hindered amine light stabilizer compound (HALS) comprising a functional group according to Formula (II): 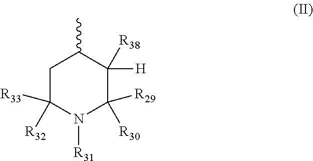
wherein R₃₁ is chosen from: hydrogen; OH; C₁-C₂₀ hydrocarbyl; —CH₂CN; C₁-C₁₂ acyl; or C₁-C₁₈ alkoxy; R₃₈ is chosen from: hydrogen; or C₁-C₅ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or
a functional group according to Formula (IIa): 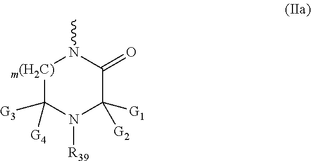
wherein
m is an integer from 1 to 2;
R₃₉ is chosen from: hydrogen; OH; C₁-C₂₀ hydrocarbyl; —CH₂CN; C₁-C₁₂ acyl; or C₁-C₁₈ alkoxy; and
each of G₁-G₄ is independently chosen from C₁-C₂₀ hydrocarbyl; or
mixtures of HALS compounds having functional groups according to Formula (II) and Formula (IIa);
iii) a stabilizing amount of a co-synergist selected from the group consisting of bisamides of fatty acids of the general formula (IV): 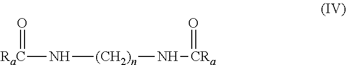
wherein Rₐ is a C₇ to C₂₅ alkyl group with 0 to 6 unsaturated double bonds and n is 2 to 10; and
iv) a stabilizing amount of a co-active agent selected from the group consisting of alkoxylated C₁₂-C₆₀ alcohols or monoalkyl ethers thereof; alkoxylated esters of fatty acids; sorbitan esters or ethoxylates thereof; mono- or polyglycerol esters having from 1 to 20 glycerol units or alkoxylates thereof; alkoxylated fatty amines, esters thereof, or salts thereof; sugar esters; alkoxylated fatty amides; ethylene oxide/propylene oxide copolymers; and mixtures thereof;
wherein the total weight of co-synergist (IV) and co-active agent is from 1 wt. % to 99 wt. %, based on the total weight of the stabilizer composition; and the weight ratio of co-synergist to co-active agent is 1:99 to 99:1,
or comprising:
i) a stabilizing amount of an ultraviolet light absorber (UVA) selected from the group consisting of orthohydroxyphenyl triazine compounds; orthohydroxybenzophenone compounds; orthohydroxyphenyl benzotriazole compounds; oxanilides; cyanoacrylates; benzoxazinone compounds; and mixtures thereof;
ii) a stabilizing amount of a hindered amine light stabilizer compound (HALS) comprising a functional group according to Formula (II): 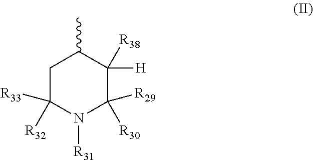
wherein R₃₁ is chosen from: hydrogen; OR C₁-C₂₀ hydrocarbyl; —CH₂CN; C₁-C₁₂ acyl; or C₁-C₁₈ alkoxy; R₃₈ is chosen from: hydrogen; or C₁-C₈ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or
a functional group according to Formula (IIa): 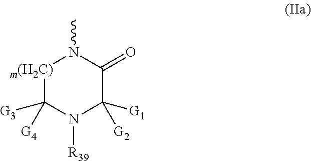
wherein
m is an integer from 1 to 2;
R₃₉ is chosen from: hydrogen; OR C₁-C₂₀ hydrocarbyl; —CH₂CN; C₁-C₁₂ acyl; or C₁-C₁₈ alkoxy; and
each of G₁-G₄ is independently chosen from C₁-C₂₀ hydrocarbyl; or
mixtures of HALS compounds having functional groups according to Formula (II) and Formula (IIa);
iii) a stabilizing amount of a co-synergist selected from the group consisting of bisamides of fatty acids of the general formula (IV): 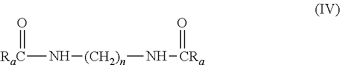
wherein Rₐ is a C₇ to C₂₅ alkyl group with 0 to 6 unsaturated double bonds and n is 2 to 10; and
wherein the co-synergist (IV) is present at from 1 wt. % to 99 wt. %, based on the total weight of the stabilizer composition; and
wherein a co-active agent selected from the group consisting of alkoxylated C₁₂-C₆₀ alcohols or monoalkyl ethers thereof; alkoxylated esters of fatty acids; sorbitan esters or ethoxylates thereof; mono- or polyglycerol esters having from 1 to 20 glycerol units or alkoxylates thereof; alkoxylated fatty amines, esters thereof, or salts thereof; sugar esters; alkoxylated fatty amides; ethylene oxide/propylene oxide copolymers; and mixtures thereof, is absent from the stabilizer composition (0 wt. %).

2. (canceled)

3. The stabilizer composition according to claim 1, wherein the combined co-synergist and co-active agent, and the combined UVA and HALS (co-synergist+co-active agent):(UVA+HALS) are present in a weight ratio from 1:50 to 50:1.

4. The stabilizer composition according to claim 1, wherein the ortho-hydroxyphenyl triazine compound is a 2-(2′-hydroxyphenyl)-1,3,5-triazine compound according to Formula (I): 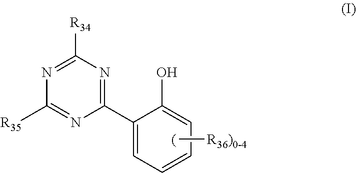
wherein
R₃₄ and R₃₅ are the same or different and are independently chosen from
a C₆-C₁₀ aryl group, wherein the C₆-C₁₀ aryl group is optionally substituted at from 1 to 3 substitutable positions with one or more group chosen from OH, halogen, C₁-C₁₂ alkyl, C₁-C₁₂ alkoxy, C₁₋₁₂ alkoxyester, C₂₋₁₂ alkanoyl, or phenyl, wherein the phenyl is optionally substituted at from 1 to 3 substitutable positions with one or more group chosen from: hydroxyl, halogen, C₁₋₁₂ alkyl, C₁₋₁₂ alkoxy, C₁₋₁₂ alkoxyester, or C₂₋₁₂ alkanoyl;
mono- or di-C₁-C₁₂ hydrocarbyl-substituted amino;
C₂-C₁₂ alkanoyl;
C₁-C₁₂ alkyl;
C₁-C₁₀ acyl; or
C₁-C₁₀ alkoxyl; and
R₃₆ is a substituent that is the same or different at from 0 to 4 positions of the phenoxy portion of Formula (I) and is independently chosen from hydroxyl, halogen, C₁-C₁₂ alkyl, C₁-C₁₂ alkoxy, C₁-C₁₂ alkoxyester, C₂-C₁₂ alkanoyl; phenyl; or C₁-C₁₂ acyl.

5. The stabilizer composition according to claim 4, wherein the 2-(2′-hydroxyphenyl)-1,3,5-triazine compound is selected from the group consisting of:
4,6-bis-(2,4-dimethylphenyl)-2-(2-hydroxy-4-octyloxyphenyl)-s-triazine;
2-(4,6-Diphenyl-1,3,5-triazin-2-yl-)-5-((hexyl)oxyl-phenol;
4,6-bis-(2,4-dimethylphenyl)-2-(2,4-dihydroxyphenyl)-s-triazine;
2,4-bis(2,4-dihydroxyphenyl)-6-(4-chlorophenyl)-s-triazine;
2,4-bis[2-hydroxy-4-(2-hydroxy-ethoxy)phenyl]-6-(4-chlorophenyl)-s-triazine;
2,4-bis[2-hydroxy-4-(2-hydroxy-4-(2-hydroxy-ethoxy)phenyl]-6-(2,4-dimethylphenyl)-s-triazine;
2,4-bis[2-hydroxy-4-(2-hydroxyethoxy)phenyl]-6-(4-bromophenyl)-s-triazine;
2,4-bis[2-hydroxy-4-(2-acetoxyethoxy)phenyl]-6-(4-chlorophenyl)-s-triazine;
2,4-bis(2,4-dihydroxyphenyl)-6-(2,4-dimethylphenyl)-s-triazine;
2,4-bis(4-biphenylyl)-6-[2-hydroxy-4-[(octyloxycarbonyl)ethylideneoxy]phenyl]-s-triazine;
2,4-bis(4-biphenylyl)-6-[2-hydroxy-4-(2-ethylhexyloxy)phenyl]-s-triazine;
2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine;
2,4-bis(2,4-dimethylphenyl)-6-[2-hydroxy-4(-3-benzyloxy-2-hydroxypropyloxy)phenyl]-s-triazine;
2,4-bis(2-hydroxy-4-n-butyloxyphenyl)-6-(2,4-di-n-butyloxyphenyl)-s-triazine;
2,4-bis(2,4-dimethylphenyl)-6-[2-hydroxy-4-(3-nonyloxy-2-hydroxypropyloxy)-5-α-cumylphenyl]-s-triazine;
methylenebis-{2,4-bis(2,4-dimethylphenyl)-6-[2-hydroxy-4-(3-butyloxy-2-hydroxypropoxy)phenyl]-s-triazine};
methylene bridged dimer mixture bridged in the 3:5′, 5:5′ and 3:3′ positions in a 5:4:1 ratio;
2,4,6-tris(2-hydroxy-4-isooctyloxycarbonyliso-propylideneoxy-phenyl)-s-triazine;
2,4,6,-tris(2-hydroxy-4-octyloxy-phenyl)-1,3,5-triazine;
2,4-bis(2,4-dimethylphenyl)-6-(2-hydroxy-4-hexyloxy-5-α-cumylphenyl)-s-triazine;
2-(2,4,6-trimethylphenyl)-4,6-bis[2-hydroxy-4-(3-butyloxy-2-hydroxypropyloxy)phenyl]-s-triazine;
2,4,6-tris[2-hydroxy-4-(3-sec-butyloxy-2-hydroxypropyloxy)-phenyl]-s-triazine;
mixture of 4,6-bis-(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine;
4,6-bis-(2,4-dimethylphenyl)-2-(2-hydroxy-4(3-(2-ethylhexyloxy)-2-hydroxypropoxy)-phenyl)-s-triazine;
4,6-diphenyl-2-(4-hexyloxy-2-hydroxyphenyl)-s-triazine; and
mixtures thereof.

6. The stabilizer composition according to claim 1, wherein:
the orthohydroxybenzophenone compound is selected from the group consisting of 2-hydroxy-4-methoxybenzophenone; 2,2′-dihydroxy-4-methoxybenzophenone; 2-hydroxy-4-octyloxybenzophenone; 2,2′-dihydroxy-4,4′-di-methoxybenzophenone; 2,2′-dihydroxybenzophenone; 2,2′,4,4′-tetrahydroxybenzophenone; 2,2′-dihydroxy-4,4′-dimethoxybenzophenone; 2,2′-dihydroxy-4,4′-diethoxybenzophenone; 2,2′-dihydroxy-4,4′-dipropoxybenzophenone; 2,2′-dihydroxy-4,4′-dibutoxybenzophenone; 2,2′-dihydroxy-4-methoxy-4′-ethoxybenzophenone; 2,2′-dihydroxy-4-methoxy-4′-propoxybenzophenone; 2,2′-dihydroxy-4-methoxy-4′-butoxybenzophenone; 2,2′-dihydroxy-4-ethoxy-4′-propoxybenzophenone; 2,2′-dihydroxy-4-ethoxy-4′-butoxybenzophenone; 2,3′-dihydroxy-4,4′-dimethoxybenzophenone; 2,3′-dihydroxy-4-methoxy-4′-butoxybenzophenone; 2-hydroxy-4,4′,5′-trimethoxybenzophenone; 2-hydroxy-4,4′,6′-tributoxybenzophenone; 2-hydroxy-4-butoxy-4′,5′-dimethoxybenzophenone; 2-hydroxy-4-ethoxy-2′,4′-dibutylbenzophenone; 2-hydroxy-4-propoxy-4′,6′-dichlorobenzophenone; 2-hydroxy-4-propoxy-4′,6′-dibromobenzophenone; 2,4-dihydroxybenzophenone; 2-hydroxy-4-ethoxybenzophenone; 2-hydroxy-4-propoxybenzophenone; 2-hydroxy-4-butoxybenzophenone; 2-hydroxy-4-methoxy-4′-methylbenzophenone; 2-hydroxy-4-methoxy-4′-ethylbenzophenone; 2-hydroxy-4-methoxy-4′-propylbenzophenone; 2-hydroxy-4-methoxy-4′-butylbenzophenone; 2-hydroxy-4-methoxy-4′-tertiary-butylbenzophenone; 2-hydroxy-4-methoxy-4′-chlorobenzophenone; 2-hydroxy-4-methoxy-2′-chlorobenzophenone; 2-hydroxy-4-methoxy-4′-bromobenzophenone; 2-hydroxy-4,4′-dimethoxybenzophenone; 2-hydroxy-4,4′-dimethoxy-3-methylbenzophenone; 2-hydroxy-4,4′-dimethoxy-2′-ethylbenzophenone; 2-hydroxy-4,4′,5′-trimethoxybenzophenone; 2-hydroxy-4-ethoxy-4′-methylbenzophenone; 2-hydroxy-4-ethoxy-4′-ethylbenzophenone; 2-hydroxy-4-ethoxy-4′-propylbenzophenone; 2-hydroxy-4-ethoxy-4′-butylbenzophenone; 2-hydroxy-4-ethoxy-4′-methoxybenzophenone; 2-hydroxy-4,4′-diethoxybenzophenone; 2-hydroxy-4-ethoxy-4′-propoxybenzophenone; 2-hydroxy-4-ethoxy-4′-butoxybenzophenone; 2-hydroxy-4-ethoxy-4′-chlorobenzophenone; 2-hydroxy-4-ethoxy-4′-bromobenzophenone; and mixtures thereof; and/or
the benzoxazinone compound is selected from the group consisting of 2-methyl-3,1-benzoxazin-4-one; 2-butyl-3,1-benzoxazin-4-one; 2-phenyl-3,1-benzoxazin-4-one; 2-(1- or 2-naphthyl)-3,1-benzoxazin-4-one; 2-(4-biphenyl)-3,1-benzoxazin-4-one; 2-p-nitrophenyl-3,1-benzoxazin-4-one; 2-m-nitrophenyl-3,1-benzoxazin-4-one; 2-p-benzoylphenyl-3,1-benzoxazin-4-one; 2-p-methoxyphenyl-3,1-benzoxazin-4-one; 2-O-methoxyphenyl-3,1-benzoxazin-4-one; 2-cyclohexyl-3,1-benzoxazin-4-one; 2-p-(or m-)phthalimidephenyl-3,1-benzoxazin-4-one; N-phenyl-4-(3,1-benzoxazin-4-one-2-yl)phthalimide; N-benzoyl-4-(3,1-benzoxazine-4-one-2-yl)aniline; N-benzoyl-N-methyl-4-(3,1-benzoxazin-4-one-2-yl)-aniline; 2-[p-(N-phenylcarbamonyl)phenyl]-3,1-benzoxazin-4-one; 2-[p-(N-phenyl N-methylcarbamoyl)phenyl]-3,1-benzoxazin-4-one; 2,2′-bis(3,1-benzoxazin-4-one); 2,2′-ethylenebis(3,1-benzoxazin-4-one); 2,2′-tetramethylenebis(3,1-benzoxazin-4-one); 2,2′-hexamethylenebis(3,1-benzoxazin-4-one); 2,2′-decamethylenebis(3,1-benzoxazin-4-one); 2,2′-p-phenylenebis(3,1-benzoxazin-4-one); 2,2′-m-phenylenebis(3,1-benzoxazin-4-one); 2,2′-(4,4′-diphenylene)bis(3,1-benzoxazin-4-one); 2,2′-(2,6- or 1,5-naphthalene)bis(3,1-benzoxazin-4-one); 2,2′-(2-methyl-p-phenylene)bis(3,1-benzoxazin-4-one); 2,2′-(2-nitro-p-phenylene)bis(3,1-benzoxazin-4-one); 2,2′-(2-chloro-p-phenylene)bis(3,1-benzoxazin-4-one); 2,2′-(1,4-cyclohexylene)bis(3,1-benzoxazin-4-one); N-p-(3,1-benzoxazin-4-on-2-yl)phenyl; 4-(3,1-benzoxazin-4-on-2-yl)phthalimide: N-p-(3,1-benzoxazin-4-on-2-yl)benzoyl; 4-(3,1-benzoxazin-4-on-2-yl)aniline; 1,3,5-tri(3,1-benzoxazin-4-on-2-yl)benzene; 1,3,5-tri(3,1-benzoxazin-4-on-2-yl)naphthalene; 2,4,6-tri(3,1-benzoxazin-4-on-2-yl)naphthalene; and mixtures thereof; and/or
the hindered amine light stabilizer compound is selected from the group consisting of bis(2,2,6,6-tetramethylpiperidin-4-yl) sebacate; bis(2,2,6,6-tetramethylpiperidin-4-yl)succinate; bis(1,2,2,6,6-pentamethylpiperidin-4-yl)sebacate; bis(1-octyloxy-2,2,6,6-tetramethylpiperidin-4-yl)sebacate; bis(1,2,2,6,6-pentamethylpiperidin-4-yl) n-butyl 3,5-di-tert-butyl-4-hydroxybenzylmalonate; a condensate of 1-(2-hydroxyethyl)-2,2,6,6-tetramethyl-4-hydroxypiperidine and succinic acid; 2,2,6,6-tetramethylpiperidin-4-yl stearate; 2,2,6,6-tetramethylpiperidin-4-yl dodecanate; 1,2,2,6,6-pentamethylpiperidin-4-yl stearate; 1,2,2,6,6-pentamethylpiperidin-4-yl dodecanate; a condensate of N,N′-bis(2,2,6,6-tetramethylpiperidin-4-yl)hexamethylenediamine and 4-tert-octylamino-2,6-dichloro-1,3,5-triazine; tris(2,2,6,6-tetramethylpiperidin-4-yl) nitrilotriacetate; tetrakis(2,2,6,6-tetramethylpiperidin-4-yl)-1,2,3,4-butanetetracarboxylate; 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; a condensate of N,N′-bis(2,2,6,6-tetramethylpiperidin-4-yl)hexamethylenediamine and 4-morpholino-2,6-dichloro-1,3,5-triazine; a condensate of N,N′-bis(2,2,6,6-tetramethylpiperidin-4-yl)hexamethylenediamine and 4-morpholino-2,6-dichloro-1,3,5-triazine, methylated; a condensate of 2-chloro-4,6-bis(4-n-butylamino-2,2,6,6-tetramethylpiperidyl)-1,3,5-triazine and 1,2-bis(3-aminopropylamino)ethane; a condensate of 2-chloro-4,6-bis(4-n-butylamino-1,2,2,6,6-pentamethylpiperidyl)-1,3,5-triazine and 1,2-bis-(3-aminopropylamino)ethane; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; a mixture of 4-hexadecyloxy- and 4-stearyloxy-2,2,6,6-tetramethylpiperidine; a mixture of 4-hexadecyloxy- and 4-stearyloxy-1,2,2,6,6-pentamethylpiperidine; a condensate of N,N′-bis(2,2,6,6-tetramethylpiperidin-4-yl)hexamethylenediamine and 4-cyclohexylamino-2,6-dichloro-1,3,5-triazine; a condensate of 1,2-bis(3-aminopropylamino)ethane, 2,4,6-trichloro-1,3,5-triazine and 4-butylamino-2,2,6,6-tetramethylpiperidine; 2-undecyl-7,7,9,9-tetramethyl-1-oxa-3,8-diaza-4-oxospiro[4.5]decane; oxo-piperanzinyl-triazines; a reaction product of 7,7,9,9-tetramethyl-2-cycloundecyl-1-oxa-3,8-diaza-4-oxospiro[4.5]decane and epichlorohydrin; tetrakis(2,2,6,6-tetramethyl-4-piperidyl) butane-1,2,3,4-tetracarboxylate; 1,2,3,4-butanetetracarboxylic acid, tetrakis(1,2,2,6,6-pentamethyl-4-piperidinyl)ester; 1,2,3,4-butanetetracarboxylic acid, 1,2,2,6,6-pentamethyl-4-piperdinyl tridecyl ester; 1,2,3,4-butanetetracarboxylic acid, 2,2,6,6-tetramethyl-4-piperidinyl tridecyl ester; 1,2,3,4-butanetetracarboxylic acid, polymer with 2,2,6,6-tetramethyl-2,4,8,10-tetraoxaspiro[5.51-undecane-3,9-diethanol,1,2,2,6,6-pentamethyl-4-piperdinyl ester; 1,2,3,4-butanetetracarboxylic acid, polymer with 2,2,6,6-tetramethyl-2,4,8,10-tetraoxaspiro[5.51-undecane-3,9-diethanol, 2,2,6,6-tetramethyl-4-piperdinyl ester; bis(1-undecanoxy-2,2,6,6-tetramethylpiperidin-4-yl)carbonate; 1-(2-hydroxy-2-methylpropoxy)-2,2,6,6-tetramethyl-4-piperdinol; 1-(2-hydroxy-2-methylpropoxy)-4-octadecanoyloxy-2,2,6,6-tetramethylpiperidine; 1-(4-octadecanoyloxy-2,2,6,6-tetramethylpiperidin-1-yloxy)-2-octadecanoyloxy-2-methylpropane; 1-(2-hydroxyethyl)-2,2,6,6-tetramethyl-4-piperdinol; a reaction product of 1-(2-hydroxyethyl)-2,2,6,6-tetramethyl-4-piperdinol and dimethylsuccinate; 2,2,4,4-tetramethyl-7-oxa-3,20-diazadispiro[5.1.11.2]heneicosan-21-one; the ester of 2,2,6,6-tetramethyl-4-piperidinol with higher fatty acids; 3-dodecyl-1-(2,2,6,6-tetramethyl-4-piperidyl)pyrrolidine-2,5-dione; 1H-Pyrrole-2,5-dione, 1-octadecyl-, polymer with (1-methylethenyl)benzene and 1-(2,2,6,6-tetramethyl-4-piperidinyl)-1H-pyrrole-2,5-dione; piperazinone, 1,1′,1″-[1,3,5-triazine-2,4,6-triyltris[(cyclohexylimino)-2,1-ethanediyl]]tris[3,3,5,5-tetramethyl-; piperazinone, 1,1′,1″-[1,3,5-triazine-2,4,6-triyltris[(cyclohexylimino)-2,1-ethanediyl]]tris[3,3,4,5,5-pentamethyl-; the reaction product of 7,7,9,9-tetramethyl-2-cycloundecyl-1-oxa-3,8-diaza-4-oxospiro[4.5]decane and epichlorohydrin; the condensate of N,N′-bis(2,2,6,6-tetramethylpiperidin-4-yl)hexamethylenediamine and 4-cyclohexylamino-2,6-dichloro-1,3,5-triazine; the condensate of 1,2-bis(3-aminopropylamino)ethane, 2,4,6-trichloro-1,3,5-triazine and 4-butylamino-2,2,6,6-tetramethylpiperidine; the condensate of N,N′-bis(2,2,6,6-tetramethylpiperidin-4-yl)hexamethylenediamine and 4-morpholino-2,6-dichloro-1,3,5-triazine; the condensate of 2-chloro-4,6-bis(4-n-butylamino-2,2,6,6-tetramethylpiperidyl)-1,3,5-triazine and 1,2-bis(3-aminopropylamino)ethane; the condensate of 2-chloro-4,6-bis(4-n-butylamino-1,2,2,6,6-pentamethylpiperidyl)-1,3,5-triazine and 1,2-bis-(3-aminopropylamino)ethane; 2-[(2-hydroxyethyl)aminol-4,6-bis[N-(1-cyclohexyloxy-2,2,6,6-tetramethylpiperidin-4-yl)butylamino-1,3,5-triazine; propanedioic acid, [(4-methoxyphenyl)-methylene]-bis-(1,2,2,6,6-pentamethyl-4-piperidinyl) ester; tetrakis(2,2,6,6-tetramethylpiperidin-4-yl)-1,2,3,4-butanetetracarboxylate; benzenepropanoic acid, 3,5-bis(1,1-dimethylethyl)-4-hydroxy-, 1-[2-[3-[3,5-bis(1,1-dimethylethyl)-4-hydroxyphenyl]-1-oxopropoxylethyl]-2,2,6,6-tetramethyl-4-piperidinyl ester; N-(1-octyloxy-2,2,6,6-tetramethylpiperidin-4-yl)-N′-dodecyloxalamide; tris(2,2,6,6-tetramethylpiperidin-4-yl) nitrilotriacetate; 1,5-dioxaspiro{5,5}undecane-3,3-dicarboxylic acid, bis(1,2,2,6,6-pentamethyl-4-piperidinyl): 1,5-dioxaspiro{5,5}undecane-3,3-dicarboxylic acid, bis(2,2,6,6-tetramethyl-4-piperidinyl) the condensate of 1-(2-hydroxyethyl)-2,2,6,6-tetramethyl-4-hydroxypiperidine and succinic acid; the condensate of N,N′-bis(2,2,6,6-tetramethylpiperidin-4-yl)hexamethylenediamine and 4-tert-octylamino-2,6-dichloro-1,3,5-triazine; 1,2,3,4-butanetetracarboxylic acid, 1,2,2,6,6-pentamethyl-4-piperidinyl tridecyl ester; tetrakis(2,2,6,6-tetramethylpiperidin-4-yl)-1,2,3,4-butanetetracarboxylate; 1,2,3,4-butanetetracarboxylic acid, 2,2,6,6-tetramethyl-4-piperidinyl tridecyl ester; tetrakis(1,2,2,6,6-pentamethylpiperidin-4-yl)-1,2,3,4-butanetetracarboxylate; mixture of 2,2,4,4-tetramethyl-21-oxo-7-oxa-3.20-diazaspiro(5.1.11.2)-heneicosane-20-propanoic acid-dodecylester and 2,2,4,4-tetramethyl-21-oxo-7-oxa-3.20-diazaspiro(5.1.11.2)-heneicosane-20-propanoic acid-tetradecylester; 1H,4H,5H,8H-2,3a,4a,6,7a,8a-hexaazacyclopenta[def]fluorene-4,8-dione, hexahydro-2,6-bis(2,2,6,6-tetramethyl-4-piperidinyl)-; polymethyl[propyl-3-oxy(2′,2′,6′,6′-tetramethyl-4,4′-piperidinyl)]siloxane; polymethyl[propyl-3-oxy(1′,2′,2′,6′,6′-pentamethyl-4,4′-piperidinyl)]siloxane; copolymer of methylmethacrylate with ethyl acrylate and 2,2,6,6-tetramethylpiperidin-4-yl acrylate; copolymer of mixed C₂₀ to C₂₄ alpha-olefins and (2,2,6,6-tetramethylpiperidin-4-yl)succinimide; 1,2,3,4-butanetetracarboxylic acid, polymer with β,β,β′,β′-tetramethyl-2,4,8,10-tetraoxaspiro[5.5]undecane-3,9-diethanol, 1,2,2,6,6-pentamethyl-4-piperidinyl ester; 1,2,3,4-butanetetracarboxylic acid, polymer with β,β,β′,β′-tetramethyl-2,4,8,10-tetraoxaspiro[5.5]undecane-3,9-diethanol, 2,2,6,6-tetramethyl-4-piperidinyl ester copolymer; 1,3-benzenedicarboxamide, N,N′-bis(2,2,6,6-tetramethyl-4-piperidinyl; 1,1′-(1,10-dioxo-1,10-decanediyl)-bis(hexahydro-2,2,4,4,6-pentamethylpyrimidine; ethane diamide, N-(1-acetyl-2,2,6,6-tetramethylpiperidinyl)-N′-dodecyl; formamide, N,N′-1,6-hexanediylbis[N-(2,2,6,6-tetramethyl-4-piperidinyl); D-glucitol, 1,3:2,4-bis-O-(2,2,6,6-tetramethyl-4-piperidinylidene)-; 2,2,4,4-tetramethyl-7-oxa-3,20-diaza-21-oxo-dispiro[5.1.11.2]heneicosane; propanamide, 2-methyl-N-(2,2,6,6-tetramethyl-4-piperidinyl)-2-[(2,2,6,6-tetramethyl-4-piperidinyl)amino]-; 7-oxa-3,20-diazadispiro[5.1.11.2]heneicosane-20-propanoic acid, 2,2,4,4-tetramethyl-21-oxo-dodecyl ester; N-(2,2,6,6-tetramethylpiperidin-4-yl)-3-aminopropionic acid dodecyl ester; N-(2,2,6,6-tetramethylpiperidin-4-yl)-N′-aminooxalamide; propanamide, N-(2,2,6,6-tetramethyl-4-piperidinyl)-3-[(2,2,6,6-tetramethyl-4-piperidinyl)amino]-; mixture of 4-hexadecyloxy- and 4-stearyloxy-2,2,6,6-tetramethylpiperidine; 3-dodecyl-1-(1,2,2,6,6-pentamethylpiperidin-4-yl)pyrrolidine-2,5-dione; 3-dodecyl-1-(1-ethanoyl-2,2,6,6-pentamethylpiperidin-4-yl)pyrrolidine-2,5-dione; bis(2,2,6,6-tetramethylpiperidin-4-yl)succinate; bis(1,2,2,6,6-pentamethylpiperidin-4-yl) n-butyl 3,5-di-tert-butyl-4-hydroxybenzylmalonate; tris(2,2,6,6-tetramethylpiperidin-4-yl) nitrilotriacetate; 1,1′-(1,2-ethanediyl)bis(3,3,5,5-tetramethylpiperazinone); 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; a mixture of 4-hexadecyloxy- and 4-stearyloxy-2,2,6,6-tetramethylpiperidine; 2-undecyl-7,7,9,9-tetramethyl-1-oxa-3,8-diaza-4-oxospiro[4.5]decane; 1,5-dioxaspiro{5,5}undecane-3,3-dicarboxylic acid, bis(2,2,6,6-tetramethyl-4-piperidinyl) and 1,5-dioxaspiro{5,5}undecane-3,3-dicarboxylic acid, bis(1,2,2,6,6-pentamethyl-4-piperidinyl); N¹—(β-hydroxyethyl)3,3-pentamethylene-5,5-dimethylpiperazin-2-one; N¹-tert-octyl-3,3,5,5-tetramethyl-diazepin-2-one; N¹-tert-octyl-3,3-pentamethylene-5,5-hexamethylene-diazepin-2-one; N¹-tert-octyl-3,3-pentamethylene-5,5-dimethylpiperazin-2-one; trans-1,2-cyclohexane-bis-(N¹-5,5-dimethyl-3,3-pentamethylene-2-piperazinone; trans-1,2-cyclohexane-bis-(N¹-3,3,5,5-dispiropentamethylene-2-piperazinone); N¹-isopropyl-1,4-diazadispiro-(3,3,5,5)pentamethylene-2-piperazinone; N¹-isopropyl-1,4-diazadispiro-3,3-pentamethylene-5,5-tetramethylene-2-piperazinone; N¹-isopropyl-5,5-dimethyl-3,3-pentamethylene-2-piperazinone; trans-1,2-cyclohexane-bis-N¹-(dimethyl-3,3-pentamethylene-2-piperazinone); N¹-octyl-5,5-dimethyl-3,3-pentamethylene-1,4-diazepin-2-one; N¹-octyl-1,4-diazadispiro-(3,3,5,5)pentamethylene-1,5-diazepin-2-one; and mixtures thereof.

7. (canceled)

8. The stabilizer composition according to claim 1, wherein the ratio of combined co-synergist (IV) and co-active agent to total amount of ultraviolet light absorber (UVA) is from 200:1 to 1:50.

9. (canceled)

10. The stabilizer composition according to claim 1, wherein the co-synergist (IV) is selected from the group consisting of N,N′-ethylene bis(stearamide) (EBS), N.N′-ethylene bis(oleamide) (EBO), N,N′-hexamethylene bis(stearamide), N,N′-hexamethylene bis(oleamide), N,N′-hexamethylene bis(erucamide), N.N′-hexamethylene bis(behenamide), N,N′-ethylene bis(erucamide), N,N′-ethylene bis(behenamide), and mixtures thereof.

11. The stabilizer composition according to claim 1, wherein the co-active agent is an alkoxylated alcohol, or monoalkyl ether thereof, according to Formula (III): 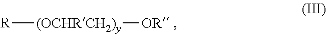
wherein R is a hydrocarbyl group having from 12 to 60 carbon atoms.

12. The stabilizer composition according to claim 11, wherein the co-active agent:
comprises an ethoxylated and/or propoxylated alcohol, wherein the ethoxylated and/or propoxylated alcohol is selected from the group consisting of ethoxylated and/or propoxylated docosyl alcohol, stearyl alcohol, oleyl alcohol, cetyl alcohol, isotridecyl alcohol, lauryl alcohol, C₁₂-C₁₅ alcohols, C₁₆/C₁₈ alcohols, and C₂₀-C₅₀ alcohols, or
comprises a mixture of ethoxylated alcohol and propoxylated alcohol; or
is selected from the group consisting of C₁₂-C₁₅ oxo alcohols having 2 ethylene oxide and 5 propylene oxide groups; and C₁₂-C₁₅ oxo alcohols having 5 ethylene oxide and 2 propylene oxide groups.

13.-14. (canceled)

15. The stabilizer composition according to claim 11, wherein R″ is methyl and the co-active agent comprises a monomethyl ether of an ethoxylated and/or propoxylated alcohol, wherein the alcohol is selected from the group consisting of docosyl alcohol; stearyl alcohol; oleyl alcohol; cetyl alcohol; isotridecyl alcohol; lauryl alcohol; C₁₂-C₁₅ alcohols; C₁₆/C₁₈ alcohols; and C₂₀-C₅₀ alcohols.

16. The stabilizer composition according to claim 1, wherein the orthohydroxyphenyl benzotriazole compound selected from the group consisting of 2-(2′-hydroxy-5′-methylphenyl)-benzotriazole; 2-(2′-hydroxy-5′-tert-butylphenyl)benzotriazole; 2-(2′-hydroxy-3′-methyl-5′-tert-butylphenyl)-benzotriazole; 2-(2′-hydroxy-5′-cyclohexylphenyl)-benzotriazole; 2-(2′-hydroxy-3′,5′-dimethylphenyl)-benzotriazole; 2-(2′-hydroxy-5′-tert-butylphenyl)-5-chloro-benzotriazole; 2-(2′-hydroxy-5-tert-octylphenyl)-2H-benzotriazole; 2-(2′-hydroxy-5-octylphenyl)-2H-benzotriazole; 2-(3′,5′-di-tert-butyl-2′-hydroxyphenyl)-5-chlorobenzotriazole; 2-(3′-tert-butyl-5′-methyl-butyl-2′ hydroxyphenyl)-5-chlorobenzotriazole; 2-(3′,5′-di-tert-amyl-2′-hydroxyphenyl)benzotriazole; 2-(3′,5′-bis(α,α-dimethylbenzyl)-2′-hydroxyphenyl)benzotriazole; 2-(3′-tert-butyl-2′-hydroxy-5′-(2-octyloxycarbonylethyl)phenyl)benzotriazole; 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; 2-[2′-hydroxy-3′-(α,α-dimethylbenzyl)-5′-(1,1,3,3-tetramethyl-butyl)phenyl]benzotriazole; 5-trifluoromethyl-2-(2-hydroxy-3-α-cumyl-5-tert-octylphenyl)-2H-benzotriazole; 2-(2′-hydroxy-5′-(2-hydroxyethyl)phenyl)benzotriazole; 2-(2′-hydroxy-5′-(2-methacryloyloxyethyl)phenyl)benzotriazole; 2-(3′-tert-butyl-5′-methyl-2′-hydroxyphenyl)-5-chloro-benzotriazole; 2-(3′-sec-butyl-5′-tert.butyl-2′-hydroxyphenyl)-benzotriazole; 2-(3′,5′-di-tert-butyl-2′-hydroxyphenyl)-benzotriazole; 2-(5′-tert-octyl-2′-hydroxyphenyl)-benzotriazole; 2-(3′-dodecyl-5′-methyl-2′-hydroxyphenyl)-benzotriazole; 2-(3′-tert-butyl-5′-(2-octyloxycarbonylethyl)-2′-hydroxyphenyl)-5-chlorobenzotriazole; 2-(5′-methyl-2′-hydroxyphenyl)-benzotriazole; 2-(5′-tert-butyl-2′-hydroxyphenyl)-benzotriazole; 2-(2′-hydroxy-3′-di-tert-butylphenyl)-benzotriazole; and mixtures thereof.

17. (canceled)

18. The stabilizer composition according to claim 1, further comprising a stabilizing amount of a co-stabilizer selected from the group consisting of hindered benzoates or benzamides, thioesters, hydroxylamines, antioxidants, hindered phenols, phosphites, phosphonites, benzofuranones, nitrones, and mixtures thereof.

19. The stabilizer composition according to claim 18, wherein the co-stabilizer is a hindered benzoate or benzamide compound according to Formula (VII): 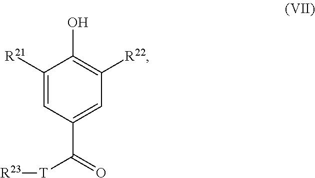
wherein
each of R²¹ and R²² is independently chosen from a C₁-C₁₂ alkyl;
T is chosen from O or NR²⁴, where R²⁴ is H or a C₁-C₃₀ hydrocarbyl; and
R²³ is H or a C₁-C₃₀ hydrocarbyl.

20. The stabilizer composition according to claim 1, further comprising a co-additive selected from the group consisting of nucleating agents, plasticizers, lubricants, rheology agents, catalysts, leveling agents, optical brighteners, anti-static agents, blowing agents, flame retardants, dyes, pigments, and mixtures thereof.

21. A masterbatch concentrate comprising a stabilizer composition according to claim 1; and at least one organic material identical to, or compatible with, an organic material to be stabilized by the masterbatch concentrate, wherein the masterbatch concentrate comprises 10 wt. % to 90 wt. % of the stabilizer composition, based on the total weight of the masterbatch concentrate.

22. A stabilized polymer composition comprising an organic material to be stabilized and the stabilizer composition according to claim 1.

23. The stabilized polymer composition according to claim 22, wherein the organic material to be stabilized:
is selected from the group consisting of polyolefins, poly(ethylene-vinyl acetate) (EVA), polyesters, polyethers, polyketones, polyamides, natural and synthetic rubbers, polyurethanes, polystyrenes, high-impact polystyrenes, polyacrylates, polymethacrylates, polybutyl acrylates, polyacetals, polyacrylonitriles, polybutadienes, polystyrenes, acrylonitrile-butadiene-styrene, styrene acrylonitrile, acrylate styrene acrylonitrile, cellulosic acetate butyrate, cellulosic polymers, polyimides, polyamideimides, polyetherimides, polyphenylsulfides, polyphenyloxidepolysulfones, polyethersulfones, polyvinylchlorides, polycarbonates, polyketones, aliphatic polyketones, thermoplastic olefins (TPO), polyolefin elastomers (POE), amino resin cross-linked polyacrylates and polyesters, polyisocyanate cross-linked polyesters and polyacrylates, phenol/formaldehyde, urea/formaldehyde and melamine/formaldehyde resins, drying and non-drying alkyd resins, alkyd resins, polyester resins, acrylate resins cross-linked with melamine resins, urea resins, isocyanates, isocyanurates, carbamates, epoxy resins, cross-linked epoxy resins derived from aliphatic, cycloaliphatic, heterocyclic and aromatic glycidyl compounds, which are cross-linked with anhydrides or amines, polysiloxanes, Michael addition polymers, amines, blocked amines with activated unsaturated and methylene compounds, ketimines with activated unsaturated and methylene compounds, polyketimines in combination with unsaturated acrylic polyacetoacetate resins, polyketimines in combination with unsaturated acrylic resins, coating compositions, radiation curable compositions, epoxymelamine resins, organic dyes, cosmetic products, cellulose-based paper formulations, photographic film paper, fibers, waxes, and inks, or
is a polyolefin selected from the group consisting of i) polymers of monoolefins chosen from polyethylene, polypropylene, polyisobutylene, polybut-1-ene, or poly-4-methylpent-1-ene; ii) polymers of diolefins chosen from polyisoprene or polybutadiene; iii) polymers of cycloolefins chosen from cyclopentene or norbornene; iv) polyethylene chosen from optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); v) thermoplastic olefins (TPO); vi) polyolefin elastomers (POE); vii) copolymers thereof; and viii) mixtures thereof.

24. (canceled)

25. The stabilized polymer composition according to claim 21,
wherein olefin polymers or co-polymers functionalized with carboxylic acids or functional equivalents thereof are absent from the composition, or
wherein the functionalized olefin polymers and co-polymers are reaction products of an olefin polymer or copolymer with an α,β-unsaturated carboxylic acid reagent, wherein the carboxylic acid reagent is a carboxylic acid, ester, or anhydride.

26. (canceled)

27. A stabilized article of manufacture comprising an organic material to be stabilized; and
a) from 0.01 wt. % to 15 wt. %, based on the total weight of the stabilized article of manufacture, of a stabilizer composition comprising:
i) a stabilizing amount of an ultraviolet light absorber (UVA) selected from the group consisting of: orthohydroxyphenyl triazine compounds; orthohydroxybenzophenone compounds; oxanilides; cyanoacrylates; benzoxazinone compounds; and mixtures thereof;
ii) a stabilizing amount of a hindered amine light stabilizer compound (HALS) comprising a functional group according to Formula (II): 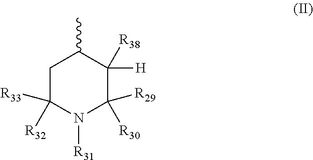
wherein R₃₁ is chosen from: hydrogen; OH; C₁-C₂₀ hydrocarbyl; —CH₂CN; C₁-C₁₂ acyl; or C₁-C₁₈ alkoxy; R₃₈ is chosen from: hydrogen; or C₁-C₈ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or
a functional group according to Formula (IIa): 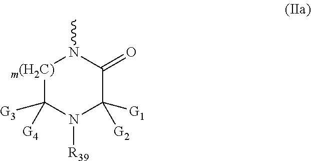
wherein
m is an integer from 1 to 2;
R₃₉ is chosen from: hydrogen; OH; C₁-C₂₀ hydrocarbyl; —CH₂CN; C₁-C₁₂ acyl; or C₁-C₁₅ alkoxy; and
each of G₁-G₄ is independently chosen from C₁-C₂₀ hydrocarbyl; or
mixtures of HALS compounds having functional groups according to Formula (II) and Formula (IIa);
iii) a stabilizing amount of a co-synergist selected from the group consisting of bisamides of fatty acids of the general formula (IV): 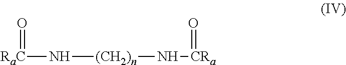
wherein Rₐ is a C₇ to C₂₅ alkyl group with 0 to 6 unsaturated double bonds and n is 2 to 10; and,
iv) a stabilizing amount of a co-active agent selected from the group consisting of alkoxylated C₁₂-C₆₀ alcohols or monoalkyl ethers thereof; alkoxylated esters of fatty acids; sorbitan esters or ethoxylates thereof; mono- or polyglycerol esters having from 1 to 20 glycerol units or alkoxylates thereof; alkoxylated fatty amines, esters thereof, or salts thereof; sugar esters; alkoxylated fatty amides; ethylene oxide/propylene oxide copolymers; and mixtures thereof;
wherein the total weight of co-synergist (IV) and co-active agent is from 1 wt. % to 99 wt. %, based on the total weight of the stabilizer composition; and
the ratio of co-synergist (IV) to co-active agent is 1:99 to 99:1;
or
b) the masterbatch concentrate according to claim 21;
such that the final concentration of the combined co-synergist (IV) and co-active agent in the stabilized article of manufacture is from 0.01 wt. % to 5 wt. %, based on the weight of the stabilized article of manufacture.
or comprising:
a) from 0.01 wt. % to 15 wt. %, based on the total weight of the stabilized article of manufacture, of a stabilizer composition comprising:
i) a stabilizing amount of an ultraviolet light absorber (UVA) selected from the group consisting of: orthohydroxyphenyl triazine compounds; orthohydroxybenzophenone compounds; orthohydroxyphenyl benzotriazole compounds; oxanilides; cyanoacrylates; benzoxazinone compounds; and mixtures thereof;
ii) a stabilizing amount of a hindered amine light stabilizer compound (HALS) comprising a functional group according to Formula (II): 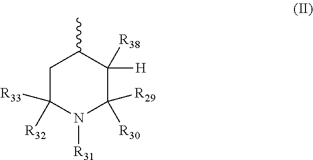
wherein R₃₁ is chosen from: hydrogen; OH; C₁-C₂₀ hydrocarbyl; —CH₂CN; C₁-C₁₂ acyl; or C₁-C₁₈ alkoxy; R₃₈ is chosen from: hydrogen; or C₁-C₈ hydrocarbyl; and each of R₂₉, R₃₀, R₃₂, and R₃₃ is independently chosen from C₁-C₂₀ hydrocarbyl, or R₂₉ and R₃₀ and/or R₃₂ and R₃₃ taken together with the carbon to which they are attached form a C₅-C₁₀ cycloalkyl; or
a functional group according to Formula (Ia): 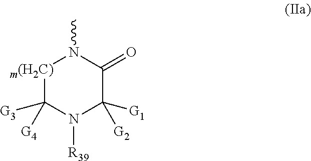
wherein
m is an integer from 1 to 2;
R₃₉ is chosen from: hydrogen; OH; C₁-C₂₀ hydrocarbyl; —CH₂CN; C₁-C₁₂ acyl; or C₁-C₁₈ alkoxy; and
each of G₁-G₄ is independently chosen from C₁-C₂₀ hydrocarbyl; or
mixtures of HALS compounds having functional groups according to Formula (II) and Formula (IIa); and
iii) a stabilizing amount of a co-synergist selected from the group consisting of bisamides of fatty acids of the general formula (IV): 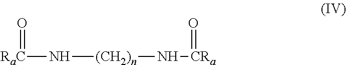
wherein Rₐ is a C7 to C25 alkyl group with 0 to 6 unsaturated double bonds and n is 2 to 10;
wherein a co-active agent selected from the group consisting of alkoxylated C₁₂-C₆₀ alcohols or monoalkyl ethers thereof; alkoxylated esters of fatty acids; sorbitan esters or ethoxylates thereof; mono- or polyglycerol esters having from 1 to 20 glycerol units or alkoxylates thereof; alkoxylated fatty amines, esters thereof, or salts thereof; sugar esters; alkoxylated fatty amides; ethylene oxide/propylene oxide copolymers; and mixtures thereof, is absent from the stabilizer composition (0 wt. %); and
wherein the co-synergist (IV) is present at from 1 wt. % to 99 wt. %, based on the total weight of the stabilizer composition
or
b) the masterbatch concentrate according to claim 21;
such that the final concentration of the combined co-synergist (IV) and co-active agent in the stabilized article of manufacture is from 0.01 wt. % to 5 wt. %, based on the weight of the stabilized article of manufacture.

28. The stabilized article of manufacture according to claim 27, wherein:
the final concentration of combined co-synergist (IV) and co-active agent in the stabilized article of manufacture is from 0.01 wt. % to 1 wt. %, based on the weight of the stabilized article of manufacture; and/or
a ratio of the combined co-synergist (IV) and co-active agent to ultraviolet light absorber (UVA) is from 200:1 to 1:50.

29.-30. (canceled)

31. The stabilized article of manufacture according to claim 27,
wherein the organic material to be stabilized is selected from the group consisting of polyolefins, poly(ethylene-vinyl acetate) (EVA), polyesters, polyethers, polyketones, polyamides, natural and synthetic rubbers, polyurethanes, polystyrenes, high-impact polystyrenes, polyacrylates, polymethacrylates, polybutyl acrylates, polyacetals, polyacrylonitriles, polybutadienes, polystyrenes, acrylonitrile-butadiene-styrene, styrene acrylonitrile, acrylate styrene acrylonitrile, cellulosic acetate butyrate, cellulosic polymers, polyimides, polyamideimides, polyetherimides, polyphenylsulfides, polyphenyloxidepolysulfones, polyethersulfones, polyvinylchlorides, polycarbonates, polyketones, aliphatic polyketones, thermoplastic olefins (TPO), polyolefin elastomers (POE), amino resin cross-linked polyacrylates and polyesters, polyisocyanate cross-linked polyesters and polyacrylates, phenol/formaldehyde, urea/formaldehyde and melamine/formaldehyde resins, drying and non-drying alkyd resins, alkyd resins, polyester resins, acrylate resins cross-linked with melamine resins, urea resins, isocyanates, isocyanurates, carbamates, epoxy resins, cross-linked epoxy resins derived from aliphatic, cycloaliphatic, heterocyclic and aromatic glycidyl compounds, which are cross-linked with anhydrides or amines, polysiloxanes, Michael addition polymers, amines, blocked amines with activated unsaturated and methylene compounds, ketimines with activated unsaturated and methylene compounds, polyketimines in combination with unsaturated acrylic polyacetoacetate resins, polyketimines in combination with unsaturated acrylic resins, coating compositions, radiation curable compositions, epoxymelamine resins, organic dyes, cosmetic products, cellulose-based paper formulations, photographic film paper, fibers, waxes, and inks,
wherein the organic material to be stabilized is a polyolefin polymer selected from the group consisting of i) polymers of monoolefins chosen from polyethylene, polypropylene, polyisobutylene, polybut-1-ene, or poly-4-methylpent-1-ene; ii) polymers of diolefins chosen from polyisoprene or polybutadiene; iii) polymers of cycloolefins chosen from cyclopentene or norbornene; iv) polyethylene chosen from optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); v) thermoplastic olefins (TPO); vi) polyolefin elastomers (POE); vii) copolymers thereof; and viii) mixtures thereof.

32. (canceled)

33. The stabilized polymer composition according to claim 27, wherein:
the olefin polymers or co-polymers functionalized with carboxylic acids or functional equivalents thereof are absent from the composition; and/or
the functionalized olefin polymers and co-polymers are reaction products of an olefin polymer or copolymer with an α,β-unsaturated carboxylic acid reagent, wherein the carboxylic acid reagent is a carboxylic acid, ester, or anhydride.

34. (canceled)

35. The stabilizer composition according to claim 19, wherein the hindered benzoate compound is selected from the group consisting of 2,4-di-tert-butylphenyl-3,5-di-tert-butyl-4-hydroxybenzoate; hexadecyl-3,5-di-tert-butyl-4-hydroxybenzoate; octadecyl-3,5-di-tert-butyl-4-hydroxybenzoate; octyl-3,5-di-tert-butyl-4-hydroxybenzoate; decyl-3,5-di-tert-butyl-4-hydroxybenzoate; dodecyl-3,5-di-tert-butyl-4-hydroxybenzoate; tetradecyl-3,5-di-tert-butyl-4-hydroxybenzoate; behenylyl-3,5-di-tert-butyl-4-hydroxybenzoate; 2-methyl-4,6-di-tert-butylphenyl-3,5-di-tert-butyl-4-hydroxybenzoate; butyl-3-[3-t-butyl-4-(3,5-di-t-butyl-4-hydroxybenzoyloxy)phenyl]propionate; and mixtures thereof.
